(19) United States
(12) Patent Application Publication
(10) Pub. No.: US 2026/0135671 A1
(43) Pub. Date: May 14, 2026

(54) METHOD AND DEVICE FOR TRANSMISSION AND RECEPTION OF DATA IN WIRELESS COMMUNICATION SYSTEM

(71) Applicant: Samsung Electronics Co., Ltd., Suwon-si (KR)

(72) Inventors: Sungjin PARK, Suwon-si (KR); Hyemin CHOE, Suwon-si (KR); Hyoungju JI, Suwon-si (KR); Youngrok JANG, Suwon-si (KR); Younsun KIM, Suwon-si (KR)

(21) Appl. No.: 19/382,807

(22) Filed: Nov. 7, 2025

(30) Foreign Application Priority Data
Nov. 8, 2024 (KR) 10-2024-0157753

(51) Int. Cl. H04L 5/00; H04B 7/06; H04L 27/26; H04W 72/23

(52) U.S. Cl. CPC H04L 5/0055; H04B 7/0626; H04L 27/2636; H04W 72/23

(57) ABSTRACT

The disclosure relates to a 5G or 6G communication system for supporting a higher data transmission rate. The disclosure relates to a 5th generation (5G) or 6th generation (6G) communication system for supporting a higher data transmission rate. A data transmission/reception method and a device in a wireless communication system are provided. The method performed by a user equipment (UE) transmitting and receiving data in a wireless communication system includes receiving, by the UE, at least one of higher layer information or a layer 1 (L1) signal from a base station, identifying, by the UE, a waveform applied to a physical downlink shared channel (PDSCH) received using at least one of the higher layer information or the L1 signal, determining, by the UE, a processing time based on the waveform applied to the PDSCH, and transmitting, by the UE, a hybrid automatic repeat request-acknowledgement (HARQ-ACK) feedback to the base station based on the determined processing time.

### CROSS-REFERENCE TO RELATED APPLICATION(S)

This application is based on and claims priority under 35 U.S.C. § 119(a) of a Korean patent application number 10-2024-0157753, filed on Nov. 8, 2024, in the Korean Intellectual Property Office, the disclosure of which is incorporated by reference herein in its entirety.

### BACKGROUND

### 1. Field

The disclosure relates to an operation of a user equipment (UE) and a base station in a wireless communication system. More particularly, the disclosure relates to a method for configuring/reporting data information in a wireless communication system and a device capable of performing the same.

### 2. Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

5th generation (5G) mobile communication technologies define broad frequency bands such that high transmission rates and new services are possible, and can be implemented not only in “Sub 6 GHz” bands such as 3.5 GHZ, but also in “Above 6 GHz” bands referred to as millimeter wave (mmWave) including 28 GHz and 39 GHz. In addition, it has been considered to implement 6th generation (6G) mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BandWidth Part (BWP), new channel coding methods such as a Low Density Parity Check (LDPC) code for large amount of data transmission and a polar code for highly reliable transmission of control information, layer 2 (L2) pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, new radio (NR) UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, Integrated Access and Backhaul (IAB) for providing a node for network service area expansion by supporting a wireless backhaul link and an access link in an integrated manner, mobility enhancement including conditional handover and Dual Active Protocol Stack (DAPS) handover, and two-step random access for simplifying random access procedures (2-step random access channel (RACH) for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting Augmented Reality (AR), Virtual Reality (VR), Mixed Reality (MR) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and Artificial Intelligence (AI) from the design stage and internalizing end-to-end AI support functions, and next-generation distributed computing technology for implementing services at levels of complexity exceeding the limit of UE operation capability by utilizing ultra-high-performance communication and computing resources.

In order to meet the demand for wireless data traffic soring since the 4th generation (4G) communication system came to the market, there are ongoing efforts to develop enhanced 5G communication systems or pre-5G communication systems. For the reasons, the 5G communication system or pre-5G communication system is called the beyond 4G network communication system or post long term evolution (LTE) system. For higher data transmit rates, 5G communication systems are considered to be implemented on ultra-high frequency bands (mmWave), such as, e.g., 60 GHz. To mitigate pathloss on the ultra-high frequency band and increase the reach of radio waves, the following techniques are taken into account for the 5G communication system, beamforming, massive multi-input multi-output (MIMO), full dimensional MIMO (FD-MIMO), array antenna, analog beamforming, and large scale antenna. Also being developed are various technologies for the 5G communication system to have an enhanced network, such as evolved or advanced small cell, cloud radio access network (cloud RAN), ultra-dense network, device-to-device (D2D) communication, wireless backhaul, moving network, cooperative communication, coordinated multi-point (CoMP), and interference cancellation. There are also other various schemes under development for the 5G system including, e.g., hybrid frequency shift keying (FSK) and quadrature amplitude modulation (QAM) (FQAM) and sliding window superposition coding (SWSC), which are advanced coding modulation (ACM) schemes, and filter bank multi-carrier (FBMC), non-orthogonal multiple access (NOMA) and sparse code multiple access (SCMA), which are advanced access schemes.

The Internet is evolving from the human-centered connection network by which humans create and consume information to the Internet of Things (IoT) network by which information is communicated and processed between things or other distributed components. Another arising technology is the Internet of Everything (IoE), which is a combination of the Big data processing technology and the IoT technology through, e.g., a connection with a cloud server. To implement the IoT, technology elements, such as a sensing technology, wired/wireless communication and network infra, service interface technology, and a security technology, are required. There is recent ongoing research for inter-object connection technologies, such as the sensor network, Machine-to-Machine (M2M), or the Machine-Type Communication (MTC). In the IoT environment may be offered intelligent Internet Technology (IT) services that collect and analyze the data generated by the things connected with one another to create human life a new value. The IoT may have various applications, such as the smart home, smart building, smart city, smart car or connected car, smart grid, health-care, or smart appliance industry, or state-of-art medical services, through conversion or integration of existing information technology (IT) techniques and various industries.

Thus, various attempts are being made to apply 5G communication systems (fifth generation communication systems or new radio (NR)) to IoT networks. For example, the sensor network, machine-to-machine (M2M), machine type communication (MTC), or other 5G techniques are implemented by schemes, such as beamforming, multi-input multi-output (MIMO), and array antenna schemes. The above-mentioned application of the cloud radio access network (RAN) as a big data processing technique may be said to be an example of the convergence of the 5G and IoT technologies.

As described above, as wireless communication systems evolve to provide various services, a need arises for a method for smoothly providing such services.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a device and method for effectively providing a service in a mobile communication system.

Additional aspects will be set forth in part in the description which follows and, in part, will be apparent from the description, or may be learned by practice of the presented embodiments.

In accordance with an aspect of the disclosure, a method performed by a user equipment (UE) transmitting and receiving data in a wireless communication system is provided. The method includes receiving, by the UE, at least one of higher layer information or a layer 1 (L1) signal from a base station, identifying, by the UE, a waveform applied to a physical downlink shared channel (PDSCH) received using at least one of the higher layer information or the L1 signal, determining, by the UE, a processing time based on the waveform applied to the PDSCH, and transmitting, by the UE, a hybrid automatic repeat request-acknowledgement (HARQ-ACK) feedback to the base station based on the determined processing time.

In accordance with another aspect of the disclosure, a method performed by a user equipment (UE) transmitting and receiving data in a wireless communication system is provided. The method includes receiving, by the UE, at least one of higher layer information or a layer 1 (L1) signal from a base station, identifying, by the UE, a waveform applied to a channel state information-reference signal (CSI-RS) received using at least one of the higher layer information or the L1 signal, determining, by the UE, a processing time based on the waveform applied to the CSI-RS, and transmitting, by the UE, CSI feedback to the base station using the determined processing time.

In accordance with another aspect of the disclosure, a user equipment (UE) for transmitting and receiving data in a wireless communication system is provided. The UE includes a transceiver, memory, including one or more storage media, storing instructions, and one or more processors communicatively coupled to the transceiver and the memory, wherein the instructions, when executed by the one or more processors individually or collectively, cause the UE to receive at least one of higher layer information or a layer 1 (L1) signal from a base station, identify a waveform applied to a physical downlink shared channel (PDSCH) received using at least one of the higher layer information or the L1 signal, determine a processing time based on the waveform applied to the PDSCH, and transmit a hybrid automatic repeat request-acknowledgement (HARQ-ACK) feedback to the base station using the determined processing time.

In accordance with another aspect of the disclosure, one or more non-transitory computer-readable storage media storing one or more computer programs including computer-executable instructions that, when executed by one or more processors of a user equipment (UE) individually or collectively, cause the UE to perform operations are provided. The operations include receiving, by the UE, at least one of higher layer information or a layer 1 (L1) signal from a base station, identifying, by the UE, a waveform applied to a physical downlink shared channel (PDSCH) received using at least one of the higher layer information or the L1 signal, determining, by the UE, a processing time based on the waveform applied to the PDSCH, and transmitting, by the UE, a hybrid automatic repeat request-acknowledgement (HARQ-ACK) feedback to the base station based on the determined processing time.

Disclosed embodiments may provide a device and method for effectively providing a service in a mobile communication system.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a view illustrating a basic structure of a time-frequency domain in a wireless communication system according to an embodiment of the disclosure;

FIG. 2 is a view illustrating the structures of a frame, a subframe, and a slot in a wireless communication system according to an embodiment of the disclosure;

FIG. 3 is a view illustrating an example of physical uplink shared channel (PUSCH) repeated transmission type B in a wireless communication system according to an embodiment of the disclosure;

FIG. 4A is a view illustrating an example of an aperiodic channel state information (CSI) reporting method according to an embodiment of the disclosure;

FIG. 4B is a view illustrating an example of an aperiodic CSI reporting method according to an embodiment of the disclosure;

FIG. 5A illustrates an example in which uplink control information (UCI) is mapped to a PUSCH according to an embodiment of the disclosure;

FIG. 5B illustrates an example in which uplink control information is mapped to a PUSCH according to an embodiment of the disclosure;

FIG. 5C illustrates an example in which uplink control information is mapped to a PUSCH according to an embodiment of the disclosure;

FIG. 6 is a view illustrating a processing procedure for transmitting and receiving UCI information through a PUSCH between a UE and a base station according to an embodiment of the disclosure;

FIG. 7 is a view illustrating a semi-static HARQ-ACK codebook (or Type-1 HARQ-ACK codebook) configuration method in an NR system according to an embodiment of the disclosure;

FIG. 8 is a view illustrating a dynamic HARQ-ACK codebook (or Type-2 HARQ-ACK codebook) configuration method in an NR system according to an embodiment of the disclosure;

FIG. 9 is a transmission block diagram according to an embodiment of the disclosure;

FIG. 10 is a flowchart illustrating a process of calculating processing time of the UE and reporting HARQ-ACK feedback accordingly in a circumstance where multiple waveforms may be applied to a PDSCH according to an embodiment of the disclosure;

FIG. 11 is a flowchart illustrating a procedure in which uplink information and control information are multiplexed according to an embodiment of the disclosure;

FIG. 12 is a view illustrating a structure of a UE in a wireless communication system according to an embodiment of the disclosure; and

FIG. 13 is a view illustrating a structure of a base station in a wireless communication system according to an embodiment of the disclosure.

Throughout the drawings, it should be noted that like reference numbers are used to depict the same or similar elements, features, and structures.

### DETAILED DESCRIPTION

The following descriptions with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In describing embodiments, the description of technologies that are known in the art and are not directly related to the disclosure is omitted. This is for further clarifying the gist of the disclosure without making it unclear.

For the same reasons, some elements may be exaggerated or schematically shown. The size of each element does not necessarily reflect the real size of the element. The same reference numeral is used to refer to the same element throughout the drawings.

Advantages and features of the disclosure, and methods for achieving the same may be understood through the embodiments to be described below taken in conjunction with the accompanying drawings. However, the disclosure is not limited to the embodiments disclosed herein, and various changes may be made thereto. The embodiments disclosed herein are provided only to inform one of ordinary skill in the art of the category of the disclosure. The disclosure is defined only by the appended claims. The same reference numeral denotes the same element throughout the specification. When determined to make the subject matter of the disclosure unclear, the detailed description of the known art or functions may be skipped. The terms as used herein are defined considering the functions in the disclosure and may be replaced with other terms according to the intention or practice of the user or operator. Therefore, the terms should be defined based on the overall disclosure.

Hereinafter, the base station may be an entity allocating resource to terminal and may be at least one of gNode B, eNode B, Node B, base station (BS), wireless access unit, base station controller, or node over network. The UE may include a terminal, a mobile station (MS), a cellular phone, a smartphone, a computer, or a multimedia system capable of performing communication functions. In the disclosure, downlink (DL) refers to a wireless transmission path of signal transmitted from the base station to the terminal, and uplink (UL) refers to a wireless transmission path of signal transmitted from the terminal to the base station. Although LTE or long term evolution advanced (LTE-A) systems may be described below as an example, the embodiments may be applied to other communication systems having a similar technical background or channel pattern. For example, 5G mobile communication technology (5G, new radio, NR) or sixth generation mobile communication technology (6G) developed after LTE-A may be included therein, and 5G or 6G below may be a concept including legacy LTE, LTE-A and other similar services. Further, the embodiments may be modified in such a range as not to significantly depart from the scope of the disclosure under the determination by one of ordinary skill in the art and such modifications may be applicable to other communication systems.

It should be appreciated that the blocks in each flowchart and combinations of the flowcharts may be performed by computer program instructions. Since the computer program instructions may be equipped in a processor of a general-use computer, a special-use computer or other programmable data processing devices, the instructions executed through a processor of a computer or other programmable data processing devices generate means for performing the functions described in connection with a block(s) of each flowchart. Since the computer program instructions may be stored in a computer-available or computer-readable memory that may be oriented to a computer or other programmable data processing devices to implement a function in a specified manner, the instructions stored in the computer-available or computer-readable memory may produce a product including an instruction means for performing the functions described in connection with a block(s) in each flowchart. Since the computer program instructions may be equipped in a computer or other programmable data processing devices, instructions that generate a process executed by a computer as a series of operational steps are performed over the computer or other programmable data processing devices and operate the computer or other programmable data processing devices may provide steps for executing the functions described in connection with a block(s) in each flowchart.

Further, each block may represent a module, segment, or part of a code including one or more executable instructions for executing a specified logical function(s). Further, it should also be noted that in some replacement embodiments, the functions mentioned in the blocks may occur in different orders. For example, two blocks that are consecutively shown may be performed substantially simultaneously or in a reverse order depending on corresponding functions.

As used herein, the term “unit” means a software element or a hardware element such as a field-programmable gate array (FPGA) or an application specific integrated circuit (ASIC). A unit plays a certain role. However, ‘unit’ is not limited to software or hardware. A ‘unit’ may be configured in a storage medium that may be addressed or may be configured to execute one or more processors. Accordingly, as an example, a ‘unit’ includes elements, such as software elements, object-oriented software elements, class elements, and task elements, processes, functions, attributes, procedures, subroutines, segments of program codes, drivers, firmware, microcodes, circuits, data, databases, data architectures, tables, arrays, and variables. Functions provided within the components and the ‘units’ may be combined into smaller numbers of components and ‘units’ or further separated into additional components and ‘units’. Further, the components and ‘units’ may be implemented to execute one or more CPUs in a device or secure multimedia card. According to embodiments, a “ . . . unit” may include one or more processors.

Wireless communication systems evolve beyond voice-centered services to broadband wireless communication systems to provide high data rate and high-quality packet data services, such as 3rd generation partnership project (3GPP) high speed packet access (HSPA), long term evolution (LTE) or evolved universal terrestrial radio access (E-UTRA)), LTE-advanced (LTE-A), LTE-pro, 3GPP2 high rate packet data (HRPD), ultra mobile broadband (UMB), and institute of electrical and electronics engineers (IEEE) 802.16e communication standards.

As a representative example of such broadband wireless communication system, the LTE system adopts orthogonal frequency division multiplexing (OFDM) for downlink and single carrier frequency division multiple access (SC-FDMA) for uplink. Uplink means a wireless link where the user equipment (UE) (or mobile station (MS) transmits data or control signals to the base station (BS, or eNode B), and downlink means a wireless link where the base station transmits data or control signals to the UE. Such multiple access scheme may typically allocate and operate time-frequency resources carrying data or control information per user not to overlap, i.e., to maintain orthogonality, to thereby differentiate each user's data or control information.

Post-LTE communication systems, e.g., 5G communication systems, are required to freely reflect various needs of users and service providers and thus to support services that simultaneously meet various requirements. Services considered for 5G communication systems include, e.g., enhanced mobile broadband (eMBB), massive machine type communication (mMTC), and ultra reliability low latency communication (URLLC).

eMBB aims to provide a further enhanced data transmission rate as compared with LTE, LTE-A, or LTE-pro. For example, eMBB for 5G communication systems needs to provide a peak data rate of 20 Gbps on downlink and a peak data rate of 10 Gbps on uplink in terms of one base station. 5G communication systems also need to provide an increased user perceived data rate while simultaneously providing such peak data rate. To meet such requirements, various transmit (TX)/receive (RX) techniques, as well as multiple input multiple output (MIMO), need to further be enhanced. While LTE adopts a TX bandwidth up to 20 MHz in the 2 GHz band to transmit signals, the 5G communication system employs a broader frequency bandwidth in a frequency band ranging from 3 GHz to 6 GHz or more than 6 GHz to meet the data rate required for 5G communication systems.

mMTC is also considered to support application services, such as internet of things (IoT) in the 5G communication system. To efficiently provide IoT, mMTC is required to support massive UEs in the cell, enhance the coverage of the UE and the battery time, and reduce UE costs. IoT terminals are attached to various sensors or devices to provide communication functionality, and thus, it needs to support a number of UEs in each cell (e.g., 1,000,000 UEs/km2). Since mMTC-supportive UEs, by the nature of service, are highly likely to be located in shadow areas not covered by the cell, such as the underground of a building, it may require much broader coverage as compared with other services that the 5G communication system provides. mMTC-supportive UEs, due to the need for being low cost and difficulty in frequently exchanging batteries, may be required to have a very long battery life, e.g., 10 years to 15 years.

URLLC is a mission-critical, cellular-based wireless communication service. For example, URLLC may be considered for use in remote control for robots or machinery, industrial automation, unmanned aerial vehicles, remote health care, or emergency alert. This requires that URLLC provide very low-latency and very high-reliability communication. For example, URLLC-supportive services need to meet an air interface latency of less than 0.5 milliseconds simultaneously with a packet error rate of 10-5 or less. Thus, for URLLC-supportive services, the 5G communication system may be required to provide a shorter transmit time interval (TTI) than those for other services while securing reliable communication links by allocating a broad resource in the frequency band.

The three 5G services, i.e., eMBB, URLLC, and mMTC, may be multiplexed in one system and be transmitted. In this case, the services may adopt different TX/RX schemes and TX/RX parameters to meet their different requirements. Of course, 5G is not limited to the above-described three services.

Hereinafter, embodiments of the disclosure are described in detail with reference to the accompanying drawings. Hereinafter, the base station may be an entity allocating resource to terminal and may be at least one of gNode B, gNB, eNode B, Node B, base station (BS), wireless access unit, base station controller, or node over network. The UE may include UE (user equipment), MS (mobile station), cellular phone, smartphone, computer, or multimedia system capable of performing communication functions. Although 5G system is described in connection with embodiments of the disclosure, as an example, embodiments of the disclosure may also apply to other communication systems with similar technical background or channel form. For example, LTE or LTE-A mobile communication and post-5G mobile communication technology may be included therein. Further, embodiments of the disclosure may be modified in such a range as not to significantly depart from the scope of the disclosure under the determination by one of ordinary skill in the art and such modifications may be applicable to other communication systems. The contents of the disclosure are applicable to frequency division duplex (FDD) and time division duplex (TDD) systems.

When determined to make the subject matter of the disclosure unclear, the detailed description of the known art or functions may be skipped. The terms as used herein are defined considering the functions in the disclosure and may be replaced with other terms according to the intention or practice of the user or operator. Therefore, the terms should be defined based on the overall disclosure.

In the disclosure, higher layer signaling may be signaling corresponding to at least one or a combination of one or more of the following signaling.

Master Information Block (MIB)

System Information Block (SIB) or SIB X (X=1, 2, . . . )

Radio Resource Control (RRC)

Medium Access Control (MAC) Control Element (CE)

Further, L1 signaling may be signaling corresponding to at least one or a combination of one or more of the following physical layer channels or signaling methods using signaling.

Physical downlink control channel (PDCCH)

Downlink control information (DCI)

UE-specific DCI

Group common DCI

Common DCI

Scheduling DCI (e.g., DCI used for scheduling downlink or uplink data)

Non-scheduling DCI (e.g., DCI not for the purpose of scheduling downlink or uplink data)

Physical uplink control channel (PUCCH)

Uplink control information (UCI)

Hereinafter, in the disclosure, ‘determine priority between A and B’ may be referred to in other various manners, e.g., as selecting one with higher priority according to a predetermined priority rule and performing an operation according thereto or omitting or dropping the operation for the one with lower priority.

Hereinafter, in the disclosure, the above-described examples are described in connection with various embodiments. One or more embodiments may be applied simultaneously or in combination, rather than independently.

### [NR Time-Frequency Resource]

The frame structure of the 5G system may be described below in more detail with reference to the drawings.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

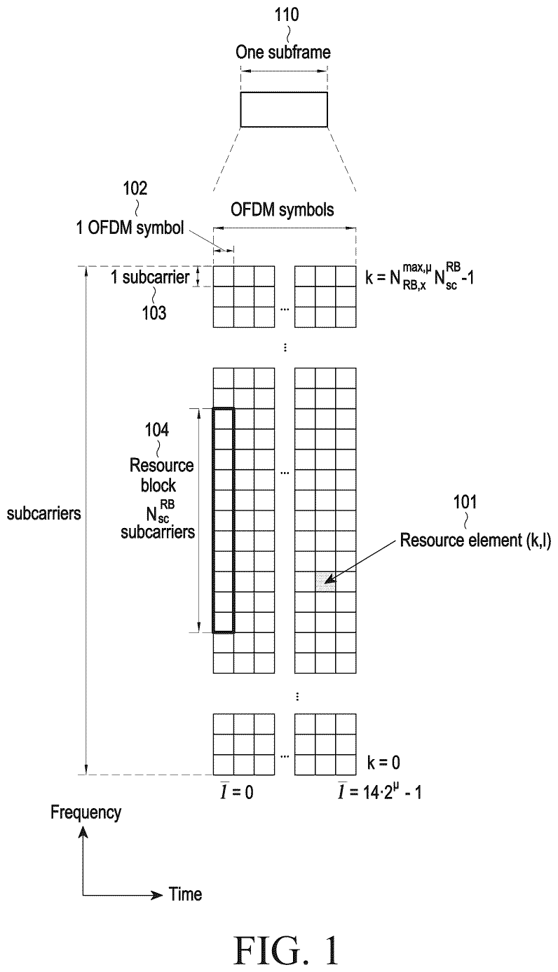

FIG. 1 is a view illustrating a basic structure of a time-frequency domain in a wireless communication system according to an embodiment of the disclosure.

In other words, FIG. 1 may be a view illustrating a basic structure of a time-frequency domain, which is a radio resource region in which data or control channels are transmitted in a 5G system.

Referring to FIG. 1, the horizontal axis may refer to the time domain, and the vertical axis may refer to the frequency domain. A basic unit of a resource in the time and frequency domain is a resource element (RE) 101, which may be defined by one orthogonal frequency division multiplexing (OFDM) symbol 102 on the time axis, and by one subcarrier 103 on the frequency axis. In the frequency domain.

$${N}_{sc}^{RB}$$

(e.g., 12) consecutive KEs may constitute one resource block (RB) 104. One subframe 110 may be composed of one or more OFDM symbols

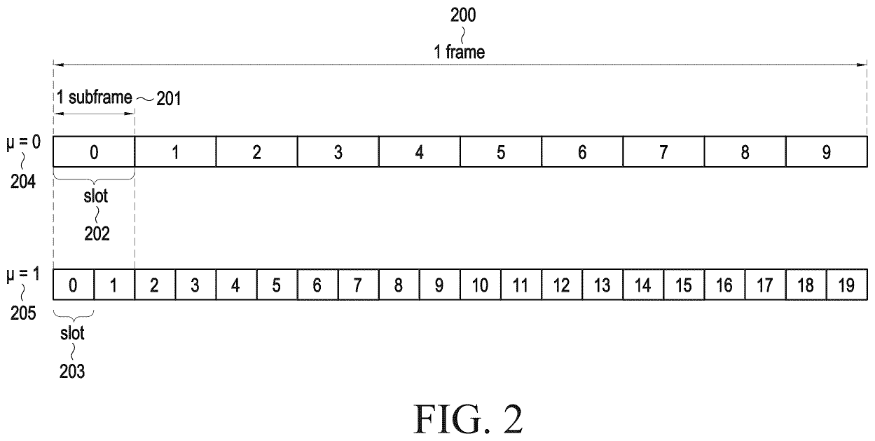

FIG. 2 is a view illustrating the structures of a frame, a subframe, and a slot in a wireless communication system according to an embodiment of the disclosure.

FIG. 2 may illustrate an example structure of a frame 200, a subframe 201, and a slot 202. One frame 200 may be defined as 10 ms. One subframe 201 may be defined as 1 ms, and thus, one frame 200 may consist of a total of 10 subframes 201. One slot 202 or 203 may be defined as 14 orthogonal frequency-division multiplexing (OFDM) symbols (that is, the number

$$( {N}_{symb}^{slot} )$$

of symbols per slot=14). One subframe 201 may be composed of one or more slots 202 and 203, and the number of slots 202 and 203 per subframe 201 may differ depending on μ (204 or 205), which is a set value for the subcarrier spacing. FIG. 2 may illustrate an example in which the subcarrier spacing setting value μ=0 (204) and an example in which the subcarrier spacing setting value μ=1 (205). When μ=0 (204), one subframe 201 may consist of one slot 202, and when μ=1 (205), one subframe 201 may consist of two slots (203). In other words, according to the set subcarrier spacing value μ, the number

$$( {N}_{slot}^{subframe , μ} )$$

of slots per frame of slots per subframe may vary, and accordingly, the number

$$( {N}_{slot}^{frame , μ} )$$

of slots per frame may differ. According to each subcarrier spacing μ,

$${N}_{slot}^{subframe , μ} and {N}_{slot}^{frame , μ}$$

may be defined in Table 1 below.

TABLE 1

| μ | ${N}_{symb}^{slot}$ | ${N}_{slot}^{frame , μ}$ | ${N}_{slot}^{subframe , μ}$ |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |

### [PDCCH: DCI Related]

Next, downlink control information (DCI) in the 5G system may be described in detail.

Scheduling information for uplink data (or physical uplink shared channel (PUSCH) or downlink data (or physical downlink data channel (PDSCH) in the 5G system may be transmitted from the base station through DCI to the UE. The UE may monitor the DCI format for fallback and the DCI format for non-fallback for PUSCH or PDSCH. The fallback DCI format may be composed of fixed fields predetermined between the base station and the UE, and the non-fallback DCI format may include configurable fields.

DCI may be transmitted through the PDCCH, which is a physical downlink control channel, via channel coding and modulation. A cyclic redundancy check (CRC) is added to the DCI message payload, and the CRC is scrambled with the radio network temporary identifier (RNTI) that is the identity of the UE. Different RNTIs may be used for the purposes of the DCI message, e.g., UE-specific data transmission, power control command, or random access response. In other words, the RNTI is not explicitly transmitted, but the RNTI is included in the CRC calculation process and transmitted. Upon receiving the DCI message transmitted on the PDCCH, the UE identifies the CRC using the allocated RNTI, and when the CRC is correct, the UE may be aware that the message has been transmitted to the UE.

For example, DCI scheduling a PDSCH for system information (SI) may be scrambled to SI-RNTI. The DCI scheduling a PDSCH for a random access response (RAR) message may be scrambled to RA-RNTI. DCI scheduling a PDSCH for a paging message may be scrambled with P-RNTI. The DCI providing a slot format indicator (SFI) may be scrambled to SFI-RNTI. The DCI providing transmit power control (TPC) may be scrambled to TPC-RNTI. The DCI for scheduling a UE-specific PDSCH or PUSCH may be scrambled with cell RNTI (C-RNTI).

DCI format 0_0 may be used as fallback DCI for scheduling PUSCH, and in this case, CRC may be scrambled to C-RNTI. DCI format 0_0 in which CRC is scrambled to C-RNTI may include, e.g., the following information.

TABLE 2
Identifier for DCI formats - [1] bit
$Frequency domain resource assignment - [ ⌈ {log}_{2} ( {N}_{R B}^{UL , BWP} ( {N}_{R B}^{UL , BWP} + 1 ) / 2 ) ⌉ ] bits$
Time domain resource assignment - X bits
Frequency hopping flag - 1 bit.
Modulation and coding scheme - 5 bits
New data indicator - 1 bit
Redundancy version - 2 bits
HARQ process number - 4 bits
TPC command for scheduled PUSCH - [2] bits
UL/SUL (supplementary UL) indicator - 0 or 1 bit

DCI format 0_1 may be used as non-fallback DCI for scheduling PUSCH, and in this case, CRC may be scrambled to C-RNTI. DCI format 0_1 in which CRC is scrambled to C-RNTI may include, e.g., the following information.

```
TABLE 3
  Carrier indicator - 0 or 3 bits
  UL/SUL indicator - 0 or 1 bit
  Identifier for DCI formats - [1] bits
  Bandwidth part indicator - 0, 1 or 2 bits
  Frequency domain resource assignment
    $For resource allocation type 0 , ⌈ {N}_{R B}^{UL , BWP} / P ⌉ bits$
    $For resource allocation type 1 , ⌈ {log}_{2} ( {N}_{R B}^{UL , BWP} ( {N}_{R B}^{UL , BWP} + 1 ) / 2 ) ⌉ bits$
  Time domain resource assignment -1, 2, 3, or 4 bits
  VRB(virtual resource block)-to-PRB(physical resource block) mapping -
0 or 1 bit, only for resource allocation type 1.
    0 bit if only resource allocation type 0 is configured;
    1 bit otherwise.
  Frequency hopping flag - 0 or 1 bit, only for resource allocation type 1.
    0 bit if only resource allocation type 0 is configured;
    1 bit otherwise.
  Modulation and coding scheme - 5 bits
  New data indicator - 1 bit
  Redundancy version - 2 bits
  HARQ process number - 4 bits
  1st downlink assignment index - 1 or 2 bits
    1 bit for semi-static HARQ-ACK codebook;
    2 bits for dynamic HARQ-ACK codebook with single HARQ-ACK
    codebook.
  2nd downlink assignment index - 0 or 2 bits
    2 bits for dynamic HARQ-ACK codebook with two HARQ-ACK sub-
    codebooks;
    0 bit otherwise.
  TPC command for scheduled PUSCH - 2 bits
  $SRS resource indicator - ⌈ {log}_{2} ( {\sum }_{k = 1}^{{L}_{max} Σ} ( \begin{matrix}{N}_{SRS} \\ k\end{matrix} ) ( ) ) □□ ⌉$ $or ⌈ {log}_{2} ( {N}_{S R S} ) ⌉ bits$
    $⌈ {log}_{2} ( {\sum }_{k = 1}^{{L}_{max} Σ} ( \begin{matrix}{N}_{SRS} \\ k\end{matrix} ) ( ) ) □□ ⌉ bits for non - codebook based PUSCH$
    transmission;
    ┌log₂ (N_{SRS})┐ bits for codebook based PUSCH transmission.
  Precoding information and number of layers -up to 6 bits
  Antenna ports - up to 5 bits
  SRS request - 2 bits
  CSI request - 0, 1, 2, 3, 4, 5, or 6 bits
  CBG(code block group) transmission information- 0, 2, 4, 6, or 8 bits
  PTRS-DMRS association - 0 or 2 bits.
  beta_offset indicator - 0 or 2 bits
  DMRS sequence initialization - 0 or 1 bit
```

DCI format 1_0 may be used as fallback DCI for scheduling PDSCH, and in this case, CRC may be scrambled to C-RNTI. DCI format 1_0 in which CRC is scrambled to C-RNTI may include, e.g., the following information.

TABLE 4
Identifier for DCI formats - [1] bit
$Frequency domain resource assignment - [ ⌈ {log}_{2} ( {N}_{R B}^{DL , BWP} ( {N}_{R B}^{DL , BWP} + 1 ) / 2 ) ⌉ ] bits$
Time domain resource assignment - X bits
VRB-to-PRB mapping - 1 bit.
Modulation and coding scheme - 5 bits
New data indicator - 1 bit
Redundancy version - 2 bits
HARQ process number - 4 bits
Downlink assignment index - 2 bits
TPC command for scheduled PUCCH - [2] bits
PUCCH(physical uplink control channel) resource indicator - 3 bits
PDSCH-to-HARQ feedback timing indicator - [3] bits

DCI format 1_1 may be used as non-fallback DCI for scheduling PDSCH, and in this case, CRC may be scrambled to C-RNTI. DCI format 1_1 in which CRC is scrambled to C-RNTI may include, e.g., the following information.

```
TABLE 5
  Carrier indicator - 0 or 3 bits
  Identifier for DCI formats - [1] bits
  Bandwidth part indicator - 0, 1 or 2 bits
  Frequency domain resource assignment
    $For resource allocation type 0 , ⌈ {N}_{R B}^{DL , BWP} / P ⌉ bits$
    $For resource allocation type 1 , ⌈ {log}_{2} ( {N}_{R B}^{DL , BWP} ( {N}_{R B}^{DL , BWP} + 1 ) / 2 ) ⌉ bits$
  Time domain resource assignment -1, 2, 3, or 4 bits
  VRB-to-PRB mapping - 0 or 1 bit, only for resource allocation type 1.
    0 bit if only resource allocation type 0 is configured;
    1 bit otherwise.
  PRB bundling size indicator - 0 or 1 bit
  Rate matching indicator - 0, 1, or 2 bits
  ZP channel state information - reference signal (CSI-RS) trigger - 0, 1,
  or 2 bits
For transport block 1:
  Modulation and coding scheme - 5 bits
  New data indicator - 1 bit
  Redundancy version - 2 bits
For transport block 2:
  Modulation and coding scheme - 5 bits
  New data indicator - 1 bit
  Redundancy version - 2 bits
  HARQ process number - 4 bits
  Downlink assignment index - 0 or 2 or 4 bits
  TPC command for scheduled PUCCH - 2 bits
  PUCCH resource indicator - 3 bits
  PDSCH-to-HARQ_feedback timing indicator - 3 bits
  Antenna ports - 4, 5 or 6 bits
  Transmission configuration indication - 0 or 3 bits
  SRS request - 2 bits
  CBG transmission information - 0, 2, 4, 6, or 8 bits
  CBG flushing out information - 0 or 1 bit
  DMRS sequence initialization - 1 bit
```

### [PDSCH: Processing Time]

Next, a PDSCH processing procedure time may be described. When the base station schedules the UE to transmit the PDSCH using DCI format 1_0, 1_1, or 1_2, the UE may need PDSCH processing time to receive the PDSCH by applying the transmission method directed through DCI (modulation/demodulation and coding indication index (MCS), information related to demodulation reference signals, time and frequency resource allocation information, etc.). In NR, a PDSCH processing time may be defined to receive PDSCH by applying the transmission method indicated through DCI. The PDSCH processing time of the UE may follow Equation 1 below.

$$Tproc , 1 = ( N 1 + d 1 , 1 + d 2 ) ( 2048 + 144 ) κ 2 - μ Tc + Text \qquad Equation 1$$

In Tproc,1 described above by Equation 1, each variable may have the following meaning.
N1: The number of symbols determined according to UE processing capability 1 or 2 and numerology μ according to the capabilities of the UE. When UE processing capability 1 is reported according to the UE capability report, it may have the value of Table 6 below. When UE processing capability 2 is reported, and it is set through higher layer signaling to be able to use UE processing capability 2, it may have the value of Table 7. The numerology μ may correspond to the minimum value of μPDCCH, μPDSCH, and μUL to maximize Tproc,1, and μPDCCH, μPDSCH, and μUL may mean the numerology of the PDCCH having scheduled the PDSCH, the numerology of the scheduled PDSCH, and the numerology of the uplink channel where the HARQ-ACK is to be transmitted, respectively.

TABLE 6

| | PDSCH decoding time N₁ [symbols] | |
|---|---|---|
| | | when dmrs-AdditionalPosition ≠ pos0 in |
| | when dmrs-AdditionalPosition = pos0 in | DMRS-DownlinkConfig which is higher |
| | DMRS-DownlinkConfig which is higher | layer signaling in both PDSCH mapping |
| | layer signaling in both PDSCH mapping | types A and B, or when higher layer |
| μ | types A and B | parameter is not configured |
| 0 | 8 | N_{1, 0} |
| 1 | 10 | 13 |
| 2 | 17 | 20 |
| 3 | 20 | 24 |

Table 6 may include the PDSCH processing time in the case of PDSCH processing capability 1.

TABLE 7

| | PDSCH decoding time N₁ [symbols] |
|---|---|
| | when dmrs-AdditionalPosition = pos0 in |
| | DMRS-DownlinkConfig which is higher layer |
| μ | signaling in both PDSCH mapping types A and B |
| 0 | 3 |
| 1 | 4.5 |
| 2 | 9 for frequency range 1 |

Table 7 may include the PDSCH processing time in the case of PDSCH processing capability 2.
κ: 64
Text: When the UE uses a shared spectrum channel access scheme, the UE may calculate Text and apply it to the PDSCH processing time. Otherwise, Text may be assumed to be 0.
If 11 representing the PDSCH DMRS position value is 12, N1,0 in Table x2-2 may have a value of 14, otherwise have a value of 13.
For PDSCH mapping type A, if the last symbol of PDSCH may be the ith symbol in the slot where PDSCH is transmitted, and i<7, d1,1 is 7-i, otherwise d1, 1 is 0.
d2: When PUCCH with a high priority index overlaps PUCCH or PUSCH with a low priority index over time, d2 of PUCCH with the high priority index may be set to a value reported from the UE. Otherwise, d2 may be 0.
When PDSCH mapping type B is used for UE processing capability 1, the d1, 1 value may be determined according to L, which is the number of symbols of the PDSCH scheduled as follows, and the number d of symbols overlapping between the PDCCH scheduling PDSCH and the scheduled PDSCH.
if L≥7, d1,1=0.
if L≥4 and L≤6, d1,1=7−L.
if L=3, d1,1=min (d, 1).
if L=2, d1,1=3+d.
When PDSCH mapping type B is used for UE processing capability 2, the d1, 1 value may be determined according to L, which is the number of symbols of the PDSCH scheduled as follows, and the number d of symbols overlapping between the PDCCH scheduling PDSCH and the scheduled PDSCH.
if L≥7, d1,1=0.
if L≥4 and L≤6, d1,1=7−L.
When L=2,
When the scheduling PDCCH may exist within a CORESET constituted of three symbols, and the CORESET and the scheduled PDSCH have the same start symbol, d1,1=3.
Otherwise, d1,1=d.
In the case of a UE supporting capability 2 within a given serving cell, the PDSCH processing time according to the UE processing capability 2 may be applied when the UE has higher layer signaling, processingType2Enabled, set to enabled for the cell.

If the position of the first uplink transmission symbol of the PUCCH containing HARQ-ACK information (the corresponding position may consider K1-defined at the transmission time of HARQ-ACK, the PUCCH resource used for HARQ-ACK transmission, and timing advance effect) does not start before the first uplink transmission symbol appearing Tproc,1 after the last symbol of PDSCH, the UE may transmit a valid HARQ-ACK message. In other words, the UE may transmit the PUCCH including the HARQ-ACK only when the PDSCH processing time is sufficient. Otherwise, the UE may not provide the base station with valid HARQ-ACK information corresponding to the scheduled PDSCH. Tproc,1 may be used for both normal and extended CP cases. For a PDSCH constituted of two PDSCH transmission positions within one slot, d1, 1 may be calculated with respect to the first PDSCH transmission position within the corresponding slot.

To summarize the description, Tproc,1 may have the same or different values according to a subcarrier spacing or a UE capability or presence of additional DMRS or PDSCH transmission length and DMRS type or whether there is overlap between PDCCH and PDSCH in terms of time resource or the number of scheduled RBs or UL switching gap or whether there is overlap between a PUCCH including HARQ-ACK information and another PUSCH.

### [PDSCH: Reception Preparation Time Upon Cross-Carrier Scheduling]

Next, in the case of cross-carrier scheduling in which μPDCCH which is the numerology where PDCCH scheduled next is transmitted and μPDSCH which is the numerology where the PDSCH scheduled through the corresponding PDCCH is transmitted, N-pdsch which is the PDSCH reception preparation time of the UE defined form the time interval between PDCCH and PDSCH may be described.

If μPDCCH<μPDSCH, the scheduled PDSCH may not be transmitted before the first symbol of the slot Npdsch symbols after the last symbol of the PDCCH that has scheduled the PDSCH. The transmission symbol of the corresponding PDSCH may include a DM-RS.

If μPDCCH>μPDSCH, the scheduled PDSCH may be transmitted Npdsch symbols after the last symbol of the PDCCH that has scheduled the PDSCH. The transmission symbol of the corresponding PDSCH may include a DM-RS.

TABLE 8

| μ_{PDCCH} | N_{pdsch} [symbols] |
|---|---|
| 0 | 4 |
| 1 | 5 |
| 2 | 10 |
| 3 | 14 |

Table 8 may include Npdsch according to the scheduled PDCCH subcarrier spacing.

### [PUSCH: Transmission Scheme Related]

Next, a scheduling method for PUSCH transmission may be described. PUSCH transmission may be dynamically scheduled by UL grant in DCI or operated by configured grant type 1 or type 2. Dynamic scheduling indication for PUSCH transmission may be performed in DCI format 0_0 or 0_1.

Configured grant Type 1 PUSCH transmission may be semi-statically configured through reception of configuredGrantConfig including rrc-ConfiguredUplinkGrant of Table 9 through higher layer signaling without reception of the UL grant in the DCI. Configured grant Type 2 PUSCH transmission may be semi-persistently scheduled by the UL grant in the DCI after receiving the configuredGrantConfig that does not include rrc-ConfiguredUplinkGrant of Table 9 through higher layer signaling. When PUSCH transmission is operated by the configured grant, the parameters applied to PUSCH transmission may be applied through configuredGrantConfig which is the higher layer signaling of Table 9 except for the dataScramblingIdentityPUSCH, txConfig, codebookSubset, maxRank, and scaling of UCI-OnPUSCH which are provided through the pusch-Config of Table 10 below which is higher layer signaling. If the UE receives transformPrecoder through configuredGrantConfig, which is higher layer signaling of Table 9, the UE may apply tp-pi2BPSK in pusch-Config of Table 10 for PUSCH transmission operated by the configured grant.

TABLE 9

| | |
|---|---|
| ConfiguredGrantConfig ::= | SEQUENCE { |
| frequencyHopping | ENUMERATED {intraSlot, interSlot} |

OPTIONAL, -- Need S,

| | |
|---|---|
| cg-DMRS-Configuration | DMRS-UplinkConfig, |
| mcs-Table | ENUMERATED {qam256, qam64LowSE} |

OPTIONAL, -- Need S

| | |
|---|---|
| mcs-TableTransformPrecoder | ENUMERATED {qam256, qam64LowSE} |

OPTIONAL, -- Need S

| | |
|---|---|
| uci-OnPUSCH | SetupRelease { CG-UCI-OnPUSCH } |

OPTIONAL, -- Need M

| | |
|---|---|
| resourceAllocation | ENUMERATED { resourceAllocationType0, |

resourceAllocationType1, dynamicSwitch },

| | |
|---|---|
| rbg-Size | ENUMERATED {config2} |

OPTIONAL, -- Need S

| | |
|---|---|
| powerControlLoopToUse | ENUMERATED {n0, n1}, |
| p0-PUSCH-Alpha | P0-PUSCH-AlphaSetId, |
| transformPrecoder | ENUMERATED {enabled, disabled} |

OPTIONAL, -- Need S

| | |
|---|---|
| nrofHARQ-Processes | INTEGER(1..16), |
| repK | ENUMERATED {n1, n2, n4, n8}, |
| repK-RV | ENUMERATED {s1-0231, s2-0303, s3-0000} |

OPTIONAL, -- Need R

| | |
|---|---|
| periodicity | ENUMERATED { |
| | sym2, sym7, sym1x14, sym2x14, sym4x14, sym5x14, |

sym8x14, sym10x14, sym16x14, sym20x14,

sym32x14, sym40x14, sym64x14, sym80x14,

sym128x14, sym160x14, sym256x14, sym320x14, sym512x14,

sym640x14, sym1024x14, sym1280x14, sym2560x14,

sym5120x14,

sym6, sym1x12, sym2x12, sym4x12, sym5x12, sym8x12,

sym10x12, sym16x12, sym20x12, sym32x12,

sym40x12, sym64x12, sym80x12, sym128x12,

sym160x12, sym256x12, sym320x12, sym512x12, sym640x12,

sym1280x12, sym2560x12

},

| | |
|---|---|
| configuredGrantTimer | INTEGER (1..64) |

OPTIONAL, -- Need R

| | |
|---|---|
| rrc-ConfiguredUplinkGrant | SEQUENCE { |
| timeDomainOffset | INTEGER (0..5119), |
| timeDomainAllocation | INTEGER (0..15), |
| frequencyDomainAllocation | BIT STRING (SIZE(18)), |
| antennaPort | INTEGER (0..31), |
| dmrs-SeqInitialization | INTEGER (0..1) |

OPTIONAL, -- Need R

| | |
|---|---|
| precodingAndNumberOfLayers | INTEGER (0..63), |
| srs-ResourceIndicator | INTEGER (0..15) |

OPTIONAL, -- Need R

| | |
|---|---|
| mcsAndTBS | INTEGER (0..31), |
| frequencyHoppingOffset | INTEGER (1.. |
| maxNrofPhysicalResourceBlocks-1) | OPTIONAL, -- Need R |
| pathlossReferenceIndex | INTEGER (0..maxNrofPUSCH- |

PathlossReferenceRSs-1),
...

| | |
|---|---|
| } | OPTIONAL, -- |

Need R
...
}

Next, a PUSCH transmission method may be described. The DMRS antenna port for PUSCH transmission may be the same as the antenna port for SRS transmission. PUSCH transmission may follow a codebook-based transmission method and a non-codebook-based transmission method, respectively, depending on whether the value of txConfig in pusch-Config of Table x2-4, which is higher layer signaling, is ‘codebook’ or ‘nonCodebook’.

As described above, PUSCH transmission may be dynamically scheduled through DCI format 0_0 or 0_1 or be semi-statically configured by the configured grant. If the UE receives an instruction of scheduling on PUSCH transmission through DCI format 0_0, the UE performs beam configuration for PUSCH transmission using pucch-spatialRelationInfoID corresponding to the UE-specific PUCCH resource corresponding to the minimum ID in the uplink BWP activated in the serving cell and, in this case, the PUSCH transmission may be based on a single antenna port. The UE may not expect scheduling for PUSCH transmission through DCI format 0_0 in a BWP in which PUCCH resource including pucch-spatial RelationInfo is not configured. If the UE has not had txConfig in pusch-Config of Table 10 configured thereto, the UE may not expect to be scheduled through DCI format 0_1.

TABLE 10

| | |
|---|---|
| PUSCH-Config ::= | SEQUENCE { |
| dataScramblingIdentityPUSCH | INTEGER (0..1023) |

OPTIONAL, -- Need S

| | |
|---|---|
| txConfig | ENUMERATED {codebook, nonCodebook} |

OPTIONAL, -- Need S

| | |
|---|---|
| dmrs-UplinkForPUSCH-MappingTypeA | SetupRelease { DMRS-UplinkConfig } |

OPTIONAL, -- Need M

| | |
|---|---|
| dmrs-UplinkForPUSCH-MappingTypeB | SetupRelease { DMRS-UplinkConfig } |

OPTIONAL, -- Need M

| | |
|---|---|
| pusch-PowerControl | OPTIONAL, -- |

Need M

| | |
|---|---|
| frequencyHopping | ENUMERATED {intraSlot, interSlot} |

OPTIONAL, -- Need S

| | |
|---|---|
| frequencyHoppingOffsetLists | SEQUENCE (SIZE (1..4)) OF INTEGER (1.. |

maxNrofPhysicalResourceBlocks-1)

OPTIONAL, --

Need M

| | |
|---|---|
| resourceAllocation | ENUMERATED { resourceAllocationType0, |

resourceAllocationType1, dynamicSwitch},

| | |
|---|---|
| pusch-TimeDomainAllocationList | SetupRelease { PUSCH- |
| TimeDomainResourceAllocationList } | OPTIONAL, -- Need M |
| pusch-AggregationFactor | ENUMERATED { n2, n4, n8 } |

OPTIONAL, -- Need S

| | |
|---|---|
| mcs-Table | ENUMERATED {qam256, qam64LowSE} |

OPTIONAL, -- Need S

| | |
|---|---|
| mcs-TableTransformPrecoder | ENUMERATED {qam256, qam64LowSE} |

OPTIONAL, -- Need S

| | |
|---|---|
| transformPrecoder | ENUMERATED {enabled, disabled} |

OPTIONAL, -- Need S

| | |
|---|---|
| codebookSubset | ENUMERATED {fullyAndPartialAndNonCoherent, |

partialAndNonCoherent,nonCoherent}

OPTIONAL, -- Cond

codebookBased

| | |
|---|---|
| maxRank | INTEGER (1..4) |

OPTIONAL, -- Cond codebookBased

| | |
|---|---|
| rbg-Size | ENUMERATED { config2} |

OPTIONAL, -- Need S

| | |
|---|---|
| uci-OnPUSCH | SetupRelease { UCI-OnPUSCH} |

OPTIONAL, -- Need M

| | |
|---|---|
| tp-pi2BPSK | ENUMERATED {enabled} |

OPTIONAL, -- Need S
...
}

Next, codebook-based PUSCH transmission may be described. Codebook-based PUSCH transmission may be dynamically operated through DCI format 0_0 or 0_1 or be semi-statically configured by the configured grant. If dynamically scheduled by codebook-based PUSCH DCI format 0_1 or semi-statically configured by configured grant, the UE may determine a precoder for PUSCH transmission based on the SRS resource indicator (SRI), transmission precoding matrix indicator (TPMI), and transmission rank (number of PUSCH transmission layers).

In this case, the SRI may be given through a field SRS resource indicator in the DCI or configured through srs-ResourceIndicator which is higher layer signaling. The UE may have at least one SRS resource, up to two SRS resources, configured thereto upon codebook-based PUSCH transmission. When the UE receives the SRI through the DCI, the SRS resource indicated by the corresponding SRI may mean the SRS resource corresponding to the SRI among SRS resources transmitted prior to the PDCCH including the SRI. Further, the TPMI and transmission rank may be given through the field precoding information and number of layers in the DCI or configured through precodingAndNumberOfLayers, which is higher level signaling. The TPMI may be used to indicate the precoder applied to PUSCH transmission. If the UE is configured with one SRS resource, the TPMI may be used to indicate a precoder to be applied in the configured one SRS resource. If the UE is configured with a plurality of SRS resources, the TPMI may be used to indicate a precoder to be applied in the SRS resource indicated through the SRI.

The precoder to be used for PUSCH transmission may be selected from an uplink codebook having the same number of antenna ports as the nrofSRS-Ports value in SRS-Config, which is higher layer signaling. In codebook-based PUSCH transmission, the UE may determine a codebook subset based on the TPMI and codebookSubset in pusch-Config, which is higher layer signaling. codebookSubset in pusch-Config, which is higher layer signaling, may be set to one of ‘fullyAndPartialAndNonCoherent’, ‘partialAndNonCoherent’, or ‘nonCoherent’ based on the UE capability reported by the UE to the base station. If the UE reports ‘partialAndNonCoherent’ as the UE capability, the UE may not expect the value of codebookSubset, which is higher layer signaling, to be set to ‘fully AndPartial AndNonCoherent’. Further, if the UE reports ‘nonCoherent’ as the UE capability, the UE may not expect the value of codebook Subset, which is higher layer signaling, to be to set ‘fully AndPartialAndNonCoherent’ or ‘partialAndNonCoherent’. If nrofSRS-Ports in SRS-ResourceSet, which is higher layer signaling, indicates two SRS antenna ports, the UE may not expect the value of codebookSubset, which is higher layer signaling, to be set to ‘partial AndNonCoherent’.

The UE may have one SRS resource set, in which the value of usage in SRS-ResourceSet, which is higher layer signaling, is set to ‘codebook,’ configured thereto, and one SRS resource in the corresponding SRS resource set may be indicated through the SRI. If several SRS resources are configured in the SRS resource set in which the usage value in the SRS-ResourceSet, which is higher layer signaling, is set to ‘codebook’, the UE may expect the same value to be set for all SRS resources in the nrofSRS-Ports value in the SRS-Resource which is higher layer signaling.

The UE may transmit one or more SRS resources included in the SRS resource set in which the value of usage is set to ‘codebook’ according to higher layer signaling to the base station, and the base station may select one of the SRS resources transmitted by the UE and instruct the UE to perform PUSCH transmission using transmission beam information about the corresponding SRS resource. In this case, in codebook-based PUSCH transmission, the SRI is used as information for selecting an index of one SRS resource and may be included in the DCI. Additionally, the base station may include information indicating the TPMI and rank to be used by the UE for PUSCH transmission in the DCI. The UE may perform PUSCH transmission by applying the precoder indicated by the rank and TPMI indicated by the transmission beam of the SRS resource using the SRS resource indicated by the SRI.

Next, codebook-based PUSCH transmission may be described. Non-codebook-based PUSCH transmission may be dynamically operated through DCI format 0_0 or 0_1 or be semi-statically configured by the configured grant. When at least one SRS resource is configured in the SRS resource set in which the value of usage in the SRS-ResourceSet, which is higher layer signaling, is set to ‘nonCodebook’, the UE may be scheduled for non-codebook based PUSCH transmission through DCI format 0_1.

For the SRS resource set in which the value of usage in the SRS-ResourceSet, which is higher layer signaling, is set to ‘nonCodebook’, the UE may be configured with one connected non-zero power CSI-RS (NZP CSI-RS) resource. The UE may perform calculation on the precoder for SRS transmission through measurement of the NZP CSI-RS resource connected with the SRS resource set. If the difference between the last received symbol of the aperiodic NZP CSI-RS resource connected with the SRS resource set and the first symbol of aperiodic SRS transmission in the UE is smaller than 42 symbols, the UE may not expect that information about the precoder for SRS transmission is updated.

If the value of resourceType in SRS-ResourceSet, which is higher layer signaling, is set to ‘aperiodic’, the connected NZP CSI-RS may be indicated by an SRS request, which is a field in DCI format 0_1 or 1_1. In this case, if the connected NZP CSI-RS resource is an aperiodic NZP CSI resource, it may indicate that there is a connected NZP CSI-RS for the case where the value of the field SRS request in DCI format 0_1 or 1_1 is not ‘00.’ In this case, the DCI may be required not to indicate cross carrier or cross BWP scheduling. Further, if the value of the SRS request may indicate the presence of the NZP CSI-RS, the NZP CSI-RS may be positioned in the slot in which the PDCCH including the SRS request field is transmitted. In this case, TCI states configured in the scheduled subcarrier may not be set to quasi co-located (QCL)-typeD.

If a periodic or semi-persistent SRS resource set is configured, the connected NZP CSI-RS may be indicated through associatedCSI-RS in the SRS-ResourceSet, which is higher layer signaling. For non-codebook-based transmission, the UE may not expect spatialRelationInfo, which is higher layer signaling for SRS resource, and associatedCSI-RS in SRS-ResourceSet, which is higher layer signaling, to be configured together.

When a plurality of SRS resources are configured to the UE, the UE may determine the precoder and transmission rank to be applied to PUSCH transmission based on the SRI indicated by the base station. In this case, the SRI may be indicated through a field SRS resource indicator in the DCI or be configured through srs-ResourceIndicator which is higher layer signaling. Like the above-described codebook-based PUSCH transmission, when the UE receives the SRI through the DCI, the SRS resource indicated by the corresponding SRI may mean the SRS resource corresponding to the SRI among SRS resources transmitted prior to the PDCCH including the SRI. The UE may use one or more SRS resources for SRS transmission. The maximum number of SRS resources and the maximum number of SRS resources that may be simultaneously transmitted in the same symbol within one SRS resource set may be determined by the UE capability reported by the UE to the base station. In this case, the SRS resources transmitted simultaneously by the UE may occupy the same RB. The UE may configure one SRS port for each SRS resource. Only one SRS resource set in which the value of usage in the SRS-ResourceSet, which is higher layer signaling, is set to ‘nonCodebook’ may be configured, and up to 4 SRS resources may be configured for non-codebook-based PUSCH transmission.

The base station may transmit one NZP CSI-RS connected with the SRS resource set to the UE, and the UE may calculate the precoder to be used for transmission of one or more SRS resources in the SRS resource set based on the measurement result upon NZP CSI-RS reception. The UE may apply the calculated precoder when transmitting one or more SRS resources in the SRS resource set with usage set to ‘nonCodebook’ to the base station, and the base station may select one or more SRS resources among one or more SRS resources received. In this case, in non-codebook based PUSCH transmission, the SRI indicates an index that may represent a combination of one or a plurality of SRS resources, and the SRI may be included in the DCI. In this case, the number of SRS resources indicated by the SRI transmitted by the base station may be the number of transmission layers of the PUSCH. The UE may apply the precoder applied to SRS resource transmission to each layer and transmit the PUSCH.

### [PUSCH: Preparation Procedure Time]

Next, the PUSCH preparation procedure time may be described. When the base station schedules the UE to transmit the PUSCH using DCI format 0_0, 0_1, or 0_2, the UE may require a PUSCH preparation procedure time to apply the transmission precoding method, number of transmission layers, and spatial domain transmission filter to the transmission method (SRS resource) indicated through the DCI and transmit the PUSCH. Given this, NR may define the PUSCH preparation procedure time. The PUSCH preparation procedure time of the UE may follow Equation 2 below.

$$Tproc , 2 = max ( ( N 2 + d 2 , 1 + d 2 ) ( 2048 + 144 ) κ 2 - μ Tc + Text + Tswitch , d 2 , 2 ) \qquad Equation 2$$

In Tproc,2 described above by Equation 2, each variable may have the following meaning.
N2: The number of symbols determined according to UE processing capability 1 or 2 and numerology μ according to the capabilities of the UE. When UE processing capability 1 is reported according to the UE capability report, it may have the value of Table 11 below. When UE processing capability 2 is reported, and it is set through higher layer signaling to be able to use UE processing capability 2, it may have the value of Table 12.

TABLE 11

| | PUSCH preparation time N₂ |
|---|---|
| μ | [symbols] |
| 0 | 10 |
| 1 | 12 |
| 2 | 23 |
| 3 | 36 |

TABLE 12

| | PUSCH preparation time N₂ |
|---|---|
| μ | [symbols] |
| 0 | 5 |
| 1 | 5.5 |
| 2 | 11 for frequency range 1 |

d2, 1: The number of symbols set to 0 if all of the resource elements of the first OFDM symbol of the PUSCH transmission are configured to consist only of DM-RS, and 1 otherwise.
κ: 64
μ: Of μ_{DL} or μ_{DL}, it may include the value where Tproc,2 is bigger. μ_{DL} may mean the numerology of the downlink where the PDCCH including the DCI scheduling PUSCH is transmitted, and μ_{DL} may mean the numerology of the uplink where the PUSCH is transmitted.
Tc: may have 1/(Δfₘₐₓ·N_{f}), Δfₘₐₓ=480·10³ Hz, N_{f}=4096
d2,2: This follows the BWP switching time when the DCI scheduling PUSCH indicates BWP switching and, otherwise, may be 0.
d2: When the PUCCH overlaps, in OFDM symbols on the time axis, the PUSCH having a high priority index and the PUCCH having a low priority index, the d2 value of the PUSCH having a high priority index may be used. Otherwise, d2 may be 0.
Text: When the UE uses a shared spectrum channel access scheme, the UE may calculate Text and apply it to the PUSCH preparation process time. Otherwise, Text may be assumed to be 0.
Tswitch: When the uplink switching interval is triggered, Tswitch may be assumed to be the switching time interval. Otherwise, it may be assumed to be 0.

Considering the time axis resource mapping information for the PUSCH scheduled through DCI and the effect of the timing advance between uplink and downlink, if the first symbol of the PUSCH starts before the first uplink symbol for which the CP starts Tproc,2 after the last symbol of the PDCCH including the DCI scheduling the PUSCH, the base station and the UE may determine that the PUSCH preparation procedure time is not sufficient. Otherwise, the base station and the UE may determine that the PUSCH preparation procedure time is sufficient. The UE may transmit the PUSCH only when the PUSCH preparation procedure time is sufficient and may disregard DCI scheduling PUSCH when the PUSCH preparation procedure time is not sufficient.

### [PUSCH: Repeated Transmission Related]

Repeated transmission of an uplink data channel in a 5G system may be described below in detail. The 5G system may support two types, PUSCH repeated transmission type A and PUSCH repeated transmission type B, as repeated transmission methods of an uplink data channel. The UE may have either PUSCH repeated transmission type A or B configured thereto by higher layer signaling.

### PUSCH Repeated Transmission Type A

As described above, by the time domain resource allocation method in one slot, the symbol length and start symbol position of the uplink data channel may be transmitted, and the base station may notify the UE of the number of repeated transmissions through higher layer signaling (e.g., RRC signaling) or L1 signaling (e.g., DCI).

The UE may repeatedly transmit uplink data channels, which are identical in length and start symbol to the configured uplink data channel, in consecutive slots based on the number of repeated transmissions received from the base station. In this case, when at least one symbol among the symbols of the uplink data channel configured to the UE or the slot configured to the UE through downlink by the base station is configured through downlink, the UE may omit uplink data channel transmission but count the number of uplink data channel repeated transmissions.

### PUSCH Repeated Transmission Type B

As described above, as the time domain resource allocation method in one slot, the start symbol and length of the uplink data channel may be transmitted, and the base station may notify the UE of the number of repeated transmissions, numberofrepetitions, through higher layer signaling (e.g., RRC signaling) or L1 signaling (e.g., DCI).

First, the nominal repetition of the uplink data channel may be determined as follows based on the start symbol and length of the uplink data channel configured above. The slot where the nth nominal repetition starts is given by

$${K}_{s} + ⌊ \frac{S + n \cdot L}{{N}_{symb}^{slot}} ⌋ ,$$

and the symbol which starts in the slot may be given by

$$mod ( S + n \cdot L , {N}_{symb}^{slot} ) .$$

The slot where the nth nominal repetition starts may be given by

$${K}_{s} + ⌊ \frac{S + ( n + 1 ) \cdot L - 1}{{N}_{symb}^{slot}} ⌋ ,$$

and the symbol which ends in the slot may be given by

$$mod ( S + ( n + 1 ) \cdot L - 1 , {N}_{symb}^{slot} ) .$$

Here, n=0, . . . , numberofrepetitions−1, S may indicate the start symbol of the configured uplink data channel, and L may indicate the symbol length of the configured uplink data channel. Kₛ may indicate the slot in which PUSCH transmission starts, and

$${N}_{symb}^{slot}$$

may indicate the number of symbols per slot.

The UE may determine an invalid symbol for PUSCH repeated transmission type B. The symbol configured as downlink by tdd-UL-DL-ConfigurationCommon or tdd-UL-DL-ConfigurationDedicated may be determined to be an invalid symbol for PUSCH repeated transmission type B. Additionally, invalid symbols may be configured in higher layer parameters (e.g., InvalidSymbolPattern). As the higher layer parameter (e.g., InvalidSymbolPattern) provides a symbol level bitmap over one or two slots, an invalid symbol may be configured. 1 in the bitmap may represent an invalid symbol. Additionally, the periodicity and pattern of the bitmap may be configured through the higher layer parameter (e.g. periodicity AndPattern). If the higher layer parameter (e.g. InvalidSymbolPattern) is configured, and InvalidSymbolPatternIndicator-ForDCIFormat0_1 or InvalidSymbolPatternIndicator-ForDCIFormat0_2 parameter indicates 1, the UE may apply the invalid symbol pattern and, if it indicates 0, the UE may not apply the invalid symbol pattern. Or, if the higher layer parameter (e.g. InvalidSymbolPattern) may be configured, and InvalidSymbolPatternIndicator-ForDCIFormat0_1 or InvalidSymbolPatternIndicator-ForDCIFormat0_2 parameter is not configured, the UE may apply the invalid symbol pattern.

After the invalid symbol is determined, for each nominal repetition, the UE may consider symbols other than the invalid symbol as valid symbols. If each nominal repetition includes one or more valid symbols, the nominal repetition may include one or more actual repetitions. Here, each actual repetition may include a contiguous set of valid symbols that may be used for PUSCH repeated transmission type B in one slot.

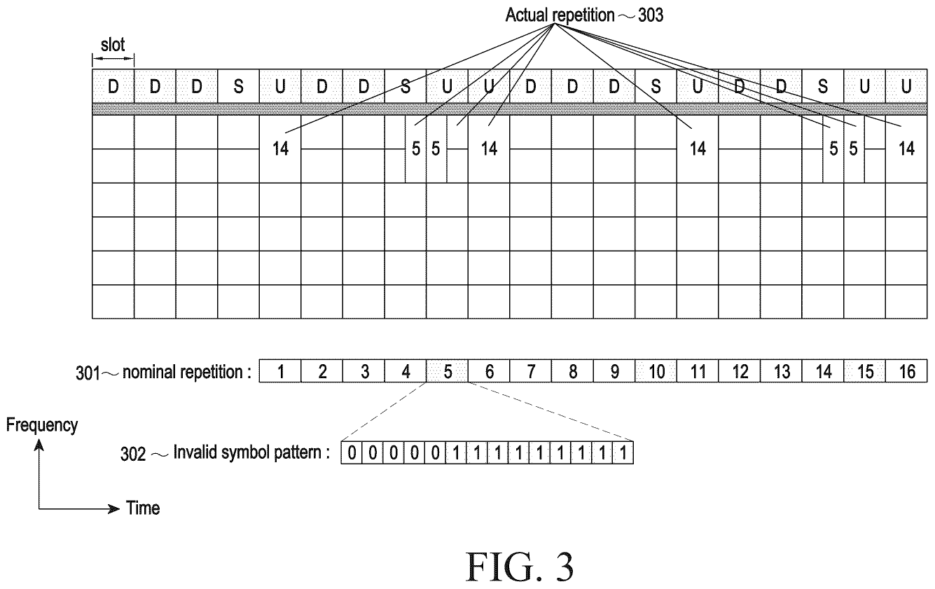

FIG. 3 is a view illustrating an example of PUSCH repeated transmission type B in a wireless communication system according to an embodiment of the disclosure.

Referring to FIG. 3, the UE may have the start symbol set to 0 and the uplink data channel length L set to 14 and may have the number of repeated transmissions set to 16. In this case, nominal repetition (301) is indicated in 16 contiguous slots. Thereafter, the UE may determine symbols set as downlink symbols in each nominal repetition 301 as invalid symbols. Further, the UE may determine symbols set to 1 in the invalid symbol pattern 302 as invalid symbols. In each nominal repetition, when valid symbols, not invalid symbols, are constituted of one or more contiguous symbols in one slot, they may be set as actual repetitions and transmitted (303).

Further, for repeated PUSCH transmission, NR Release 16 may define the following additional methods for UL grant-based PUSCH transmission and configured grant-based PUSCH transmission across slot boundaries.
Method 1 (mini-slot level repetition): Through one UL grant, two or more PUSCH repeated transmissions may be scheduled within one slot or across the boundary of contiguous slots. Further, for method 1, time domain resource allocation information in DCI indicates resources of the first repeated transmission. Further, the time domain resource information of the remaining repeated transmissions may be determined according to the uplink or downlink direction that is determined for each symbol in each slot and the time domain resource information of the first repeated transmission. Each repeated transmission may occupy contiguous symbols.
Method 2 (multi-segment transmission): Two or more repeated PUSCH transmissions may be scheduled in contiguous slots through one UL grant. In this case, one transmission is designated for each slot, and the start point or repetition length may differ for each transmission. Further, in method 2, time domain resource allocation information in DCI may include the start point and repetition length of all repeated transmissions. Further, when repeated transmission is performed within a single slot through method 2, if there are several bundles of contiguous symbols in the corresponding slot, each repeated transmission may be performed for each uplink symbol bundle. If a unique bundle of contiguous uplink symbols is present in the corresponding slot, one PUSCH repeated transmission may be performed according to the method of NR release 15.
Method 3: Two or more repeated PUSCH transmissions may be scheduled in contiguous slots through two or more UL grants. In this case, one transmission is designated for each slot, and the nth UL grant may be received before the PUSCH transmission scheduled by the n−1th UL grant is ended.
Method 4: Through one UL grant or one configured grant, one or more PUSCH repeated transmissions in a single slot or two or more PUSCH repeated transmissions over the boundary of consecutive slots may be supported. The number of repetitions indicated by the base station to the UE is only a nominal value, and the number of repeated PUSCH transmissions actually performed by the UE may be larger than the nominal number of repetitions. The time domain resource allocation information in DCI or configured grant may mean the resource of the first repeated transmission indicated by the base station. The time domain resource information about the remaining repeated transmissions may be determined by referring to the uplink or downlink direction of symbols and the resource information about at least the first repeated transmission. If the time domain resource information about the repeated transmission indicated by the base station is over the slot boundary or includes the uplink/downlink switching point, the corresponding repeated transmission may be divided into a plurality of repeated transmissions. In this case, one repeated transmission may be included for each uplink period in one slot.

### [PUSCH: Frequency Hopping Process]

Frequency hopping of the uplink data channel (physical uplink shared channel (PUSCH)) in the 5G system may be described below in detail.

5G may support two methods supported for each PUSCH repeated transmission type, as a frequency hopping method for an uplink data channel. First, PUSCH repeated transmission type A may support intra-slot frequency hopping and inter-slot frequency hopping, and PUSCH repeated transmission type B supports inter-repetition frequency hopping and inter-slot frequency hopping.

The intra-slot frequency hopping method supported by PUSCH repeated transmission type A may be a method in which the UE changes and transmits the allocated resources of the frequency domain by a set frequency offset in two hops within one slot. In intra-slot frequency hopping, the start RB of each hop may be expressed through Equation 3.

$${RB}_{start} = \{ \begin{matrix}{RB}_{start} & i = 0 \\ ( {RB}_{start} + {RB}_{offset} ) mod {N}_{BWP}^{size} & i = 1\end{matrix} \qquad Equation 3$$

In Equation 3, i=0 and i=1 represent the first hop and the second hop, respectively, and RBₛₜₐᵣₜ denotes the start RB in the UL BWP and may be calculated from the frequency resource allocation method. RB_{offset} may denote the frequency offset between two hops through the higher layer parameter. The number of symbols in the first hop may be represented as

$$⌊ {N}_{symb}^{PUSCH , s} / 2 ⌋ ,$$

and the number of symbols in the second hop may be represented as

$${N}_{symb}^{PUSCH , s} - ⌊ {N}_{symb}^{PUSCH , s} / 2 ⌋ \cdot {N}_{symb}^{PUSCH , s}$$

is the length of PUSCH transmission within one slot and may be represented as the number of OFDM symbols.

Next, the inter-slot frequency hopping method supported by PUSCH repeated transmission types A and B may be a method in which the UE changes and transmits the allocated resources of the frequency domain by a set frequency offset in each slot. In inter-slot frequency hopping, the start RB during

$${n}_{s}^{μ}$$

slot may be expressed through Equation 4.

$${RB}_{start} ( {n}_{s}^{μ} ) = \{ \begin{matrix}{RB}_{start} & {n}_{s}^{μ} mod 2 = 0 \\ ( {RB}_{start} + {RB}_{offset} ) mod {N}_{BWP}^{size} & {n}_{s}^{μ} mod 2 = 1\end{matrix} \qquad Equation 4$$

In Equation 4,

$${n}_{s}^{μ}$$

denotes the current slot number in multi-slot PUSCH transmission, RBₛₜₐᵣₜ denotes the start RB in the UL BWP and may be calculated from the frequency resource allocation method. RB_{offset} may denote the frequency offset between two hops through the higher layer parameter.

Next, the inter-repetition frequency hopping method supported by PUSCH repeated transmission type B may move and transmit resources allocated in the frequency domain for one or more actual repetitions within each nominal repetition by a set frequency offset. RBstart(n) that is the index of the start RB in the frequency domain for one or more actual repetitions within the nth nominal repetition may follow Equation 5 below.

$${RB}_{start} ( n ) = \{ \begin{matrix}{RB}_{start} & n mod 2 = 0 \\ ( {RB}_{start} + {RB}_{offset} ) mod {N}_{BWP}^{size} & n mod 2 = 1\end{matrix} \qquad Equation 5$$

In Equation 5, n may denote the index of nominal repetition, and RB offset denotes the RB offset between two hops through a higher layer parameter.

### [PUSCH: Multiplexing Rule Upon AP/SP CSI Reporting]

A method for measuring and reporting the channel state in a 5G communication system may be described below in detail. Channel state information (CSI) may include a channel quality information (CQI), precoding matric indicator (PMI), CSI-RS resource indicator (CRI), SS/PBCH block resource indicator (SSBRI), layer indicator (LI), rank indicator (RI), and/or L1-reference signal received power (RSRP). The base station may control time and frequency resources for the above-described CSI measurement and reporting of the UE.

For CSI measurement and reporting, the UE may receive a configuration of at least one of configuration information (CSI-ReportConfig) for N(≥1) CSI reports, configuration information (CSI-ResourceConfig) for M(≥1) RS transmission resources, or list information (CSI-AperiodicTriggerStateList, CSI-SemiPersistentOnPUSCH-TriggerStateList) for one or two trigger states through higher layer signaling. More specifically, the above-described configuration information for CSI measurement and reporting may be as shown below in Tables 13 to 18.

Table 13 may include the following content. Table 13 may be for CSI-ReportConFIG. Table 13 may include CSI-ReportConfig information element. The IE CSI-ReportConfig is used to configure a periodic or semi-persistent report sent on PUCCH on the cell in which the CSI-ReportConfig is included, or to configure a semi-persistent or aperiodic report sent on PUSCH triggered by DCI received on the cell in which the CSI-ReportConfig is included (in this case, the cell on which the report is sent is determined by the received DCI). See TS 38.214[19], clause 5.2.1.

TABLE 13
-- ASN1START
-- TAG-CSI-REPORTCONFIG-START

| CSI-ReportConfig ::= | SEQUENCE { | |
|---|---|---|
| reportConfigId | CSI-ReportConfigId, | |
| carrier | ServCellIndex | OPTIONAL, -- Need S |
| resourcesForChannelMeasurement | CSI-ResourceConfigId, | |
| csi-IM-ResourcesForInterference | CSI-ResourceConfigId | OPTIONAL, -- Need R |
| nzp-CSI-RS-ResourcesForInterference | CSI-ResourceConfigId | OPTIONAL, -- Need |

R

| | |
|---|---|
| reportConfigType | CHOICE { |
| periodic | SEQUENCE { |
| reportSlotConfig | CSI-ReportPeriodicityAndOffset, |
| pucch-CSI-ResourceList | SEQUENCE (SIZE (1..maxNrofBWPs)) OF PUCCH-CSI- |

Resource
},

| | |
|---|---|
| semiPersistentOnPUCCH | SEQUENCE { |
| reportSlotConfig | CSI-ReportPeriodicityAndOffset, |
| pucch-CSI-ResourceList | SEQUENCE (SIZE (1..maxNrofBWPs)) OF PUCCH-CSI- |

Resource
},

| | |
|---|---|
| semiPersistentOnPUSCH | SEQUENCE { |
| reportSlotConfig | ENUMERATED {sl5, sl10, sl20, sl40, sl80, sl160, sl320}, |
| reportSlotOffsetList | SEQUENCE (SIZE (1..maxNrofUL-Allocations)) OF |

INTEGER(0..32),

| | |
|---|---|
| p0alpha | P0-PUSCH-AlphaSetId |

},

| | |
|---|---|
| aperiodic | SEQUENCE { |
| reportSlotOffsetList | SEQUENCE (SIZE (1..maxNrofUL-Allocations)) OF |

```
INTEGER(0..32)
    }
  },
```

| reportQuantity | CHOICE { | |
|---|---|---|
| none | NULL, | |
| cri-RI-PMI-CQI | NULL, | |
| cri-RI-i1 | NULL, | |
| cri-RI-i1-CQI | SEQUENCE { | |
| pdsch-BundleSizeForCSI | ENUMERATED {n2, n4} | OPTIONAL |

-- Need S
},

| | |
|---|---|
| cri-RI-CQI | NULL, |
| cri-RSRP | NULL, |
| ssb-Index-RSRP | NULL, |
| cri-RI-LI-PMI-CQI | NULL |

},

| | |
|---|---|
| reportFreqConfiguration | SEQUENCE { |
| cqi-FormatIndicator | ENUMERATED { widebandCQI, subbandCQI } |

OPTIONAL, -- Need R

| | |
|---|---|
| pmi-FormatIndicator | ENUMERATED { widebandPMI, subbandPMI } |

OPTIONAL, -- Need R

| | |
|---|---|
| csi-ReportingBand | CHOICE { |
| subbands3 | BIT STRING(SIZE(3)), |
| subbands4 | BIT STRING(SIZE(4)), |
| subbands5 | BIT STRING(SIZE(5)), |
| subbands6 | BIT STRING(SIZE(6)), |
| subbands7 | BIT STRING(SIZE(7)), |
| subbands8 | BIT STRING(SIZE(8)), |
| subbands9 | BIT STRING(SIZE(9)), |
| subbands10 | BIT STRING(SIZE(10)), |
| subbands11 | BIT STRING(SIZE(13)), |
| subbands12 | BIT STRING(SIZE(12)), |
| subbands13 | BIT STRING(SIZE(4)), |
| subbands14 | BIT STRING(SIZE(13)), |
| subbands15 | BIT STRING(SIZE(12)), |
| subbands16 | BIT STRING(SIZE(13)), |
| subbands17 | BIT STRING(SIZE(17)), |
| subbands18 | BIT STRING(SIZE(18)), |

...,

| | |
|---|---|
| subbands19-v1530 | BIT STRING(SIZE(19)) |

} OPTIONAL -- Need S

| | |
|---|---|
| } | OPTIONAL, -- Need R |
| timeRestrictionForChannelMeasurements | ENUMERATED {configured, |

notConfigured},

| | |
|---|---|
| timeRestrictionForInterferenceMeasurements | ENUMERATED {configured, |

notConfigured},

| | | |
|---|---|---|
| codebookConfig | CodebookConfig | OPTIONAL, |

-- Need R

| | | |
|---|---|---|
| dummy | ENUMERATED {n1, n2} | OPTIONAL, |

-- Need R

| groupBasedBeamReporting | CHOICE { | |
|---|---|---|
| enabled | NULL, | |
| disabled | SEQUENCE { | |
| nrofReportedRS | ENUMERATED {n1, n2, n3, n4} | OPTIONAL |

```
-- Need S
    }
  },
```

| | |
|---|---|
| cqi-Table | ENUMERATED {table1, table2, table3, spare1} |

OPTIONAL, -- Need R

| | |
|---|---|
| subbandSize | ENUMERATED {value1, value2}, |
| non-PMI-PortIndication | SEQUENCE (SIZE (1..maxNrofNZP-CSI-RS-ResourcesPerConfig)) |

```
OF PortIndexFor8Ranks OPTIONAL, -- Need R
  ...,
  [[
```

| | |
|---|---|
| semiPersistentOnPUSCH-v1530 | SEQUENCE { |
| reportSlotConfig-v1530 | ENUMERATED {sl4, sl8, sl16} |

| | |
|---|---|
| } | OPTIONAL -- Need R |

```
  ]],
  [[
```

| | |
|---|---|
| semiPersistentOnPUSCH-v1610 | SEQUENCE { |
| reportSlotOffsetListDCI-0-2-r16 | SEQUENCE (SIZE (1.. maxNrofUL-Allocations-r16)) OF |

INTEGER(0..32) OPTIONAL, -- Need R

| | |
|---|---|
| reportSlotOffsetListDCI-0-1-r16 | SEQUENCE (SIZE (1.. maxNrofUL-Allocations-r16)) OF |

INTEGER(0..32) OPTIONAL -- Need R

| | |
|---|---|
| } | OPTIONAL, -- Need R |

| | |
|---|---|
| aperiodic-v1610 | SEQUENCE { |
| reportSlotOffsetListDCI-0-2-r16 | SEQUENCE (SIZE (1.. maxNrofUL-Allocations-r16)) OF |

INTEGER(0..32) OPTIONAL, -- Need R

| | |
|---|---|
| reportSlotOffsetListDCI-0-1-r16 | SEQUENCE (SIZE (1.. maxNrofUL-Allocations-r16)) OF |

INTEGER(0..32) OPTIONAL -- Need R

| } | | OPTIONAL, -- Need R |
|---|---|---|
| reportQuantity-r16 | CHOICE { | |
| cri-SINR-r16 | NULL, | |
| ssb-Index-SINR-r16 | NULL | |
| } | | OPTIONAL, -- Need R |
| codebookConfig-r16 | CodebookConfig-r16 | OPTIONAL |

-- Need R
]]
}

| | |
|---|---|
| CSI-ReportPeriodicityAndOffset ::= | CHOICE { |
| slots4 | INTEGER(0..3), |
| slots5 | INTEGER(0..4), |
| slots8 | INTEGER(0..7), |
| slots10 | INTEGER(0..9), |
| slots16 | INTEGER(0..15), |
| slots20 | INTEGER(0..19), |
| slots40 | INTEGER(0..39), |
| slots80 | INTEGER(0..79), |
| slots160 | INTEGER(0..159), |
| slots320 | INTEGER(0..319) |

}

| | |
|---|---|
| PUCCH-CSI-Resource ::= | SEQUENCE { |
| uplinkBandwidthPartId | BWP-Id, |
| pucch-Resource | PUCCH-ResourceId |

}

| PortIndexFor8Ranks ::= | CHOICE { | |
|---|---|---|
| portIndex8 | SEQUENCE{ | |
| rank1-8 | PortIndex8 | OPTIONAL, -- Need |

R

| | | |
|---|---|---|
| rank2-8 | SEQUENCE(SIZE(2)) OF PortIndex8 | OPTIONAL, |

-- Need R

| | | |
|---|---|---|
| rank3-8 | SEQUENCE(SIZE(3)) OF PortIndex8 | OPTIONAL, |

-- Need R

| | | |
|---|---|---|
| rank4-8 | SEQUENCE(SIZE(4)) OF PortIndex8 | OPTIONAL, |

-- Need R

| | | |
|---|---|---|
| rank5-8 | SEQUENCE(SIZE(5)) OF PortIndex8 | OPTIONAL, |

-- Need R

| | | |
|---|---|---|
| rank6-8 | SEQUENCE(SIZE(6)) OF PortIndex8 | OPTIONAL, |

-- Need R

| | | |
|---|---|---|
| rank7-8 | SEQUENCE(SIZE(7)) OF PortIndex8 | OPTIONAL, |

-- Need R

| | | |
|---|---|---|
| rank8-8 | SEQUENCE(SIZE(8)) OF PortIndex8 | OPTIONAL |

-- Need R
},

| portIndex4 | SEQUENCE{ | |
|---|---|---|
| rank1-4 | PortIndex4 | OPTIONAL, -- Need |

R

| | | |
|---|---|---|
| rank2-4 | SEQUENCE(SIZE(2)) OF PortIndex4 | OPTIONAL, |

-- Need R

| | | |
|---|---|---|
| rank3-4 | SEQUENCE(SIZE(3)) OF PortIndex4 | OPTIONAL, |

-- Need R

| | | |
|---|---|---|
| rank4-4 | SEQUENCE(SIZE(4)) OF PortIndex4 | OPTIONAL |

-- Need R
},

| portIndex2 | SEQUENCE{ | |
|---|---|---|
| rank1-2 | PortIndex2 | OPTIONAL, -- Need |

R

| | | |
|---|---|---|
| rank2-2 | SEQUENCE(SIZE(2)) OF PortIndex2 | OPTIONAL |

-- Need R
},

| | |
|---|---|
| portIndex1 | NULL |

}

| | |
|---|---|
| PortIndex8::= | INTEGER (0..7) |
| PortIndex4::= | INTEGER (0..3) |
| PortIndex2::= | INTEGER (0..1) |

-- TAG-CSI-REPORTCONFIG-STOP
-- ASN1STOP
CSI-ReportConfig field descriptions
carrier
Indicates in which serving cell the CSI-ResourceConfig indicated below are to be found. If
the field is absent, the resources are on the same serving cell as this report configuration.
codebookConfig
Codebook configuration for Type-1 or Type-2 including codebook subset restriction.
Network does not configure codebookConfig and codebookConfig-r16 simultaneously to a
UE
cqi-FormatIndicator
Indicates whether the UE shall report a single (wideband) or multiple (subband) CQI. (see
TS 38.214 [19], clause 5.2.1.4).
cqi-Table
Which CQI table to use for CQI calculation (see TS 38.214 [19], clause 5.2.2.1).
csi-IM-ResourcesForInterference
CSI IM resources for interference measurement. csi-ResourceConfigId of a CSI-
ResourceConfig included in the configuration of the serving cell indicated with the field
“carrier” above. The CSI-ResourceConfig indicated here contains only CSI-IM resources.
The bwp-Id in that CSI-ResourceConfig is the same value as the bwp-Id in the CSI-
ResourceConfig indicated by resourcesForChannelMeasurement.
csi-ReportingBand
Indicates a contiguous or non-contiguous subset of subbands in the bandwidth part which
CSI shall be reported for. Each bit in the bit-string represents one subband. The right-most
bit in the bit string represents the lowest subband in the BWP. The choice determines the
number of subbands (subbands3 for 3 subbands, subbands4 for 4 subbands, and so on) (see
TS 38.214 [19], clause 5.2.1.4). This field is absent if there are less than 24 PRBs (no sub
band) and present otherwise, the number of sub bands can be from 3 (24 PRBs, sub band
size 8) to 18 (72 PRBs, sub band size 4).
dummy
This field is not used in the specification. If received it shall be ignored by the UE.
groupBasedBeamReporting
Turning on/off group beam based reporting (see TS 38.214 [19], clause 5.2.1.4).
non-PMI-PortIndication
Port indication for RI/CQI calculation. For each CSI-RS resource in the linked
ResourceConfig for channel measurement, a port indication for each rank R, indicating
which R ports to use. Applicable only for non-PMI feedback (see TS 38.214 [19], clause
5.2.1.4.2).
The first entry in non-PMI-PortIndication corresponds to the NZP-CSI-RS-Resource
indicated by the first entry in nzp-CSI-RS-Resources in the NZP-CSI-RS-ResourceSet
indicated in the first entry of nzp-CSI-RS-ResourceSetList of the CSI-ResourceConfig whose
CSI-ResourceConfigId is indicated in a CSI-MeasId together with the above CSI-
ReportConfigId; the second entry in non-PMI-PortIndication corresponds to the NZP-CSI-
RS-Resource indicated by the second entry in nzp-CSI-RS-Resources in the NZP-CSI-RS-
ResourceSet indicated in the first entry of nzp-CSI-RS-ResourceSetList of the same CSI-
ResourceConfig, and so on until the NZP-CSI-RS-Resource indicated by the last entry in
nzp-CSI-RS-Resources in the in the NZP-CSI-RS-ResourceSet indicated in the first entry of
nzp-CSI-RS-ResourceSetList of the same CSI-ResourceConfig. Then the next entry
corresponds to the NZP-CSI-RS-Resource indicated by the first entry in nzp-CSI-RS-
Resources in the NZP-CSI-RS-ResourceSet indicated in the second entry of nzp-CSI-RS-
ResourceSetList of the same CSI-ResourceConfig and so on.
nrofReportedRS
The number (N) of measured RS resources to be reported per report setting in a non-group-
based report. N <= N_max, where N_max is either 2 or 4 depending on UE capability.
(see TS 38.214 [19], clause 5.2.1.4) When the field is absent the UE applies the value 1.
nzp-CSI-RS-ResourcesForInterference
NZP CSI RS resources for interference measurement. csi-ResourceConfigId of a CSI-
ResourceConfig included in the configuration of the serving cell indicated with the field
“carrier” above. The CSI-ResourceConfig indicated here contains only NZP-CSI-RS
resources. The bwp-Id in that CSI-ResourceConfig is the same value as the bwp-Id in the
CSI-ResourceConfig indicated by resourcesForChannelMeasurement.
p0alpha
Index of the p0-alpha set determining the power control for this CSI report transmission (see
TS 38.214 [19], clause 6.2.1.2).
pdsch-BundleSizeForCSI
PRB bundling size to assume for CQI calculation when reportQuantity is CRI/RI/i1/CQI. If
the field is absent, the UE assumes that no PRB bundling is applied (see TS 38.214 [19],
clause 5.2.1.4.2).
pmi-FormatIndicator
Indicates whether the UE shall report a single (wideband) or multiple (subband) PMI. (see
TS 38.214 [19], clause 5.2.1.4).
pucch-CSI-ResourceList
Indicates which PUCCH resource to use for reporting on PUCCH.
reportConfigType
Time domain behavior of reporting configuration.
reportFreqConfiguration
Reporting configuration in the frequency domain. (see TS 38.214 [19], clause 5.2.1.4).
reportQuantity
The CSI related quantities to report. see TS 38.214 [19], clause 5.2.1. If the field
reportQuantity-r16 is present, UE shall ignore reportQuantity (without suffix).
reportSlotConfig
Periodicity and slot offset (see TS 38.214 [19], clause 5.2.1.4). If the field reportSlotConfig-
v1530 is present, the UE shall ignore the value provided in reportSlotConfig (without
suffix).
reportSlotOffsetList, reportSlotOffsetListDCI-0-1, reportSlotOffsetListDCI-0-2
Timing offset Y for semi persistent reporting using PUSCH. This field lists the allowed
offset values. This list must have the same number of entries as the pusch-
TimeDomainAllocationList in PUSCH-Config. A particular value is indicated in DCI. The
network indicates in the DCI field of the UL grant, which of the configured report slot
offsets the UE shall apply. The DCI value 0 corresponds to the first report slot offset in this
list, the DCI value 1 corresponds to the second report slot offset in this list, and so on. The
first report is transmitted in slot n + Y, second report in n + Y + P, where P is the configured
periodicity.
Timing offset Y for aperiodic reporting using PUSCH. This field lists the allowed offset
values. This list must have the same number of entries as the pusch-
TimeDomainAllocationList in PUSCH-Config. A particular value is indicated in DCI. The
network indicates in the DCI field of the UL grant, which of the configured report slot
offsets the UE shall apply. The DCI value 0 corresponds to the first report slot offset in this
list, the DCI value 1 corresponds to the second report slot offset in this list, and so on (see
TS 38.214 [19], clause 6.1.2.1). The field reportSlotOffsetList applies to DCI format 0_0,
the field reportSlotOffsetListDCI-0-1 applies to DCI format 0_1 and the field
reportSlotOffsetListDCI-0-2 applies to DCI format 0_2 (see TS 38.214 [19], clause 6.1.2.1).
resourcesForChannelMeasurement
Resources for channel measurement. csi-ResourceConfigId of a CSI-ResourceConfig
included in the configuration of the serving cell indicated with the field “carrier” above. The
CSI-ResourceConfig indicated here contains only NZP-CSI-RS resources and/or SSB
resources. This CSI-ReportConfig is associated with the DL BWP indicated by bwp-Id in
that CSI-ResourceConfig.
subbandSize
Indicates one out of two possible BWP-dependent values for the subband size as indicated
in TS 38.214 [19], table 5.2.1.4-2. If csi-ReportingBand is absent, the UE shall ignore this
field.
timeRestrictionForChannelMeasurements
Time domain measurement restriction for the channel (signal) measurements (see TS 38.214
[19], clause 5.2.1.1).
timeRestrictionForInterferenceMeasurements
Time domain measurement restriction for interference measurements (see TS 38.214 [19],
clause 5.2.1.1).

Table 14 may include CSI-ResourceConFIG. Table 14 may include CSI-ResourceConfig information element. The IE CSI-ResourceConfig defines a group of one or more NZP-CSI-RS-ResourceSet, CSI-IM-ResourceSet and/or CSI-SSB-ResourceSet.

TABLE 14
-- ASN1START
-- TAG-CSI-RESOURCECONFIG-START

| | |
|---|---|
| CSI-ResourceConfig ::= | SEQUENCE { |
| csi-ResourceConfigId | CSI-ResourceConfigId, |
| csi-RS-ResourceSetList | CHOICE { |
| nzp-CSI-RS-SSB | SEQUENCE { |

| | |
|---|---|
| nzp-CSI-RS-ResourceSetList | SEQUENCE (SIZE (1..maxNrofNZP-CSI-RS- |

ResourceSetsPerConfig)) OF NZP-CSI-RS-ResourceSetId

| | OPTIONAL, -- Need R |
|---|---|
| csi-SSB-ResourceSetList | SEQUENCE (SIZE (1..maxNrofCSI-SSB- |

ResourceSetsPerConfig)) OF CSI-SSB-ResourceSetId OPTIONAL -- Need R
},

| | |
|---|---|
| csi-IM-ResourceSetList | SEQUENCE (SIZE (1..maxNrofCSI-IM-ResourceSetsPerConfig)) |

OF CSI-IM-ResourceSetId
},

| | |
|---|---|
| bwp-Id | BWP-Id, |
| resourceType | ENUMERATED { aperiodic, semiPersistent, periodic }, |

...
}
-- TAG-CSI-RESOURCECONFIG-STOP
-- ASN1STOP
CSI-ResourceConfig field descriptions
bwp-Id
The DL BWP which the CSI-RS associated with this CSI-ResourceConfig are located in
(see TS 38.214 [19], clause 5.2.1.2.
csi-IM-ResourceSetList
List of references to CSI-IM resources used for beam measurement and reporting in a CSI-
RS resource set. Contains up to maxNrofCSI-IM-ResourceSetsPerConfig resource sets if
resourceType is ‘aperiodic’ and 1 otherwise (see TS 38.214 [19], clause 5.2.1.2).
csi-ResourceConfigId
Used in CSI-ReportConfig to refer to an instance of CSI-ResourceConfig.
csi-SSB-ResourceSetList
List of references to SSB resources used for beam measurement and reporting in a CSI-RS
resource set (see TS 38.214 [19], clause 5.2.1.2).
nzp-CSI-RS-ResourceSetList
List of references to NZP CSI-RS resources used for beam measurement and reporting in a
CSI-RS resource set. Contains up to maxNrofNZP-CSI-RS-ResourceSetsPerConfig
resource sets if resourceType is ‘aperiodic’ and 1 otherwise (see TS 38.214 [19], clause
5.2.1.2).
resourceType
Time domain behavior of resource configuration (see TS 38.214 [19], clause 5.2.1.2). It
does not apply to resources provided in the csi-SSB-ResourceSetList.

Table 15 may include NZP-CSI-RS-ResourceSet information element. Table 15 may include NZP-CSI-RS-ResourceSet. The IE NZP-CSI-RS-ResourceSet is a set of Non-Zero-Power (NZP) CSI-RS resources (their IDs) and set-specific parameters.

TABLE 15
-- ASN1START
-- TAG-NZP-CSI-RS-RESOURCESET-START

| | |
|---|---|
| NZP-CSI-RS-ResourceSet ::= | SEQUENCE { |
| nzp-CSI-ResourceSetId | NZP-CSI-RS-ResourceSetId, |

| | |
|---|---|
| nzp-CSI-RS-Resources | SEQUENCE (SIZE (1..maxNrofNZP-CSI-RS- |

ResourcesPerSet)) OF NZP-CSI-RS-ResourceId,

| | | |
|---|---|---|
| repetition | ENUMERATED { on, off } | OPTIONAL, |

-- Need S

| | |
|---|---|
| aperiodicTriggeringOffset | INTEGER(0..6) |

OPTIONAL, -- Need S

| | | |
|---|---|---|
| trs-Info | ENUMERATED {true} | OPTIONAL, |

```
-- Need R
  ...,
  [[
```

| | |
|---|---|
| aperiodicTriggeringOffset-r16 | INTEGER(0..31) |

OPTIONAL -- Need S
]]
}
-- TAG-NZP-CSI-RS-RESOURCESET-STOP
-- ASN1STOP
NZP-CSI-RS-ResourceSet field descriptions
aperiodicTriggeringOffset, aperiodicTriggeringOffset-r16
Offset X between the slot containing the DCI that triggers a set of aperiodic NZP CSI-RS
resources and the slot in which the CSI-RS resource set is transmitted. For
aperiodicTriggeringOffset, the value 0 corresponds to 0 slots, value 1 corresponds to 1
slot, value 2 corresponds to 2 slots, value 3 corresponds to 3 slots, value 4 corresponds to 4
slots, value 5 corresponds to 16 slots, value 6 corresponds to 24 slots. For
aperiodicTriggeringOffset-r16, the value indicates the number of slots. The network
configures only one of the fields. When neither field is included, the UE applies the value
0.
nzp-CSI-RS-Resources
NZP-CSI-RS-Resources associated with this NZP-CSI-RS resource set (see TS 38.214
[19], clause 5.2). For CSI, there are at most 8 NZP CSI RS resources per resource set.
repetition
Indicates whether repetition is on/off. If the field is set to off or if the field is absent, the
UE may not assume that the NZP-CSI-RS resources within the resource set are transmitted
with the same downlink spatial domain transmission filter (see TS 38.214 [19], clauses
5.2.2.3.1 and 5.1.6.1.2). It can only be configured for CSI-RS resource sets which are
associated with CSI-ReportConfig with report of L1 RSRP or “no report”.
trs-Info
Indicates that the antenna port for all NZP-CSI-RS resources in the CSI-RS resource set is
same. If the field is absent or released the UE applies the value false (see TS 38.214 [19],
clause 5.2.2.3.1).

Table 15-1 may include CSI-SSB-ResourceSet information element. Table 15-1 may include CSI-SSB-ResourceSet. The IE CSI-SSB-ResourceSet is used to configure one SS/PBCH block resource set which refers to SS/PBCH as indicated in ServingCellConfigCommon.

TABLE 15-1
-- ASN1START
-- TAG-CSI-SSB-RESOURCESET-START

| | |
|---|---|
| CSI-SSB-ResourceSet ::= | SEQUENCE |
| csi-SSB-ResourceSetId | CSI-SSB-ResourceSetId, |
| csi-SSB-ResourceList | SEQUENCE (SIZE(1..maxNrofCSI-SSB- |

ResourcePerSet)) OF SSB-Index,
...
}
-- TAG-CSI-SSB-RESOURCESET-STOP
-- ASN1STOP

Table 16 may include CSI-IM-ResourceSet information element. Table 16 may include CSI-IM-ResourceSet. The IE CSI-IM-ResourceSet is used to configure a set of one or more CSI Interference Management (IM) resources (their IDs) and set-specific parameters.

TABLE 16
-- ASN1START
-- TAG-CSI-IM-RESOURCESET-START

| | |
|---|---|
| CSI-IM-ResourceSet ::= | SEQUENCE { |
| csi-IM-ResourceSetId | CSI-IM-ResourceSetId, |
| csi-IM-Resources | SEQUENCE (SIZE(1..maxNrofCSI-IM-ResourcesPerSet)) |

OF CSI-IM-ResourceId,
...
}
-- TAG-CSI-IM-RESOURCESET-STOP
-- ASN1STOP

CSI-IM-ResourceSet field descriptions
csi-IM-Resources
CSI-IM-Resources associated with this CSI-IM-ResourceSet (see TS 38.214 [19],
clause 5.2)

Table 17 may include CSI-AperiodicTriggerStateList information element. Table 17 may include CSI-AperiodicTriggerStateList. The CSI-AperiodicTriggerStateList IE is used to configure the UE with a list of aperiodic trigger states. Each codepoint of the DCI field “CSI request” is associated with one trigger state. Upon reception of the value associated with a trigger state, the UE will perform measurement of CSI-RS (reference signals) and aperiodic reporting on L1 according to all entries in the associatedReportConfigInfoList for that trigger state.

TABLE 17
-- ASN1START
-- TAG-CSI-APERIODICTRIGGERSTATELIST-START

| | |
|---|---|
| CSI-AperiodicTriggerStateList ::= | SEQUENCE (SIZE (1..maxNrOfCSI-AperiodicTriggers)) OF |

CSI-AperiodicTriggerState

| | |
|---|---|
| CSI-AperiodicTriggerState ::= | SEQUENCE { |

| | |
|---|---|
| associatedReportConfigInfoList | SEQUENCE |

(SIZE(1..maxNrofReportConfigPerAperiodicTrigger)) OF CSI-AssociatedReportConfigInfo,
...
}

| | |
|---|---|
| CSI-AssociatedReportConfigInfo ::= | SEQUENCE { |
| reportConfigId | CSI-ReportConfigId, |
| resourcesForChannel | CHOICE { |
| nzp-CSI-RS | SEQUENCE { |
| resourceSet | INTEGER (1..maxNrofNZP-CSI-RS-ResourceSetsPerConfig), |
| qcl-info | SEQUENCE (SIZE(1..maxNrofAP-CSI-RS-ResourcesPerSet)) OF |

TCI-StateId OPTIONAL -- Cond Aperiodic
},

| | |
|---|---|
| csi-SSB-ResourceSet | INTEGER (1..maxNrofCSI-SSB-ResourceSetsPerConfig) |

},

| | |
|---|---|
| csi-IM-ResourcesForInterference | INTEGER(1..maxNrofCSI-IM-ResourceSetsPerConfig) |

OPTIONAL, -- Cond CSI-IM-ForInterference

| | |
|---|---|
| nzp-CSI-RS-ResourcesForInterference | INTEGER (1..maxNrofNZP-CSI-RS- |

ResourceSetsPerConfig) OPTIONAL, -- Cond NZP-CSI-RS-ForInterference
...
}
-- TAG-CSI-APERIODICTRIGGERSTATELIST-STOP
-- ASN1STOP

CSI-AssociatedReportConfigInfo field descriptions
csi-IM-ResourcesForInterference
CSI-IM-ResourceSet for interference measurement. Entry number in csi-IM-
ResourceSetList in the CSI-ResourceConfig indicated by csi-IM-
ResourcesForInterference in the CSI-ReportConfig indicated by reportConfigId above (1
corresponds to the first entry, 2 to the second entry, and so on). The indicated CSI-IM-
ResourceSet should have exactly the same number of resources like the NZP-CSI-RS-
ResourceSet indicated in nzp-CSI-RS-ResourcesforChannel.
csi-SSB-ResourceSet
CSI-SSB-ResourceSet for channel measurements. Entry number in csi-SSB-
ResourceSetList in the CSI-ResourceConfig indicated by
resourcesForChannelMeasurement in the CSI-ReportConfig indicated by reportConfigId
above (1 corresponds to the first entry, 2 to the second entry, and so on).
nzp-CSI-RS-ResourcesForInterference
NZP-CSI-RS-ResourceSet for interference measurement. Entry number in nzp-CSI-RS-
ResourceSetList in the CSI-ResourceConfig indicated by nzp-CSI-RS-
ResourcesForInterference in the CSI-ReportConfig indicated by reportConfigId above (1
corresponds to the first entry, 2 to the second entry, and so on).
qcl-info
List of references to TCI-States for providing the QCL source and QCL type for each
NZP-CSI-RS-Resource listed in nzp-CSI-RS-Resources of the NZP-CSI-RS-
ResourceSet indicated by nzp-CSI-RS-ResourcesforChannel. Each TCI-StateId refers to
the TCI-State which has this value for tci-StateId and is defined in tci-
StatesToAddModList in the PDSCH-Config included in the BWP-Downlink
corresponding to the serving cell and to the DL BWP to which the
resourcesForChannelMeasurement (in the CSI-ReportConfig indicated by
reportConfigId above) belong to. First entry in qcl-info-forChannel corresponds to first
entry in nzp-CSI-RS-Resources of that NZP-CSI-RS-ResourceSet, second entry in qcl-
info-forChannel corresponds to second entry in nzp-CSI-RS-Resources, and so on (see
TS 38.214 [19], clause 5.2.1.5.1)
reportConfigId
The reportConfigId of one of the CSI-ReportConfigToAddMod configured in CSI-
MeasConfig
resourceSet
NZP-CSI-RS-ResourceSet for channel measurements. Entry number in nzp-CSI-RS-
ResourceSetList in the CSI-ResourceConfig indicated by
resourcesForChannelMeasurement in the CSI-ReportConfig indicated by reportConfigId
above (1 corresponds to the first entry, 2 to thesecond entry, and so on).

| Conditional Presence | Explanation |
|---|---|
| Aperiodic | The field is mandatory present if the NZP-CSI-RS- |
| | Resources in the associated resourceSet have the |
| | resourceType aperiodic. The field is absent otherwise. |
| CSI-IM-ForInterference | This field is optional need M if the CSI-ReportConfig |
| | identified by reportConfigId is configured with csi-IM- |
| | ResourcesForInterference; otherwise it is absent. |
| NZP-CSI-RS- | This field is optional need M if the CSI-ReportConfig |
| ForInterference | identified by reportConfigId is configured with nzp-CSI- |
| | RS-ResourcesForInterference; otherwise it is absent. |

Table 18 may include CSI-SemiPersistentOnPUSCH-TriggerStateList information element. Table 18 may include CSI-SemiPersistentOnPUSCH-TriggerStateList. The CSI-SemiPersistentOnPUSCH-TriggerStateList IE is used to configure the UE with list of trigger states for semi-persistent reporting of channel state information on L1. See also TS 38.214 [19], clause 5.2.

TABLE 18
-- ASN1START
-- TAG-CSI-SEMIPERSISTENTONPUSCHTRIGGERSTATELIST-START
CSI-SemiPersistentOnPUSCH-TriggerStateList ::= SEQUENCE(SIZE
(1..maxNrOfSemiPersistentPUSCH-Triggers)) OF CSI-SemiPersistentOnPUSCH-
TriggerState

| | |
|---|---|
| CSI-SemiPersistentOnPUSCH-TriggerState ::= | SEQUENCE { |
| associatedReportConfigInfo | CSI-ReportConfigId, |

...
}
-- TAG-CSI-SEMIPERSISTENTONPUSCHTRIGGERSTATELIST-STOP
-- ASN1STOP

For the above-described CSI report configuration (CSI-ReportConfig), each report configuration CSI-ReportConfig may be associated with the CSI resource configuration associated with the report configuration and one downlink (DL) bandwidth part identified by the higher layer parameter bandwidth part identifier (bwp-id) given as CSI-ResourceConFIG. As time domain reporting for each report configuration CSI-ReportConfig, ‘aperiodic,’ ‘semi-persistent,’ and ‘periodic’ schemes may be supported, and be configured from the base station to the UE by the reportConfigType parameter configured from the higher layer. The semi-persistent CSI reporting method may support ‘PUCCH-based semi-persistent (semi-PersistentOnPUCCH)’ and ‘PUSCH-based semi-persistent (semi-PersistentOnPUSCH)’. In the case of the periodic or semi-persistent CSI reporting method, the UE may receive a configuration of a PUCCH or PUSCH resource for transmitting CSI from the base station through higher layer signaling. The period and slot offset of the PUCCH or PUSCH resource to transmit CSI may be given as a numerology of an uplink (UL) bandwidth part configured to transmit a CSI report. In the case of the aperiodic CSI reporting method, the UE may receive a scheduling of a PUSCH resource for transmitting the CSI from the base station through LI signaling (above-described DCI format 0_1).

For the above-described CSI resource configuration (CSI-ResourceConfig), each CSI resource configuration CSI-ReportConfig may include S (≥1) CSI resource sets (given as the higher layer parameter csi-RS-ResourceSetlist). The CSI resource set list may be composed of a non-zero power (NZP) CSI-RS resource set and an SS/PBCH block set or of a CSI-interference measurement (CSI-IM) resource set. Each CSI resource configuration may be positioned in the downlink (DL) bandwidth part identified by the higher layer parameter bwp-id. The CSI resource configuration may be connected to CSI report configuration of the same downlink bandwidth part. The time domain operation of the CSI-RS resource in the CSI resource configuration may be set to one of ‘aperiodic’, ‘periodic’ or ‘semi-persistent’ from the higher layer parameter resourcetype. For periodic or semi-persistent CSI resource configuration, the number of CSI-RS resource sets may be limited to S=1. The configured period and slot offset may be given as a numerology of the downlink bandwidth part identified by bwp-id. The UE may receive a configuration of one or more CSI resource configurations for channel or interference measurement from the base station through higher layer signaling. For example, the following CSI resources may be included.

### CSI-IM Resource for Interference Measurement

### NZP CSI-RS Resource for Interference Measurement

### NZP CSI-RS Resource for Channel Measurement

For CSI-RS resource sets associated with the resource in which the higher layer parameter resourceType is configured as ‘aperiodic’, ‘periodic’, or ‘semi-persistent’, the resource configuration for channel or interference measurement for one or more component cells (CCs) and the trigger state for the CSI report configuration in which the reportType is set to ‘aperiodic’ may be configured by the higher layer parameter CSI-AperiodicTriggerStateList.

The aperiodic CSI reporting of the UE may use the PUSCH, and the periodic CSI reporting may use the PUCCH. The semi-persistent CSI reporting may be performed using the PUSCH when triggered or activated by the DCI or using the PUCCH after activated by the MAC control element (CE). As described above, CSI resource configuration may also be configured aperiodically, periodically, or semi-persistently. The combination between the CSI report configuration and the CSI resource configuration may be supported based on Table 19 below.

TABLE 19

| | | Semi- | |
|---|---|---|---|
| CSI-RS | Periodic CSI | Persistent CSI | Aperiodic CSI |
| Configuration | Reporting | Reporting | Reporting |
| Periodic CSI-RS | No dynamic | For reporting on | Triggered by DCI; |
| | triggering/activation | PUCCH, the UE | additionally, |
| | | receives an | activation |
| | | activation | command [10, TS |
| | | command [10, TS | 38.321] possible as |
| | | 38.321]; for | defined in |
| | | reporting on | Subclause 5.2.1.5.1. |
| | | PUSCH, the UE | |
| | | receives triggering | |
| | | on DCI | |
| Semi-Persistent CSI- | Not Supported | For reporting on | Triggered by DCI; |
| RS | | PUCCH, the UE | additionally, |
| | | receives an | activation |
| | | activation | command [10, TS |
| | | command [10, TS | 38.321] possible as |
| | | 38.321]; for | defined in |
| | | reporting on | Subclause 5.2.1.5.1. |
| | | PUSCH, the UE | |
| | | receives triggering | |
| | | on DCI | |
| Aperiodic CSI-RS | Not Supported | Not Supported | Triggered by DCI; |
| | | | additionally, |
| | | | activation |
| | | | command [10, TS |
| | | | 38.321] possible as |
| | | | defined in |
| | | | Subclause 5.2.1.5.1. |

Table 19 may include Triggering/Activation of CSI Reporting for the possible CSI-RS Configurations.

The aperiodic CSI reporting may be triggered with the above-described DCI format 0_1 “CSI request” corresponding to the scheduling DCI for the PUSCH. The UE may monitor the PDCCH, obtain DCI format 0_1, and obtain scheduling information for PUSCH and a CSI request indicator. The CSI request indicator may be set with NTS (=0, 1, 2, 3, 4, 5, or 6) bits and be determined by the higher layer signaling (reportTriggerSize). One trigger state among one or a plurality of aperiodic CSI reporting trigger states that may be configured by higher layer signaling (CSI-AperiodicTriggerStatelist) may be triggered by the CSI request indicator.

When all bits of the CSI request field are 0, this may mean that no CSI report is requested.

If the number M of CSI trigger states in the configured CSI-AperiodicTriggerStateList is larger than 2NTs−1, M CSI trigger states may be mapped to 2NTs−1 according to a predefined mapping relationship, and one trigger state among the 2NTs−1 trigger states may be indicated by the CSI request field.

If the number M of CSI trigger states in the configured CSI-AperiodicTriggerStateList is equal to or smaller than 2NTs−1, one of the M CSI trigger states may be indicated by the CSI request field.

Table 20 below may illustrate an example of a relationship between the CSI request indicator and the CSI trigger state that may be indicated by the indicator.

TABLE 20

| CSI request | | CSI- | CSI- |
|---|---|---|---|
| field | CSI trigger state | ReportConfigId | ResourceConfigId |
| 00 | no CSI request | N/A | N/A |
| 01 | CSI trigger state#1 | CSI report#1 | CSI resource#1, |
| | | CSI report#2 | CSI resource#2 |
| 10 | CSI trigger state#2 | CSI report#3 | CSI resource#3 |
| 11 | CSI trigger state#3 | CSI report#4 | CSI resource#4 |

For the CSI resource in the CSI trigger state triggered by the CSI request field, the UE may perform measurement, generating CSI (including at least one or more of above-described CQI, PMI, CRI, SSBRI, LI, RI, or L1-RSRP). The UE may transmit the obtained CSI by the PUSCH scheduled by the corresponding DCI format 0_1. When one bit corresponding to the uplink data indicator (UL-SCH indicator) in DCI format 0_1 indicates “1”, uplink data (UL-SCH) and the obtained CSI may be multiplexed to the PUSCH resource scheduled by DCI format 0_1 and be transmitted. When one bit corresponding to the uplink data indicator (UL-SCH indicator) in DCI format 0_1 indicates “1”, only CSI, without the uplink data (UL-SCH), may be mapped to the PUSCH resource scheduled by DCI format 0_1 and be transmitted.

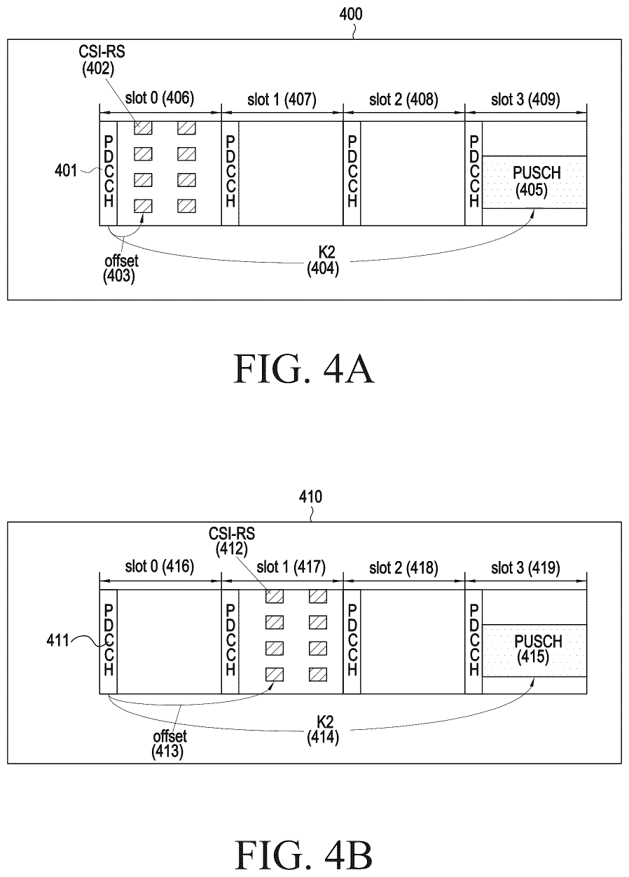

FIG. 4A is a view illustrating an example of an aperiodic CSI reporting method according to an embodiment of the disclosure. FIG. 4B is a view illustrating an example of an aperiodic CSI reporting method according to an embodiment of the disclosure.

Referring to FIGS. 4A and 4B, in the example 400 of FIG. 4A, the UE may obtain DCI format 0_1 by monitoring the PDCCH 401, obtaining scheduling information and CSI request information for the PUSCH 405. The UE may obtain resource information for the CSI-RS 402 to be measured from the received CSI request indicator. The UE may determine to perform measurement on the CSI-RS 402 resources transmitted at what time, based on the time of reception of DCI format 0_1 and parameter (above-described aperiodicTriggringOffset) for the offset 403 in the CSI resource set configuration (e.g., NZP CSI-RS resource set configuration (NZP-CSI-RS-ResourceSet)). Specifically, the UE may receive a configuration of offset value X of the parameter aperiodicTriggeringOffset in the NZP-CSI-RS resource set configuration from the base station by higher layer signaling, and the configured offset value X may mean an offset between the slot where the DCI for triggering aperiodic CSI reporting is received and the slot where the CSI-RS resource is transmitted. For example, the aperiodicTriggeringOffset parameter value and offset value X may have a mapping relationship shown in Table 21 below.

TABLE 21

| aperiodicTriggeringOffset | Offset X |
|---|---|
| 0 | 0 slot |
| 1 | 1 slot |
| 2 | 2 slots |
| 3 | 3 slots |
| 4 | 4 slots |
| 5 | 16 slots |
| 6 | 24 slots |

In the example 400 of FIG. 4A, an example in which the above-described offset value is set as X=0 may be shown. In this case, the UE may receive the CSI-RS 402 in the slot where DCI format 0_1 for triggering aperiodic CSI reporting is received (corresponding to slot 0 406 of FIG. 4A) and report the CSI information measured with the received CSI-RS to the base station through the PUSCH 405. The UE may obtain scheduling information (information corresponding to each field of the above-described DCI format 0_1) for the PUSCH 405 for CSI reporting from DCI format 0_1. As an example, the UE may obtain information about the slot to transmit the PUSCH 405 from the above-described time domain resource allocation information for the PUSCH 405. In the example 400 of FIG. 4A, the UE may obtain 3 as the K2 value 404 corresponding to the slot offset value for PDCCH-to-PUSCH so that the PUSCH 405 may be transmitted in slot 1˜ slot 3 407, 408, 409 which is three slots away from slot 0 406 which is the time of reception of the PDCCH 401.

Referring to FIGS. 4A and 4B, in the example 410 of FIG. 4B, the UE may obtain DCI format 0_1 by monitoring the PDCCH 411, obtaining scheduling information and CSI request information for the PUSCH 415. The UE may obtain resource information for the CSI-RS 412 to be measured from the received CSI request indicator. In the example 410 of FIG. 4B, an example in which the above-described offset 413 value for the CSI-RS is set as X=1 may be shown. In this case, the UE may receive the CSI-RS 412 in the slot where DCI format 0_1 for triggering aperiodic CSI reporting is received (corresponding to slot 0 416 of FIG. 4B) and report the CSI information measured with the received CSI-RS to the base station through the PUSCH 415. In the example 410 of FIG. 4B, the UE may obtain 3 as the K2 value 414 corresponding to the slot offset value for PDCCH-to-PUSCH so that the PUSCH 415 may be transmitted in slot 1˜ slot 3 417, 418, 419 which is three slots away from slot 0 416 which is the time of reception of the PDCCH 411.

The aperiodic CSI reporting may include at least one or both of CSI part 1 or CSI part 2 and, when the aperiodic CSI reporting is transmitted through PUSCH, it may be multiplexed with the transport block. For multiplexing, the CRC may be inserted into the input bit of the aperiodic CSI, then undergo encoding and rate matching, and be then mapped to the resource element in the PUSCH in a specific pattern and transmitted. The CRC insertion may be omitted according to the coding method or length of the input bits. Upon multiplexing CSI part 1 or CSI part 2 included in the aperiodic CSI reporting, the number of modulation symbols calculated for rate matching may be calculated as shown in Table 22 below.

```
TABLE 22
  For CSI part 1 transmission on PUSCH not using repetition type B with UL-SCH, the
number of coded modulation symbols per layer for CSI part 1 transmission, denoted as
${Q}_{CSI - part 1}^{′} ,$
  ${Q}_{CSI - 1}^{′} = min \{ ⌈ \frac{( {O}_{CSI - 1} + {L}_{CSI - 1} ) \cdot {β}_{offset}^{PUSCH} \cdot {\sum }_{i = 0}^{{N}_{symb , all}^{PUSCH} - 1} {M}_{sc}^{UCI} ( i )}{{\sum }_{r = 0}^{{C}_{UL - SCH} - 1} {K}_{r}} ⌉ , ⌈ α \cdot {\sum }_{l = 0}^{{N}_{symb , all}^{PUSCH} - 1} {M}_{sc}^{UCI} ( l ) ⌉ - {Q}_{ACK / CG - UCI}^{′} . \qquad Equation 6$
  For CSI part 1 transmission on an actual repetition of a PUSCH with repetition Type B
with UL-SCH, the number of coded modulation symbols per layer for CSI part 1 transmission,
denoted as
${Q}_{CSI - part 1}^{′} ,$
s determined as follows:
  ${Q}_{CSI - 1}^{′} = min \{ ⌈ \frac{( {O}_{CSI - 1} + {L}_{CSI - 1} ) \cdot {β}_{offset}^{PUSCH} \cdot {\sum }_{l = 0}^{{N}_{symb , nominal}^{PUSCH} - 1} {M}_{sc , nominal}^{UCI} ( l )}{{\sum }_{r = 0}^{{C}_{UL - SCH} - 1} {K}_{r}} ⌉ , ⌈ α \cdot {{\sum }_{l = 0}}^{{N}_{symb , nominal}^{PUSCH} - 1} {M}_{sc , nominal}^{UCI} ( l ) ⌉ - {Q}_{ACK / CG - UCI}^{′} , {{\sum }_{l = 0}}^{{N}_{symb , actual}^{PUSCH} - 1} {M}_{sc , actual}^{UCI} ( l ) - {Q}_{ACK / CG - UCI}^{′} \} . \qquad Equation 7$
  For CSI part 1 transmission on PUSCH without UL-SCH, the number of coded
modulation symbols per layer for CSI part 1 transmission, denoted as
${Q}_{CSI - part 1}^{′} ,$
is determined as follows:
  if there is CSI part 2 to be transmitted on the PUSCH,
  ${Q}_{CSI - 1}^{′} = min \{ ⌈ \frac{( {O}_{CSI - 1} + {L}_{CSI - 1} ) \cdot {β}_{offset}^{PUSCH}}{R \cdot {Q}_{m}} ⌉ , {\sum }_{l = 0}^{{N}_{symb , all}^{PUSCH} - 1} {M}_{sc}^{UCI} ( l ) - {Q}_{ACK}^{′} \} \qquad Equation 8$ $else$ ${Q}_{CSI - 1}^{′} = {\sum }_{l = 0}^{{N}_{symb , all}^{PUSCH} - 1} {M}_{sc}^{UCI} ( l ) - {Q}_{ACK}^{′}$
  For CSI part 2 transmission on PUSCH not using repetition type B with UL-SCH, the
number of coded modulation symbols per layer for CSI part 2 transmission, denoted as
${Q}_{CSI - part 2}^{′} ,$
is determined as follows:
  ${Q}_{CSI - 2}^{′} = min \{ ⌈ \frac{( {O}_{CSI - 2} + {L}_{CSI - 2} ) \cdot {β}_{offset}^{PUSCH} \cdot {\sum }_{l = 0}^{{N}_{symb , all}^{PUSCH} - 1} {M}_{sc}^{UCI} ( l )}{{\sum }_{r = 0}^{{C}_{UL - SCH} - 1} {K}_{r}} ⌉ , ⌈ α \cdot {\sum }_{l = 0}^{{N}_{symb , all}^{PUSCH} - 1} {M}_{sc}^{UCI} ( l ) ⌉ - {Q}_{ACK / CG - UCI}^{′} - {Q}_{CSI - 1}^{′} \} . \qquad Equation 9$
  For CSI part 2 transmission on an actual repetition of a PUSCH with repetition Type B
with UL-SCH, the number of coded modulation symbols per layer for CSI part 2 transmission,
denoted as
${Q}_{CSI - part 2}^{′} ,$
is determined as follows:
  ${Q}_{CSI - 2}^{′} = min \{ ⌈ \frac{( {O}_{CSI - 2} + {L}_{CSI - 2} ) \cdot {β}_{offset}^{PUSCH} \cdot {\sum }_{l = 0}^{{N}_{symb , nominal}^{PUSCH} - 1} {M}_{sc , nominal}^{UCI} ( l )}{{\sum }_{r = 0}^{{C}_{UL - SCH} - 1} {K}_{r}} ⌉ , ⌈ α \cdot {{\sum }_{l = 0}}^{{N}_{symb , nominal}^{PUSCH} - 1} {M}_{sc , nominal}^{UCI} ( l ) ⌉ - {Q}_{ACK / CG - UCI}^{′} - {Q}_{CSI - 1}^{′} , {{\sum }_{l = 0}}^{{N}_{symb , actual}^{PUSCH} - 1} {M}_{sc , actual}^{UCI} ( l ) - {Q}_{ACK / CG - UCI}^{′} - {Q}_{CSI - 1}^{′} \} \qquad Equation 10$
  For CSI part 2 transmission on PUSCH without UL-SCH, the number of coded
modulation symbols per layer for CSI part 2 transmission, denoted as
${Q}_{CSI - part 2}^{′} ,$
is determined as follows:
  ${Q}_{CSI - 2}^{′} = {\sum }_{l = 0}^{{N}_{symb , all}^{PUSCH} - 1} {M}_{sc}^{UCI} ( l ) - {Q}_{ACK}^{′} - {Q}_{CSI - 1}^{′} \qquad Equation 11$
```

For CSI part 1 transmission on PUSCH not using repetition type B with UL-SCH, the number of coded modulation symbols per layer for CSI part 1 transmission, denoted as

$${Q}_{CSI - part 1}^{′} ,$$

is determined as follows:

$${Q}_{CSI - 1}^{′} = min \{ ⌈ \frac{\begin{matrix}( {O}_{CSI - 1} + {L}_{CSI - 1} ) \cdot {β}_{offset}^{PUSCH} \cdot \\ {\sum }_{l = 0}^{{N}_{symb , all}^{PUSCH} - 1} {M}_{sc}^{UCI} ( l )\end{matrix}}{{\sum }_{r = 0}^{{C}_{UL - SCH} - 1} {K}_{r}} ⌉ , \\ ⌈ α \cdot {\sum }_{l = 0}^{{N}_{symb , all}^{PUSCH} - 1} {M}_{sc}^{UCI} ( l ) ⌉ - {Q}_{ACK / CG - UCI}^{′} \} \qquad Equation 6$$

For CSI part 1 transmission on an actual repetition of a PUSCH with repetition Type B with UL-SCH, the number of coded modulation symbols per layer for CSI part 1 transmission, denoted as

$${Q}_{CSI - part 1}^{′} ,$$

is determined as follows:

$${Q}_{CSI - 1}^{′} = min \{ ⌈ \frac{\begin{matrix}( {O}_{CSI - 1} + {L}_{CSI - 1} ) \cdot {β}_{offset}^{PUSCH} \cdot \\ {\sum }_{l = 0}^{{N}_{symb , nominal}^{PUSCH} - 1} {M}_{sc , nominal}^{UCI} ( l )\end{matrix}}{{\sum }_{r = 0}^{{C}_{UL - SCH} - 1} {K}_{r}} ⌉ , \\ ⌈ α \cdot {\sum }_{l = 0}^{{N}_{symb , nominal}^{PUSCH} - 1} {M}_{sc , nominal}^{UCI} ( l ) ⌉ - {Q}_{ACK / CG - UCI}^{′} , \\ {\sum }_{l = 0}^{{N}_{symb , nominal}^{PUSCH} - 1} {M}_{sc , actual}^{UCI} ( l ) - {Q}_{ACK / CG - UCI}^{′} \} \qquad Equation 7$$

For CSI part 1 transmission on PUSCH without UL-SCH, the number of coded modulation symbols per layer for CSI part 1 transmission, denoted as

$${Q}_{CSI - part 1}^{′} ,$$

is determined as follows:
if there is CSI part 2 to be transmitted on the PUSCH,

$${Q}_{CSI - 1}^{′} = min \{ ⌈ \frac{( {O}_{CSI - 1} + {L}_{CSI - 1} ) \cdot {β}_{offset}^{PUSCH}}{R \cdot {Q}_{m}} ⌉ , {\sum }_{l = 0}^{{N}_{symb , all}^{PUSCH} - 1} {M}_{sc}^{UCI} ( l ) - {Q}_{ACK}^{′} \} \qquad Equation 8$$

$$else$$

$${Q}_{CSI - 1}^{′} = {\sum }_{l = 0}^{{N}_{symb , all}^{PUSCH} - 1} {M}_{sc}^{UCI} ( l ) - {Q}_{ACK}^{′}$$

For CSI part 2 transmission on PUSCH not using repetition type B with UL-SCH, the number of coded modulation symbols per layer for CSI part 2 transmission, denoted as

$${Q}_{CSI - part 2}^{′} ,$$

is determined as follows:

$${Q}_{CSI - 2}^{′} = min \{ ⌈ \frac{( {O}_{CSI - 2} + {L}_{CSI - 2} ) \cdot {β}_{offset}^{PUSCH} \cdot {\sum }_{i = 0}^{{N}_{symb , all}^{PUSCH} - 1} {M}_{sc}^{UCI} ( i )}{{\sum }_{r = 0}^{{C}_{UL - SCH} - 1} {K}_{r}} ⌉ , \\ ⌈ α \cdot {\sum }_{l = 0}^{{N}_{symb , all}^{PUSCH} - 1} {M}_{sc}^{UCI} ( l ) ⌉ - {Q}_{ACK / CG - UCI}^{′} - {Q}_{CSI - 1}^{′} \} . \qquad Equation 9$$

For CSI part 2 transmission on an actual repetition of a PUSCH with repetition Type B with UL-SCH, the number of coded modulation symbols per layer for CSI part 2 transmission, denoted as

$${Q}_{CSI - part 2}^{′} ,$$

is determined as follows:

$${Q}_{CSI - 2}^{′} = min \{ ⌈ \frac{\begin{matrix}( {O}_{CSI - 2} + {L}_{CSI - 2} ) \cdot {β}_{offset}^{PUSCH} \cdot \\ {\sum }_{l = 0}^{{N}_{symb , nominal}^{PUSCH} - 1} {M}_{sc , nominal}^{UCI} ( l )\end{matrix}}{{\sum }_{r = 0}^{{C}_{UL - SCH} - 1} {K}_{r}} ⌉ , \\ ⌈ α \cdot {\sum }_{l = 0}^{{N}_{symb , nominal}^{PUSCH} - 1} {M}_{sc , nominal}^{UCI} ( l ) ⌉ - {Q}_{ACK / CG - UCI}^{′} - {Q}_{CSI - 1}^{′} , \\ {\sum }_{l = 0}^{{N}_{symb , actual}^{PUSCH} - 1} {M}_{sc , actual}^{UCI} ( l ) {Q}_{ACK / CG - UCI}^{′} - {Q}_{CSI - 1}^{′} \} \qquad Equation 10$$

For CSI part 2 transmission on PUSCH without UL-SCH, the number of coded modulation symbols per layer for CSI part 2 transmission, denoted as

$${Q}_{CSI - part 2}^{′} ,$$

is determined as follows:

$${Q}_{CSI - 2}^{′} = {\sum }_{l = 0}^{{N}_{symb , all}^{PUSCH} - 1} {M}_{sc}^{UCI} ( l ) - {Q}_{ACK}^{′} - {Q}_{CSI - 1}^{′} \qquad Equation 11$$

In particular, in PUSCH repeated transmission schemes A and B, the UE may multiplex the aperiodic CSI reporting only upon the first repeated transmission among the PUSCH repeated transmissions and transmit it. This is why the aperiodic CSI reporting information multiplexed is encoded in a polar code scheme and, in this case, for multiplexing to several PUSCH repetitions, each PUSCH repetition should have the same frequency and time resource allocation. In particular, in PUSCH repetition type B, each actual repetition may have a different OFDM symbol length, so that the aperiodic CSI reporting may be multiplexed only in the first PUSCH repetition and transmitted.

Further, when, for the PUSCH repeated transmission scheme B, the UE receives the DCI for activating the semi-permanent CSI reporting or scheduling the aperiodic CSI reporting without scheduling the transport block, although the number of PUSCH repeated transmissions set by higher layer signaling is larger than 1, the value of nominal repetition may be assumed to be 1. Further, when the UE schedules or activates aperiodic or semi-permanent CSI reporting without scheduling the transport block based on PUSCH repeated transmission scheme B, the UE may expect that the first nominal repetition is the same as the first actual repetition. If the first nominal repetition differs from the first actual repetition for the PUSCH transmitted including the semi-permanent CSI based on PUSCH repeated transmission scheme B without scheduling the DCI after the second CLI-RS is activated with DCI, transmission of the first nominal repetition may be disregarded.

### [PUCCH: UCI on PUSCH]

In an NR communication system, when an uplink control channel overlaps an uplink data channel and satisfies a transmission time condition, or when L1 signaling or higher layer signaling indicates that uplink control information is to be transmitted through an uplink data channel, the uplink control information may be included in the uplink data channel and transmitted. In this case, a total of three uplink control information pieces including HARQ-ACK, CSI part 1, and CSI part 2 may be transmitted on an uplink data channel, and each uplink control information may be mapped to a PUSCH according to a predetermined multiplexing rule.

More specifically, if the number of HARQ-ACK information bits to be included in a PUSCH is 2 bits or less in a first step, the UE may reserve REs for transmitting HARQ-ACK in advance. In this case, a method for determining the resource to reserve may be the same as the second step. However, the number and position of REs to reserve may be determined assuming that the number of HARQ-ACK bits is 2. In other words, it may be calculated based on Oack=2 in Equation 12 below. In the second step, if the number of HARQ-ACK information bits that the UE will transmit is more than 2 bits, the UE may map HARQ-ACK starting from a first OFDM symbol that does not include DMRS after a first DMRS symbol. In a third step, the UE may map CSI part1 to a PUSCH. In this case, CSI part1 may be mapped starting from a first OFDM symbol that is not DMRS, and may not be mapped to REs reserved in the first step and REs to which HARQ-ACK is mapped in the second step.

In a fourth step, the UE may map CSI part2 to a PUSCH. In this case, CSI part2 may be mapped starting from a first OFDM symbol that is not DMRS, and may not be mapped to REs where CSI part 1 is positioned and REs where HARQ-ACK mapped to REs in the second step is positioned. However, it may be mapped to REs reserved in the first step. When UL-SCH is present, the UE may map UL-SCH to a PUSCH. In this case, UL-SCH may be mapped starting from a first OFDM symbol that is not DMRS, and may not be mapped to REs where CSI part1 is positioned, REs where HARQ-ACK mapped to REs in the second step is positioned, and REs where CSI part2 is positioned. However, it may be mapped to REs reserved in the first step.

In a fifth step, if HARQ-ACK is less than 2 bits, the UE may puncture and map HARQ-ACK to REs reserved in the first step. The number of REs to which the HARQ-ACK is mapped may be calculated based on the actual number of HARQ-ACK. In other words, the number of REs to which HARQ-ACK is actually mapped may be less than the number of reserved REs in step 1. Puncturing may mean that even when an RE to which HARQ-ACK should be mapped becomes CSI part2 or UL-SCH in step 4, ACK is mapped instead of the previously mapped CSI part2 or UL-SCH. CSI part1 may not be mapped to the reserved REs so that puncturing by HARQ-ACK does not occur. This may mean that CSI part1 has higher priority than CSI part2 and is intended to enable better decoding. And if the number of bits (or the number of modulated symbols) of uplink control information to be mapped to a PUSCH is greater than the number of bits (or REs) capable of mapping uplink control information within the corresponding OFDM symbol to be mapped, a frequency axis RE interval d between modulated symbols of uplink control information to be mapped may be set to d=1. If the number of bits (or the number of modulated symbols) of uplink control information to be mapped to a PUSCH by the UE is less than the number of bits (or REs) capable of mapping uplink control information within the corresponding OFDM symbol to be mapped, a frequency axis RE interval d between modulated symbols of uplink control information to be mapped may be set to d=floor (# of available bits on 1-OFDM symbol/# of unmapped UCI bits at the beginning of 1-OFDM symbol).

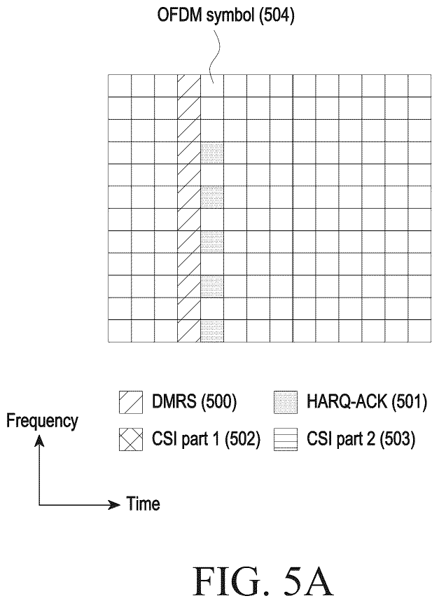

FIG. 5A illustrates an example in which uplink control information is mapped to a PUSCH according to an embodiment of the disclosure.

FIG. 5B illustrates an example in which uplink control information is mapped to a PUSCH according to an embodiment of the disclosure.

FIG. 5C illustrates an example in which uplink control information is mapped to a PUSCH according to an embodiment of the disclosure.

FIGS. 5A and 5B may illustrate examples in which uplink control information is mapped to a PUSCH.

Referring to FIGS. 5A and 5B, it may be assumed that the number of HARQ-ACK symbols to be mapped to a PUSCH is 5, and a PUSCH where one resource block is configured or scheduled PUSCH may be assumed. First, the UE may map HARQ-ACK 501 starting from a lowest RE index or a highest RE index of a first OFDM symbol 504 that does not include DMRS 500 after a first DMRS with an RE interval of d=floor (12/5)=2 in the frequency axis for 5 symbols of HARQ-ACK as illustrated in FIG. 5A. Next, the UE may map CSI-part1 502 starting from a first OFDM symbol 505 that is not DMRS as illustrated in FIG. 5B. Finally, the UE may map CSI part 2 503 to REs where CSI-part1 502 and HARQ-ACK are not mapped starting from a first OFDM symbol 506 that does not include DMRS as illustrated in FIG. 5C.

Meanwhile, when HARQ-ACK is transmitted on a PUSCH (or CG-PUSCH), the number of coded modulation symbols may be determined by the following Equation 12.

$${Q}_{ACK}^{′} = min \{ ⌈ \frac{( {O}_{ACK} + {L}_{ACK} ) \cdot {β}_{offset}^{PUSCH} \cdot {\sum }_{l = 0}^{{N}_{symb , all}^{PUSCH} - 1} {M}_{sc}^{UCI} ( l )}{{\sum }_{r = 0}^{{C}_{UL - SCH} - 1} {K}_{r}} ⌉ , \\ ⌈ α \cdot {\sum }_{l = {l}_{0}}^{{N}_{symb , all}^{PUSCH} - 1} {M}_{sc}^{UCI} ( l ) ⌉ \} \qquad Equation 12$$

Here, O_{ACK} may denote the number of bits of a HARQ-ACK payload, and L_{ACK} may denote the number of CRC bits. More specifically, O_{ACK}≥360, L_{ACK}=11. Otherwise, 360≥O_{ACK}≥20, L_{ACK}=11, 20>O_{ACK}≥12, L_{ACK}=6, 12>O_{ACK}, L_{ACK}=0

Kr is the rth code block size of UL-SCH, and

$${M}_{sc}^{UCI}$$

may denote the number of subcarriers per OFDM symbol that may be used for UCI transmission among PUSCHs configured or scheduled by the base station. Further, α and

$${β}_{offset}^{PUSCH}$$

are values configured by the base station and may be determined by higher layer signaling or L1 signaling. More specifically,

$${β}_{offset}^{PUSCH} ,$$

i.e., a beta offset value may be a value defined to determine the number of resources when HARQ-ACK information is multiplexed with other UCI information and transmitted on a PUSCH (or CG-PUSCH). If a fallback DCI (or DCI format 0_0) or a non-fallback DCI (or DCI format 0_1) that does not have a beta_offset indicator field indicates PUSCH transmission and the UE sets a beta offset value configuration to ‘semi-static’ with higher configuration, the UE may have one beta offset value configured with higher configuration. In this case, a beta offset has a value as a table such as Table 23, and may indicate an index of the corresponding value with higher configuration, and indexes

$${I}_{offset , 0}^{HARQ - ACK} , {I}_{offset , 1}^{HARQ - ACK} , {I}_{offset , 2}^{HARQ - ACK}$$

may have beta offset values for cases where the number of HARQ-ACK information bits is 2 or less, greater than 2 and 11 or less, and greater than 11, respectively, according to the number of HARQ-ACK information bits. Further, it may be possible to configure beta offset values for CSI-part1 and CSI-part2 in the same method. The beta offset value has an effect of adjusting a code rate of UCI compared to an effective code rate of UL-SCH. In other words, when a beta offset value is 2 (index=1), a code rate of UCI may be configured to be transmitted at a 1/2 lower coding rate than an effective code rate of UL-SCH.

TABLE 23

| ${I}_{offset , 0}^{H ARQ - ACK} or {I}_{offset , 1}^{H ARQ - ACK} or {I}_{offset , 2}^{H ARQ - ACK}$ | ${β}_{offset}^{H ARQ - ACK}$ |
|---|---|
| 0 | 1.000 |
| 1 | 2.000 |
| 2 | 2.500 |
| 3 | 3.125 |
| 4 | 4.000 |
| 5 | 5.000 |
| 6 | 6.250 |
| 7 | 8.000 |
| 8 | 10.000 |
| 9 | 12.625 |
| 10 | 15.875 |
| 11 | 20.000 |
| 12 | 31.000 |
| 13 | 50.000 |
| 14 | 80.000 |
| 15 | 126.000 |
| 16 | Reserved |
| 17 | Reserved |
| 18 | Reserved |
| 19 | Reserved |
| 20 | Reserved |
| 21 | Reserved |
| 22 | Reserved |
| 23 | Reserved |
| 24 | Reserved |
| 25 | Reserved |
| 26 | Reserved |
| 27 | Reserved |
| 28 | Reserved |
| 29 | Reserved |
| 30 | Reserved |
| 31 | Reserved |

If the base station schedules PUSCH transmission to the UE using a non-fallback DCI (or DCI format 0_1) and the non-fallback DCI has a beta offset indicator field, i.e., when a beta offset value configuration is set to ‘dynamic’ with higher configuration, the base station may configure beta offset values for 4 sets having

$${I}_{offset , 0}^{HARQ - ACK} , {I}_{offset , 1}^{HARQ - ACK} , {I}_{offset , 2}^{HARQ - ACK}$$

as illustrated in Table 24 for HARQ-ACK and configure them to the UE, and the UE may indicate a beta offset value to be used during HARQ-ACK multiplexing using a beta offset indicator field, and each index may be determined according to the number of HARQ-ACK information bits in the same manner as the above-described method. A set of

$${I}_{offset}^{CSI - 1} , {I}_{offset}^{CSI - 2}$$

may be indicated in the same method.

TABLE 24

| beta_offset indicator | $( {I}_{offset , 0}^{H ARQ - ACK} or {I}_{offset , 1}^{H ARQ - ACK} or {I}_{offset , 2}^{H ARQ - ACK} ) ,$ $( {I}_{offset , 0}^{CSI - 1} or {I}_{offset , 0}^{CSI - 2} ) , ( {I}_{offset , 1}^{CSI - 1} or {I}_{offset , 1}^{CSI - 2} )$ |
|---|---|
| ‘00’ | 1^{st} offset index provided by higher layers |
| ‘01’ | 2^{nd} offset index provided by higher layers |
| ‘10’ | 3^{rd} offset index provided by higher layers |
| ‘11’ | 4^{th} offset index provided by higher layers |

For HARQ-ACK transmission on an actual repetition of a PUSCH with repetition Type B with UL-SCH, the number of coded modulation symbols per layer for HARQ-ACK transmission, denoted as

$${Q}_{ACK}^{′} ,$$

is determined as follows:

$${Q}_{ACK}^{′} = min \{ ⌈ \frac{( {Q}_{ACK} + {L}_{ACK} ) \cdot {β}_{offset}^{PUSH} \cdot {Σ}_{l = 0}^{{N}_{symb , nominal}^{PUSCH} - 1} {M}_{sc , nominal}^{UCI} ( l )}{{Σ}_{r = 0}^{\text{?} - 1} {K}_{r}} ⌉ , ⌈ α \cdot {\sum }_{i = 0}^{{N}_{symb , nominal}^{PUSCH} - 1} {M}_{sc , nominal}^{UCI} ( l ) ⌉ , {\sum }_{l = 0}^{{N}_{symb , actual}^{PUSCH} - 1} {M}_{sc , actual}^{UCI} ( l ) \} \qquad Equation 13$$

$$\text{?} \text{indicates text missing or illegible when filed}$$

where

$${M}_{sc , nominal}^{UCI} ( l )$$

is the number of resource elements that can be used for transmission of UCI in OFDM symbol l, for l=0, 1, 2, . . . ,

$${N}_{symb , nominal}^{PUSCH} - 1 ,$$

in the PUSCH transmission assuming a nominal repetition without segmentation, and

$${N}_{symb , nominal}^{PUSCH}$$

is the total number of OFDM symbols in a nominal repetition of the PUSCH, including all OFDM symbols used for DMRS;
for any OFDM symbol that carries DMRS of the PUSCH assuming a nominal repetition without segmentation,

$${M}_{sc , nominal}^{UCI} ( l ) = 0 ;$$

for any OFDM symbol that does not carry DMRS of the PUSCH assuming a nominal repetition without segmentation,

$${M}_{sc , nominal}^{UCI} ( l ) = {M}_{sc}^{PUSCH} - {M}_{sc , nominal}^{PT - RS} ( l )$$

where

$${M}_{sc , nominal}^{PT - RS} ( l )$$

is the number of subcarriers in OFDM symbol l that carries PTRS, in the PUSCH transmission assuming a nominal repetition without segmentation;

$${M}_{sc , actual}^{UCI} ( l )$$

is the number of resource elements that can be used for transmission of UCI in OFDM symbol l, for

$$l = 0 , 1 , 2 , ⋯ , {N}_{symb , actual}^{PUSCH} - 1 ,$$

in the actual repetition of the PUSCH transmission, and

$${N}_{symb , actual}^{PUSCH}$$

is the total number of OFDM symbols in the actual repetition of the PUSCH transmission, including all OFDM symbols used for DMRS;
for any OFDM symbol that carries DMRS of the actual repetition of the PUSCH transmission,

$${M}_{sc , actual}^{UCI} ( l ) = 0 ;$$

for any OFDM symbol that does not carry DMRS of the actual repetition of the PUSCH transmission,

$${M}_{sc , actual}^{UCI} ( l ) = {M}_{sc}^{PUSCH} - {M}_{sc , actual}^{PT - RS} ( l )$$

where

$${M}_{sc , actual}^{PT - RS} ( l )$$

is the number of subcarriers in OFDM symbol l that carries PTRS, in the actual repetition of the PUSCH transmission;
and all the other notations in the formula are defined the same as for PUSCH not using repetition type B.

Meanwhile, when HARQ-ACK is transmitted on a PUSCH (or CG-PUSCH), if UL-SCH is not present, the number of coded modulation symbols may be determined by the following Equation 14.

$$Equation 14$$

$${Q}_{ACK}^{′} = min \{ ⌈ \frac{( {O}_{ACK} + {L}_{ACK} ) \cdot {β}_{offset}^{PUSCH}}{R \cdot {Q}_{m}} ⌉ , ⌈ α \cdot {\sum }_{l = {l}_{0}}^{{N}_{symb , all}^{PUSCH} - 1} {M}_{sc}^{UCI} ( l ) ⌉ \}$$

R is the code rate of PUSCH and is a value configured by the base station and may be determined by higher layer signaling or L1 signaling. Further, Qm may mean an order of a modulation scheme of PUSCH.

Based on

$${Q}_{ACK}^{′}$$

determined in Equations 12 and 13 above, the number

$${E}_{ACK} = {N}_{L} \cdot {Q}_{ACK}^{′} \cdot {Q}_{m}$$

of codeword bits of ACK may be obtained.

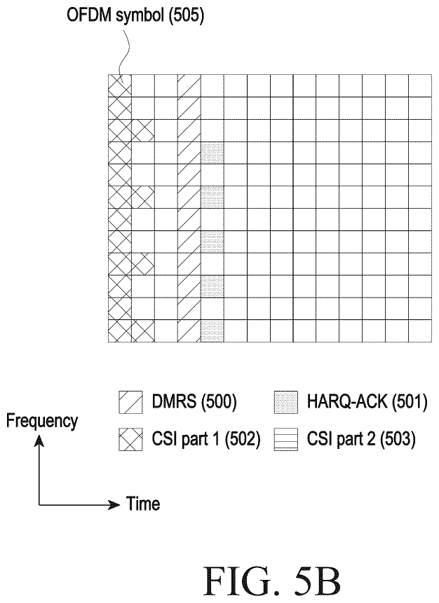

FIG. 6 is a view illustrating a processing procedure for transmitting and receiving UCI information through a PUSCH between a UE and a base station according to an embodiment of the disclosure.

Referring to FIG. 6, according to a procedure of FIG. 6, the UE may generate UCI information at 600. At 602, the UE determines a UCI information size and does not include CRC if it is 11 bits or less, and if it is greater than 12 bits, may additionally perform code block segmentation or include CRC according to the UCI information size. At 604, if the UCI information size is 11 bits or less, the UE may perform channel coding of small block lengths, and if it is greater than 12 bits, may perform polar coding. At 606, the UE may perform rate matching according to Equations 6 to 14 according to the UCI information type and calculate the number of coded modulation symbols. At 608, code blocks are combined, and at 610, coded UCI bit information may be multiplexed to a PUSCH. After the UE transmits a modulated PUSCH to the base station, the base station may demodulate the corresponding PUSCH at 612 and perform demultiplexing of coded UCI bits in the PUSCH. The base station may divide received information into code block units at 614 and perform rate dematching at 616. At 618, decoding may be performed with a channel coding scheme coded according to the UCI information size. The base station may combine decoded code blocks at 620 and obtain UCI information. Through the series of procedures, UCI information may be included in a PUSCH and transmitted and received. The flowchart described above in FIG. 6 is merely an example, and at least one block among 600 to 622 may be omitted under a specific condition. Further, it may be sufficiently possible that other blocks other than 600 to 622 included in the flowchart described above in FIG. 6 are added and operated.

The following may be described in Table 25 for a procedure in which uplink data and control information are multiplexed.

```
TABLE 25
  Step 1:
  When HARQ-ACK information to be transmitted on a PUSCH is 0 or 1 or 2 bits,
reserved resources for potential HARQ-ACK transmission may be determined. The reserved
resources may be determined in a frequency-first manner starting from a first symbol
immediately after a symbol where a first DMRS is present among resources to which a PUSCH
is allocated. The frequency-first manner may collectively refer to methods of sequentially
mapping frequency resources for each symbol and then moving to a next symbol to perform
mapping. In this case, the amount of reserved resources may be calculated assuming that
HARQ-ACK information is 2 bits.
  Depending on whether PUSCH hopping is performed, it may be determined whether to
separate coded bits for potential HARQ-ACK transmission using reserved resources by hop.
  Step 2:
  When HARQ-ACK information to be transmitted on a PUSCH is greater than 2 bits,
rate matching may be performed. In other words, coded bits of HARQ-ACK information may
be mapped in a frequency-first manner starting from a first symbol immediately after a symbol
where a first DMRS is present among resources to which a PUSCH is allocated.
  Step 2A:
  When CG-UCI information to be transmitted on a PUSCH is present, rate matching
may be performed. In other words, coded bits of CG-UCI information may perform frequency-
first mapping starting from a first symbol immediately after a symbol where a first DMRS is
present among resources to which a PUSCH is allocated.
  Step 3:
  When CSI part1 information to be transmitted on a PUSCH is present, rate matching
may be performed. CSI part 1 may be mapped using frequency-first mapping starting from the
first symbol in resources to which a PUSCH is allocated, excluding DMRS and resources to
which HARQ-ACK reserved or HARQ-ACK or CG-UCI are allocated in Step1 or Step 2 or
2A. Subsequently, CSI part 2 may be mapped using frequency-first mapping starting from a
first symbol in resources to which a PUSCH is allocated, excluding DMRS and resources to
which HARQ-ACK or CG-UCI or CSI part 1 are allocated in Step 2 or 2A. CSI part2 may be
allocated to reserved REs allocated in step1.
  Step 4:
  Data information (UL-SCH) rate matching may be performed. UL-SCH may be
mapped using frequency-first mapping on resources to which a PUSCH is allocated, except for
resources to which UCI information mapped in Steps 2 through 3 are mapped. UL-SCH may
be allocated to reserved REs allocated in step1.
  Step 5:
  When HARQ-ACK information to be transmitted on a PUSCH is not greater than 2
bits, mapping may be performed to resources reserved in Step 1. In this case, since a reserved
resource amount was calculated assuming HARQ-ACK as 2 bits, actually mapped resources
may be less than the number of reserved REs. When UCI resources or UL-SCH previously
mapped in steps 2 to 4 are present in the resources, the corresponding information may be
punctured and the HARQ-ACK information may be mapped.
  For the steps, when the number of bits (or the number of modulated symbols) of uplink
control information to be mapped to a PUSCH is greater than the number of bits (or REs)
capable of mapping uplink control information within the corresponding OFDM symbol to be
mapped, the frequency axis RE interval d between modulated symbols of uplink control
information to be mapped may be set to d = 1. If the number of bits (or the number of modulated
symbols) of uplink control information to be mapped to a PUSCH by the UE is less than the
number of bits (or REs) capable of mapping uplink control information within the
corresponding OFDM symbol to be mapped, a frequency axis RE interval d between modulated
symbols of uplink control information to be mapped may be set to d = floor(# of available bits
on 1-OFDM symbol/# of unmapped UCI bits at the beginning of 1-OFDM symbol).
```

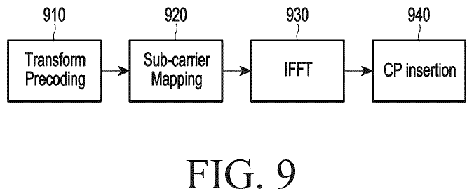

FIG. 11 is a flowchart illustrating a procedure in which uplink information and control information are multiplexed according to an embodiment of the disclosure. The procedures in Table 25 may be configured as a flowchart from the UE perspective as illustrated in FIG. 11. FIG. 11 is only one example for operating Table 25, and a specific block diagram of FIG. 11 may be omitted or replaced with something else, and it may be sufficiently possible to operate with other configurations without being limited thereto. In FIG. 11, the UE may determine whether HARQ-ACK is present and perform reserved resource determination or rate matching accordingly. Subsequently, it may proceed in an order of determining whether CG-UCI is present, determining whether CSI part 1 is present, and determining whether CSI part 2 is present. The determination of presence may be made by the UE based on presence of a PUCCH that overlaps at least one symbol of resources to which a PUSCH is allocated or information included in a DCI that schedules a PUSCH indicating that specific UCI information is included. Subsequently, the UE may map data resources and, when HARQ-ACK bits are 2 bits or less, map control information to pre-reserved resources.

### [PUCCH/PUSCH: Priority Level]

The following may describe a transmission method of the UE according to priority information of PUCCH and PUSCH.

When one UE simultaneously supports eMBB and URLLC, it may be possible to transmit data or control information for eMBB through PUSCH or PUCCH and transmit data or control information for URLLC through PUSCH or PUCCH. Since requirements of the two services are different and URLLC service generally has priority over eMBB, when at least one symbol of a channel to which eMBB is allocated overlaps a channel to which URLLC is allocated, it may be possible for the UE to select and transmit at least one of URLLC or eMBB channels. Specifically, the priority information may be indicated by a higher layer signal or an L1 signal, and a priority information value may be 0 or 1. A PUCCH or PUSCH indicated as 0 may be considered for eMBB, and a PUCCH or PUSCH indicated as 1 may be considered for URLLC.

In the case of PUSCH, when there is a field capable of indicating priority information in DCI, a priority of PUSCH may be determined by a value indicated by the corresponding field. Even for a PUSCH scheduled by DCI, when there is no field capable of indicating priority in the corresponding DCI, the UE may consider that the corresponding PUSCH has a priority value of 0. The PUSCH may be applied to all cases including or not including Aperiodic CSI or Semi-persistent CSI. In the case of a configured grant PUSCH that is transmitted and received periodically without DCI, priority may be determined by a higher layer signal.

In the case of PUCCH, priority may be determined by a higher layer signal for a PUCCH that transmits and receives SR information and a PUCCH that includes HARQ-ACK information for SPS PDSCH. For a PUCCH that includes HARQ-ACK information for PDSCH scheduled by DCI, when there is a priority field in the corresponding DCI, a priority value indicated by the corresponding field is applied, and if there is no corresponding field, it may be considered to have a priority value of 0. Further, a PUCCH including Semi-persistent CSI or periodic CSI may always be considered to have a priority value of 0.

When resources of PUCCH or PUSCH indicated by a higher layer signal or an L1 signal such as DCI overlap and at least some PUCCHs or PUSCHs have different priority information from each other, the UE may first resolve overlap for PUCCH or PUSCH with a priority information value of 0. For example, it may include a series of processes of including UCI information included in PUCCH in PUSCH. Subsequently, when the finally determined PUCCH or PUSCH through the overlapped low-priority PUCCH or PUSCH is called a second PUCCH or a second PUSCH, and a high-priority PUCCH or PUSCH is called a first PUCCH or a first PUSCH, when the second PUCCH or the second PUSCH overlaps the first PUCCH or the first PUSCH in terms of time resources, the UE may cancel transmission of the second PUCCH and the second PUSCH. The UE may expect that transmission of a first PUCCH or a first PUSCH starts at least after Tproc,2+d1 after a last symbol of PDCCH reception including DCI that scheduled the corresponding transmission. Otherwise, the UE may consider it as an error case. The value of Tproc,2+d1 may use a value presented in Equation 2.

According to the description, a PUCCH including HARQ-ACK information for PDSCH including eMBB data will have a low priority value of 0, and a PUCCH including HARQ-ACK information for PDSCH including URLLC data may have a high priority value of 1. Therefore, when a PUCCH with a priority value of 0 and a PUCCH with a priority value of 1 overlap in terms of time resources, the UE will drop a PUCCH with a priority value of 0 and may transmit a PUCCH with a priority value of 1. Therefore, from the base station perspective, since HARQ-ACK information for PDSCH including eMBB data was not received, it may not know whether the UE properly received the corresponding eMBB data, so it may retransmit again. Therefore, there may be a possibility that eMBB data transmission/reception efficiency is degraded.

For convenience of description, HARQ-ACK information for PDSCH including eMBB data may be referred to as Low priority (LP) HARQ-ACK, and HARQ-ACK information for PDSCH including URLLC data may be referred to as high priority (HP) HARQ-ACK. Low priority (LP) HARQ-ACK may refer to HARQ-ACK information having a priority value of 0, and high priority (HP) HARQ-ACK may refer to HARQ-ACK information having a priority value of 1.

A possible method to prevent the degradation of eMBB data transmission/reception efficiency may be a method of simultaneously multiplexing HP HARQ-ACK and LP HARQ-ACK in one PUCCH or PUSCH channel. Therefore, when HP HARQ-ACK and LP HARQ-ACK are multiplexed in PUCCH or PUSCH, there may be a possibility of being multiplexed together with existing CSI part 1 and CSI part 2. If the base station or the UE may multiplex only a maximum of 3 UCI information to multiplex in PUCCH or PUSCH, a method may be needed to drop which information among 4 information and select the rest.

Subsequently, an embodiment may describe a method of multiplexing UCI information to PUSCH in an environment where HP HARQ-ACK and LP HARQ-ACK are present. Further, since HP HARQ-ACK and LP HARQ-ACK have different requirements even though they are the same HARQ-ACK information, there may be a need for HP HARQ-ACK to be transmitted more reliably than LP HARQ-ACK, and accordingly, different encoding and rate matching methods may be applied. For example, when determining the number of coded modulation symbols for HP HARQ-ACK and LP HARQ-ACK in Equation 12, values where at least

$${β}_{offset}^{PUSCH}$$

or α value is different may be applied. Further, when HP HARQ-ACK and LP HARQ-ACK are multiplexed in one PUSCH, while HP HARQ-ACK applies Equation 12, when LP HARQ-ACK is transmitted to a PUSCH (or CG-PUSCH), the number

$${Q}_{LP \_ ACK}^{′}$$

of coded modulation symbols may be determined by the following Equation 15.

$${Q}_{LP \_ ACK}^{′} = min \{ ⌈ \frac{( {O}_{LP \_ ACK} + {L}_{LP \_ ACK} ) \cdot {β}_{offset}^{PUSCH} \cdot {\sum }_{l = 0}^{{N}_{symb , all}^{PUSCH} - 1} {M}_{sc}^{UCI} ( l )}{{\sum }_{r = 0}^{{C}_{UL - SCH} - 1} {K}_{r}} ⌉ , ⌈ α \cdot {\sum }_{l = {l}_{0}}^{{N}_{symb , all}^{PUSCH} - 1} {M}_{sc}^{UCI} ( l ) ⌉ - {Q}_{ACK / CG - UCI}^{′} \} \qquad Equation 15$$

For HARQ-ACK LP transmission on an actual repetition of a PUSCH with repetition Type B with UL-SCH, the number of coded modulation symbols per layer for HARQ-ACK LP transmission, denoted as

$${Q}_{ACK}^{′} ,$$

is determined as follows:

$${Q}_{ACK}^{′} = min \{ ⌈ \frac{{O}_{LP \_ ACK} + {L}_{LP \_ ACK} ) \cdot {β}_{offset}^{PUSCH} \cdot \sum \text{?} M \text{?} ( l )}{\sum \text{?} {K}_{r}} ⌉ , ⌈ α \cdot {\sum }_{l = 0} \text{?} M \text{?} ( l ) ⌉ - {Q}_{ACK / CG − UCI}^{′} , {\sum }_{l = 0} \text{?} M \text{?} ( l ) - {Q}_{ACK / CG − UCI}^{′} \}$$

$$\text{?} \text{indicates text missing or illegible when filed}$$

Further, when there is no UL-SCH and there is CSI part1, the number

$${Q}_{LP \_ ACK}^{′}$$

of coded modulation symbols may be determined by the following Equation 16.

$${Q}_{LP \_ ACK}^{′} = min \{ [ \frac{( {O}_{LP \_ ACK} + {L}_{LP \_ ACK} ) \cdot {β}_{offset}^{PUSCH}}{R \cdot {Q}_{m}} ] , ⌈ α \cdot {\sum }_{l = {l}_{0}}^{{N}_{symb , all}^{PUSCH} - 1} {M}_{sc}^{UCI} ( l ) ⌉ − {Q}_{ACK / CG - UCI}^{′} \} \qquad Equation 16$$

Further, when there is no UL-SCH and there is CSI part1, the number

$${Q}_{LP \_ ACK}^{′}$$

of coded modulation symbols may be determined by the following Equation 17.

$${Q}_{LP \_ ACK}^{′} = {\sum }_{l = {l}_{0}}^{{N}_{symb , all}^{PUSCH} − 1} {M}_{sc}^{UCI} ( l ) − {Q}_{ACK / CG − UCI}^{′} \qquad Equation 17$$

$${Q}_{ACK / CG - UCI}^{′}$$

is a value determined based on Equation 12, Equation 13, or Equation 14 and may mean the number of coded modulation symbols per layer for transmitting HARQ_ACK or CG-UCI or HARQ_ACK/CG-UCI. (the number of coded modulation symbols per layer)

### [PUCCH: Type 1 HARQ-ACK Codebook]

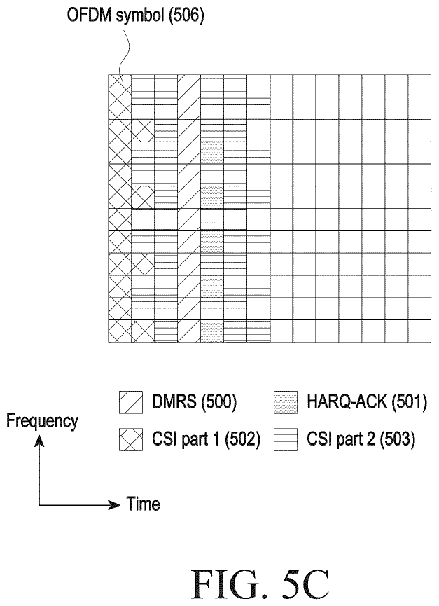

The following may be a description of a semi-static HARQ-ACK codebook (or Type-1 HARQ-ACK codebook). FIG. 7 is a view illustrating a semi-static HARQ-ACK codebook (or Type-1 HARQ-ACK codebook) configuration method in an NR system.

In a circumstance where a HARQ-ACK PUCCH that the UE may transmit is limited to one within one slot, when the UE receives a semi-static HARQ-ACK codebook higher layer signal configuration, the UE may report HARQ-ACK information for PDSCH reception or SPS PDSCH release in a HARQ-ACK codebook in a slot indicated by a value of a PDSCH-to-HARQ_feedback timing indicator in DCI format 1_x. The UE may report a HARQ-ACK information bit value as NACK in a HARQ-ACK codebook in a slot not indicated by a PDSCH-to-HARQ_feedback timing indicator field in DCI format 1_x. If the UE reports only HARQ-ACK information for one SPS PDSCH release or one PDSCH reception in MA, C cases for candidate PDSCH reception, and the report is scheduled by DCI format 1_0 including information where a counter DACI field indicates 1 in Pcell, the UE may determine one HARQ-ACK codebook for the corresponding SPS PDSCH release or the corresponding PDSCH reception.

Otherwise, a HARQ-ACK codebook determination method according to a method described below may be followed.

If the set of PDSCH reception candidates is MA,c in serving cell c, MA,c may be obtained by [pseudo-code 1] steps as follows.

### [Pseudo-Code 1 Starts]

Step 1: Initialize j to 0 and MA,c to an empty set. Initialize k, the HARQ-ACK transmission timing index, to 0.
Step 2: Set R as a set of rows in the table including PDSCH-mapped slot information, start symbol information, symbol count, or length information. If the PDSCH-possible mapping symbol indicated by each value of R is set as a UL symbol according to the above DL and UL configuration, delete the corresponding row from R.
Step 3-1: Add one to set MA,c if the UE is able to receive one PDSCH for unicast in one slot and R is not an empty set.
Step 3-2: If the UE is able to receive more than one PDSCH for unicast in one slot, count PDSCHs allocable to different symbols in the calculated R and add them to MA,c.
Step 4: Increase k by one and restart from step 2.

### [Pseudo-Code 1 Ends]

In the example of FIG. 7 for the above-described pseudo-code 1. To perform HARQ-ACK PUCCH transmission in slot #k 708, all slot candidates capable of PDSCH-to-HARQ-ACK timing that may indicate slot #k 708 may be considered. In FIG. 7, it may be assumed that HARQ-ACK transmission is possible in slot #k 708 by a PDSCH-to-HARQ-ACK timing combination for which only PDSCHs scheduled in slot #n 702, slot #n+1 704, and slot #n+2 706 are possible. The maximum number of PDSCHs schedulable per slot may be derived considering the time domain resource configuration information about the PDSCH schedulable in each of slots 702, 704, and 706 and information indicating whether the symbol in the slot is downlink or uplink. For example, assuming that maximum scheduling is possible for 2 PDSCHs in slot 702, 3 PDSCHs in slot 704, and 2 PDSCHs in slot 706, the maximum number of PDSCHs included in the HARQ-ACK codebook transmitted in slot 708 is 7 in total. This may be referred to as the cardinality of the HARQ-ACK codebook.

### [PUCCH: Type 2 HARQ-ACK Codebook]

Dynamic HARQ-ACK codebook (or Type-2 HARQ-ACK codebook) may be described below.

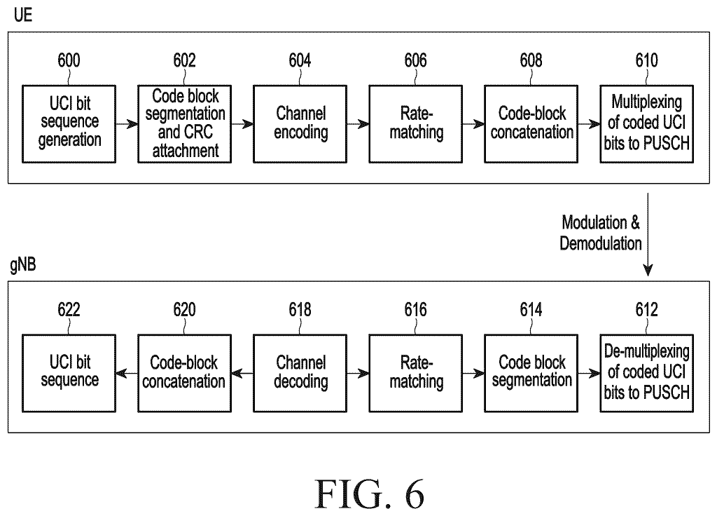

FIG. 8 is a view illustrating a dynamic HARQ-ACK codebook (or Type-2 HARQ-ACK codebook) configuration method in an NR system according to an embodiment of the disclosure.

The UE may transmit HARQ-ACK information, transmitted in one PUCCH in slot n, based on K0 which is transmission slot position information about the PDSCH scheduled in DCI format 1_x and the PDSCH-to-HARQ_feedback timing value for PUCCH transmission of HARQ-ACK information in slot n for SPS PDSCH release or PDSCH reception. Specifically, for the above-described HARQ-ACK information transmission, the UE may determine the HARQ-ACK codebook of the PUCCH transmitted in the slot determined by K0 and PDSCH-to-HARQ_feedback timing based on the DAI included in the DCI indicating SPS PDSCH release or PDSCH.

The DAI may be composed of a counter DAI and a total DAI. Counter DAI may be information that indicates the position of HARQ-ACK information corresponding to PDSCH scheduled in DCI format 1_x within a HARQ-ACK codebook. Specifically, a value of counter DAI in DCI format 1_x may indicate a cumulative value of PDSCH reception or SPS PDSCH release scheduled by DCI format 1_x in a specific cell c. The cumulative value may be set based on a PDCCH monitoring occasion and a serving cell where the scheduled DCI is present.

Total DAI may be a value that indicates a HARQ-ACK codebook size. Specifically, a value of Total DAI may mean the total number of PDSCH or SPS PDSCH release previously scheduled including a time when DCI is scheduled. And Total DAI may be a parameter used when HARQ-ACK information in a serving cell c includes HARQ-ACK information for PDSCH scheduled in other cells including the serving cell c in a CA (Carrier Aggregation) circumstance. In other words, there may be no Total DAI parameter in a system operating with one cell.

FIG. 8 may include an operation example for the DAI. FIG. 8 may show changes in the values of the counter DAI (C-DAI) and total DAI (T-DAI) indicated by the DCI discovered per PDCCH monitoring occasion set for each carrier when transmitting, on the PUCCH 820, the HARQ-ACK codebook selected based on the DAI in the nth slot of carrier 9 802 when the UE is configured with two carriers c. First, in the DCI discovered at m=0 (806), C-DAI and T-DAI each may indicate a value of 1 (812). In the DCI discovered at m=1 (808), C-DAI and T-DAI each may indicate a value of 2 (814). In the DCI discovered for carrier 0 (c=0, 802) of m=2 (810), C-DAI may indicate a value of 3 (816). In the DCI discovered for carrier 1 (c=1, 804) of m=2 (810), C-DAI may indicate a value of 4 (818). In this case, if carriers 0 and 1 are scheduled on the same monitoring occasion, all T-DAIs may be indicated as 4.

Referring to FIGS. 7 and 8, HARQ-ACK codebook determination may operate in the context that only one PUCCH containing HARQ-ACK information is transmitted in one slot. This may be referred to as mode 1. As an example method in which one PUCCH transmission resource is determined in one slot, when PDSCHs scheduled in different DCIs are multiplexed into one HARQ-ACK codebook and transmitted in the same slot, the PUCCH resource selected for HARQ-ACK transmission may be determined as the PUCCH resource indicated by the PUCCH resource field indicated in the DCI that has last scheduled the PDSCH. In other words, the PUCCH resource indicated by the PUCCH resource field indicated in the DCI scheduled before the above-described DCI may be disregarded.

In the following description, HARQ-ACK codebook determination method and devices may be defined in the context where two or more PUCCHs containing HARQ-ACK information may be transmitted in one slot. This may be referred to as mode 2. The UE may operate only mode 1 (transmission of only one HARQ-ACK PUCCH within one slot) or only mode 2 (transmission of one or more HARQ-ACK PUCCHs within one slot). Alternatively, the UE that supports both mode 1 and mode 2 may configure the base station to operate in only one mode by higher layer signaling, or mode 1 and mode 2 may be implicitly determined by DCI format, RNTI, DCI specific field value, scrambling, etc. For example, PDSCH and associated HARQ-ACK information scheduled in DCI format A are based on mode 1, and PDSCH and associated HARQ-ACK information scheduled in DCI format B may be based on mode 2.

### [PUCCH: Type 3 HARQ-ACK Codebook]

The following may describe a Type-3 HARQ-ACK codebook.

Unlike Type-1, 2 HARQ-ACK codebooks, a Type-3 HARQ-ACK codebook may be a method of reporting all HARQ-ACK information for all serving cells configured by the UE, the number of HARQ processes, the number of TBs per HARQ process, and the number of CBGs per TB. For example, when the UE has 2 serving cells, 16 HARQ processes per serving cell, 1 TB per HARQ process, and 2 CBGs per TB, the UE may report a total of 64 (=2×16×1×2) HARQ-ACK information bits. Further, according to a separate configuration, it may be possible to report an NDI value that the UE recently received for each HARQ process related to HARQ-ACK information. Through the corresponding NDI value, the base station may determine whether PDSCH received for each HARQ process of the UE is determined as initial transmission or retransmission. When there is no corresponding NDI value report separately, when the UE has already reported HARQ-ACK information for a specific HARQ process before receiving DCI requesting a Type-3 HARQ-ACK codebook from the base station, the UE may map to NACK for the corresponding HARQ process, and otherwise, may map HARQ-ACK information bits for PDSCH received for each corresponding HARQ process. The number of serving cells, the number of HARQ processes, the number of TBs, and the number of CBGs may each be configured and, when there is no separate configuration for each, the UE may consider the number of serving cells as 1, the number of HARQ processes as 8, the number of TBs as 1, and the number of CBGs as 1, respectively. Further, the number of HARQ processes may be different for each serving cell. Further, the number of TBs may have different values for each serving cell or each BWP within a serving cell. Further, the number of CBGs may be different for each serving cell.

One of the reasons why a Type-3 HARQ-ACK codebook is needed is that a case may occur where the UE may not transmit a PUCCH or PUSCH including HARQ-ACK information for PDSCH due to reasons such as channel access failure or overlap with another channel with higher priority. Therefore, it may be reasonable for the base station to request reporting only the corresponding HARQ-ACK information without having to reschedule a separate PDSCH. Therefore, it may be possible for the base station to schedule the Type-3 HARQ-ACK codebook and a PUCCH resource including the corresponding codebook through a higher layer signal or an L1 signal (e.g., a specific field in DCI).

If the UE searches for a DCI format including a value of 1 in a field requesting one-shot HARQ-ACK, the UE may determine a PUCCH or PUSCH resource for multiplexing a Type-3 HARQ-ACK codebook in a specific slot indicated by the DCI format. And the UE may multiplex only the Type-3 HARQ-ACK codebook in PUCCH or PUSCH for transmission in the corresponding slot. In other words, if two PUCCHs overlap and one is a Type-1 HARQ-ACK codebook (or Type-2 HARQ-ACK codebook) and the other is the Type-3 HARQ-ACK codebook, the UE may multiplex only the Type-3 HARQ-ACK codebook in the PUCCH or PUSCH. The reason is that since the Type-3 HARQ-ACK codebook includes HARQ-ACK information bits for all serving cells configured by the UE, all HARQ process numbers, all TBs, and all CBGs, information of Type-1 HARQ-ACK codebook and Type-2 HARQ-ACK codebook may be seen as already included in the Type-3 HARQ-ACK codebook.

However, since the Type-3 HARQ-ACK codebook includes all HARQ-ACK information bits based on all information configured by the UE, HARQ-ACK information bits for PDSCH that are not actually scheduled should also be included in the codebook even when mapped to NACK, and accordingly, there may be a disadvantage that an information bit size is large. Therefore, as an uplink control information bit size increases, there may be a possibility that uplink transmission coverage or transmission reliability is decreased. Therefore, a HARQ-ACK codebook with a smaller size than the Type-3 HARQ-ACK codebook may be needed. This is regarded as different from an existing Type-3 HARQ codebook in the disclosure, and for convenience, it may be described as an enhanced Type-3 HARQ-ACK codebook (or Type-4 HARQ-ACK codebook) in the disclosure. However, it may be sufficiently possible to be replaced with other names. For example, an enhanced Type-3 HARQ-ACK codebook may be configured as follows.
Type A: A subset of a total set of (configured) serving cells
Type B: A subset of a total set of (configured) HARQ process numbers
Type C: A subset of a total set of (configured) TB indexes
Type D: A subset of a total set of (configured) CBG indexes
Type E: A combination of at least two types among the types A to D

The enhanced Type-3 HARQ-ACK codebook may have at least one characteristic among the types A to E and may be configured as one or multiple sets. A whole set instead of a subset among the types A to E may be included. A meaning of multiple sets may be, e.g., that Type A and Type B are present or that even Type A has different subsets. Considering the types A to E, the enhanced Type-3 HARQ-ACK codebook may be indicated by a higher layer signal or an L1 signal or a combination thereof. For example, as illustrated in Table 26 below, set configurations for HARQ-ACK information bits to be reported with each enhanced Type-3 HARQ-ACK codebook are indicated by a higher layer signal, and one value among them may be indicated by an L1 signal. As illustrated in Table 26, individual configuration may be possible for what type of enhanced Type-3 HARQ-ACK codebook is configured for each index by a higher layer signal. Further, for a specific index such as index 3, it may be possible to use the Type-3 HARQ-ACK codebook that reports all HARQ-ACK information bits. The Type-3 HARQ-ACK codebook may be determined to be indicated by a separate higher layer signal or used as a default value (e.g., ACK or NACK state for all HARQ process numbers) when there is no higher layer signal.

TABLE 26

| Index | Type 3 |
|---|---|
| 1 | serving cell i, HARQ process number (#1~#8), TB 1 |
| 2 | serving cell i, HARQ process number (#9~#12), TB 1 |
| 3 | Type-3 HARQ-ACK codebook |
| . . . | . . . |

When the UE receives a value requesting a one-shot HARQ-ACK feedback field and receives a value indicated as index 1 according to Table 26, the UE may report a total of 8 bits of HARQ-ACK information bits for serving cell i, HARQ process numbers (#1 to #8), and TB 1. When the UE receives a value requesting a one-shot HARQ-ACK feedback field and receives a value indicated as index 2 according to Table 26, the UE may report a total of 4 bits of HARQ-ACK information bits for serving cell i, HARQ process numbers (#1 to #8), and TB 1. When the UE receives a value requesting a one-shot HARQ-ACK feedback field and receives a value indicated as index 3 according to Table 26, the UE may calculate the total number of HARQ-ACK bits considering a serving cell set, the total number of HARQ processes per serving cell i, the number of TBs per HARQ process, and the number of CBGs per TB. Table 26 is merely an example, and the total number of indexes may be more or less than this, and a range of HARQ process values indicated by each index and/or information included in the enhanced Type-3 HARQ-ACK codebook may be different. Further, Table 26 may be information indicated by a higher layer signal, and a specific index may be notified through DCI. Further, in addition to Table 26, HARQ-ACK information indicated through a specific index value or a one-shot HARQ-ACK feedback field (or other L1 signals) may be used for the purpose of resending specific HARQ-ACK information that was dropped when the UE was scheduled to transmit, rather than HARQ-ACK information for a specific (or all) HARQ process number. This may be referred to as dropped HARQ-ACK retransmission. The dropping case may be a case where a PUCCH or PUSCH including the HARQ-ACK information overlaps another PUCCH or PUSCH having higher priority. Or the dropping case may be a case where at least one symbol of a PUCCH or PUSCH including the HARQ-ACK information is indicated as a downlink symbol by a higher layer signal in advance. Or the dropping case may be a case where a PUCCH or PUSCH including the HARQ-ACK information is at least partially overlapped with a resource indicated by DCI including Uplink Cancellation information having a purpose of canceling uplink transmission. When the UE supports both the dropped HARQ-ACK retransmission and (enhanced) type-3 HARQ codebook-based transmission, the UE may be able to select at least one of the dropped HARQ-ACK retransmission and (enhanced) type-3 HARQ codebook-based transmission and report HARQ information through at least one piece of information among CRC and scrambled RNTI information of DCI or a search space type where DCI is searched or priority information among DCI fields or MCS, RV, NDI, HARQ process ID, etc., or a combination thereof. Or a specific index value of Table 26 may be configured and used for dropped HARQ-ACK retransmission. A specific index selection of Table 26 may be indicated by at least one of HARQ process number or MCS or NDI or RV or frequency resource allocation information or time resource allocation information among DCI fields or a combination thereof. A size of a DCI bit field indicating a specific index of Table 26 may be determined as

$$⌈ {log}_{2} ( {N}_{total}^{index} ) ⌉ .$$

### Here,

$${N}_{total}^{index} \text{?}$$

$$\text{?} \text{indicates text missing or illegible when filed}$$

may mean the total number of indexes of Table 26 configured by a higher layer signal.

A total number N of HARQ-ACK bits may be represented as the following Equation 18.

$$N = {{\sum }^{n ( c )}}_{c} {H}_{c} \times {T}_{b , c} \times {B}_{c} \qquad Equation 18$$

In Equation 18, n(c) is the total number of serving cells c, Hc is the number of HARQ processes configured in serving cell c, Tb,c is the number of TBs per HARQ process configured in serving cell c and BWP b, and Bc may be the number of CBGs configured in serving cell c. Further, when the UE searches for a DCI format with a one-shot HARQ-ACK request field value of 1, the UE may determine a PUCCH or PUSCH resource for multiplexing the Type-3 HARQ-ACK codebook (or enhanced Type-3 HARQ-ACK codebook). And the UE may multiplex only the Type-3 HARQ-ACK codebook (or enhanced Type-3 HARQ-ACK codebook) in the determined PUCCH or PUSCH resource for transmission in the corresponding slot. If there is a PUCCH or PUSCH including SR information or CSI information that overlaps the PUCCH or PUSCH, it may be possible for the UE to not multiplex it and drop SR or CSI information. In other words, it may be possible to multiplex only Type-3 HARQ-ACK information and drop other UCI such as SR and CSI.

### [PUCCH Power Control]

PUCCH power control may be described below. Equation 19 below may be an equation that determines the PUCCH transmission power.

$${P}_{PUCCH , b , f , c} ( i , q \text{?} , q \text{?} , l ) = min \{ \begin{matrix}{P}_{CMAX , f , c} ( i ) , \\ \begin{matrix}{P}_{{0}_{PUCCH} , b , f , c} ( q \text{?} ) + 10 {log}_{10} ( {2}^{μ} \cdot {M}_{RB , b , f , c}^{PUCCH} ( i ) ) + \\ {PL}_{b , f , c} ( {q}_{d} ) + Δ \text{?} ( i ) + {Δ}_{TF , b , f , c} ( i ) + {f}_{b , f , c} ( i , l )\end{matrix}\end{matrix} \} \qquad Equation 19$$

$$[ dBm ]$$

$$\text{?} \text{indicates text missing or illegible when filed}$$

In Equation 19, P₀_{_{PUCCH}}_{,b,f,c}(qᵤ) is a reference setting transmission power setting value, and has a different value according to various transmission types qᵤ, and the value may be changed by a higher layer signal such as RRC or MAC CE. When the value is changed by MAC CE, if the slot in which HARQ-ACK is transmitted for the PDSCH that received MAC CE is k, the UE may determine that the corresponding value is applied from the k+koffset slot. koffset may have different values depending on the subcarrier spacing, and may be, e.g., 3 ms.

$${M}_{RB , b , f , c}^{PUSCH} ( i )$$

may be the size of the frequency resource area where PUCCH is allocated. PL_{b,f,c}(q_{d}) is an estimated pathloss value of the UE, and the UE may calculate it based on a specific reference signal among various CSI-RSs or SS/PBCHs depending on whether a higher layer signal is set and the type thereof. For repeated transmission PUCCHs, the same q_{d} may apply. For repeated transmission PUCCHs, the same qᵤ may apply.

For PUCCH formats 2, 3, and 4, when a UCI size is greater than or equal to 11, a value of Δ_{TF,b,f,c}(i) in Equation 19 may be determined by Equation 20 below.

$${Δ}_{TF , b , f , c} ( i ) = 10 {log}_{10} ( {K}_{1} \cdot ( {n}_{HARQ - ACK} ( i ) + {O}_{SR} ( i ) + {O}_{C S I} ( i ) ) / {N}_{R E} ( i ) ) \qquad Equation 20$$

In Equation 20, K1 is 6, n_{HARQ-ACK}(i) is the number of HARQ-ACK bits, O_{SR}(i) is the number of SR bits, O_{CSI}(i) is the number of CSI bits, and N_{RE}(i) may mean the number of REs of PUCCH.

### [PDSCH: SPS]

SPS operations may be described below. When the UE may operate 2 or more activated DL SPS in one cell/one BWP, the base station may configure 2 or more DL SPS configurations to one UE. A reason for supporting 2 or more DL SPS configurations is that when the UE supports various traffic, different MCS or time/frequency resource allocation or periods may be different for each traffic, so it may be advantageous to configure DL SPS configurations suitable for each purpose.

The UE may receive at least some of the following higher layer signal configuration information for DL SPS as illustrated in Table 27.

```
TABLE 27
  Periodicity: DL SPS transmission period
  nrofHARQ-Processes: Number of HARQ processes configured for DL SPS
  n1PUCCH-AN: HARQ resource configuration information for DL SPS
  mcs-Table: MCS table configuration information applied to DL SPS
  sps-ConfigIndex-r16: Index of SPS configured in one cell/one BWP
  harq-ProcID-Offset-r16: Offset value for HARQ-ACK process number calculation
  periodicityExt-r16: DL SPS transmission period, which may be set to different values
according to subcarrier spacing, and if this field is present, Periodicity is ignored
  harq-CodebookID-r16: HARQ-ACK codebook index information for SPS or SPS
release
  pdsch-AggregationFactor-r16: Number of SPS PDSCH repetitive transmissions
```

Among the higher layer signal configuration information, an SPS index may be utilized for the purpose of indicating which SPS a DCI (L1 signaling) providing SPS activation or deactivation refers to. Specifically, in a circumstance where 2 SPSs are configured with a higher layer signal in one cell/one BWP, index information that indicates this may be needed in SPS higher layer information for the UE to know which of the 2 SPSs a DCI indicating SPS activation refers to. For example, the UE may enable activation or deactivation by a HARQ process number field in DCI indicating SPS activation or deactivation pointing to an index of a specific SPS. Specifically, as illustrated in Table 28, when DCI including CRC scrambled with CG-RNTI includes the following information and an new data indicator (NDI) field of the corresponding DCI indicates 0, the UE may determine that it indicates a specific SPS PDSCH release (deactivation) that is already activated.

TABLE 28

| | DCI format 0_0 | DCI format 1_0 |
|---|---|---|
| HARQ process number | SPS index | SPS index |
| Redundancy version | set to ‘00’ | set to ‘00’ |
| Modulation and coding scheme | set to all ‘1’s | set to all ‘1’s |
| Frequency domain resource | set to all ‘1’s | set to all ‘1’s |
| assignment | | |

In Table 28, one HARQ process number may indicate one SPS index or may indicate multiple SPS indexes. It may also be possible to indicate one or multiple SPS index(es) by other DCI fields (time resource field, frequency resource field, MCS, RV, PDSCH-to-HARQ timing field, etc.) other than the HARQ process number field. Basically, one SPS may be activated or deactivated by one DCI. A position of a type 1 HARQ-ACK codebook for HARQ-ACK information for DCI indicating SPS PDSCH release may be the same as a position of a type 1 HARQ-ACK codebook corresponding to a reception position of the corresponding SPS PDSCH. When a position of a HARQ-ACK codebook corresponding to candidate SPS PDSCH reception in a slot is k1, a position of a HARQ-ACK codebook for DCI indicating release of the corresponding SPS PDSCH may also be k1. Therefore, when DCI indicating SPS PDSCH release is transmitted in slot k, the UE will not expect to be scheduled for PDSCH corresponding to HARQ-ACK codebook position k1 in the same slot k and, when such a circumstance occurs, the UE may consider it as an error case. Table 28 exemplified DCI formats 0_0 and 1_0, but it may also be applied to DCI formats 0_1 and 1_1, and may be sufficiently extendable and applicable to other DCI formats 0_x and 1_x. By the above-described operation, the UE may simultaneously operate one or 2 or more SPS PDSCHs in one cell/one BWP by receiving SPS PDSCH higher layer signal and receiving DCI indicating activation of SPS PDSCH. Subsequently, the UE may periodically receive activated SPS PDSCH in one cell/one BWP and transmit corresponding HARQ-ACK information. HARQ-ACK information corresponding to SPS PDSCH may be determined by the UE through slot interval information by PDSCH-to-HARQ-ACK timing included in activated DCI information and exact time and frequency information within the corresponding slot and PUCCH format information through n1PUCCH-AN information included in SPS higher configuration information. If there is no PDSCH-to-HARQ-ACK timing field included in DCI information, the UE may assume that one value previously configured with a higher layer signal is applied as a default value and determine that the corresponding value is applied.

Or the UE may configure the following DL SPS configuration information from a higher layer signal.
Periodicity: DL SPS transmission period
nrofHARQ-Processes: Number of HARQ processes configured for DL SPS
n1PUCCH-AN: HARQ resource configuration information for DL SPS
mcs-Table: MCS table configuration information applied to DL SPS

In the disclosure, all DL SPS configuration information may be configured for each Pcell or Scell, and may also be configurable for each frequency bandwidth part (BWP). Further, it may be possible for one or more DL SPSs to be configured for each specific cell-specific BWP.

The UE may determine grant-free transmission/reception configuration information through receiving a higher layer signal for DL SPS. DL SPS may enable data transmission/reception for a configured resource area after receiving DCI indicating activation, and may not perform data transmission/reception for a resource area before receiving the corresponding DCI. Further, for a resource area after receiving DCI indicating release, the UE may not perform data reception.

The UE may verify DL SPS assignment PDCCH when the following 2 conditions are all satisfied for SPS scheduling activation or release.
Condition 1: When CRC bits of a DCI format transmitted in the PDCCH are scrambled with CS-RNTI configured with higher layer signaling
Condition 2: When an new data indicator (NDI) field for an activated transport block is set to 0

When some of fields constituting a DCI format transmitted with the DL SPS assignment PDCCH are the same as those presented in Table 29 or Table 30, the UE may determine that information in the DCI format is a valid activation or a valid release of DL SPS. For example, when the UE detects a DCI format including information presented in Table 29, the UE may determine that DL SPS is activated. As another example, when the UE detects a DCI format including information presented in Table 30, the UE may determine that DL SPS is released.

When some of fields constituting a DCI format transmitted with the DL SPS assignment PDCCH are not the same as those presented in Table 29 (special field configuration information for activating DL SPS) or Table 30 (special field configuration information for releasing DL SPS), the UE may determine that the DCI format is detected with CRC that does not match.

TABLE 29

| | DCI format 1_0 | DCI format 1_1 |
|---|---|---|
| HARQ process number | set to all ‘0’s | set to all ‘0’s |
| Redundancy version | set to ‘00’ | For the enabled transport |
| | | block: set to ‘00’ |

TABLE 30

| | DCI format 1_0 |
|---|---|
| HARQ process number | set to all ‘0’s |
| Redundancy version | set to ‘00’ |
| Modulation and coding scheme | set to all ‘1’s |
| Resource block assignment | set to all ‘1’s |

The UE may generate the corresponding HARQ-ACK information bit when receiving PDSCH without PDCCH reception or receiving PDCCH indicating SPS PDSCH release. Further, at least in Rel-15 NR, the UE may not expect to transmit HARQ-ACK information(s) for two or more SPS PDSCH receptions in one PUCCH resource. In other words, at least in Rel-15 NR, the UE may include only HARQ-ACK information for one SPS PDSCH reception in one PUCCH resource.

DL SPS may also be configured in P (primary) Cell and S (secondary) Cell. Parameters that may be configured with DL SPS higher layer signaling may be as follows.
Periodicity: Transmission period of DL SPS
nrofHARQ-processes: Number of HARQ processes that may be configured for DL SPS
n1PUCCH-AN: PUCCH HARQ resource for DL SPS, the base station configures resources with PUCCH format 0 or 1

Tables 29 and 30 may be possible fields in a circumstance where only one DL SPS may be configured per cell and per BWP. In a circumstance where multiple DL SPSs are configured per cell and per BWP, DCI fields for activating (or releasing) each DL SPS resource may be different. The disclosure may provide a method to solve such a circumstance.

In the disclosure, not all DCI formats described in Tables 29 and 30 may be used for activating or releasing DL SPS resources, respectively. For example, DCI format 1_0 and DCI format 1_1 used for scheduling PDSCH may be utilized for activating DL SPS resources. For example, DCI format 1_0 used for scheduling PDSCH may be utilized for releasing DL SPS resources.

### [CSI: Calculation Time]

When a CSI request field on DCI received from the base station triggers CSI report(s) to be included in PUSCH, the UE may report valid CSI for an nth triggered report when the following conditions are satisfied.

Condition 1: When it does not start earlier than a first uplink symbol Zref including the corresponding CSI report reflecting an effect of timing advance

Condition 2: When it does not start earlier than a first uplink symbol Z′ref(n) including an nth CSI report reflecting an effect of timing advance

Zref may mean a next first symbol that starts after Tproc,CSI of Equation 21 from a last symbol of PDCCH that triggers the CSI report. Zref may mean a next first symbol that starts after T′proc,CSI of Equation 22 from a last symbol of a CSI-RS resource (or CSI-IM or NZP CSI-RS). Equations 21 and 22 may be as follows.

$$Tproc , CSI = ( Z ) ( 2048 + 144 ) \cdot κ 2 − μ \cdot Tc + Tswitch \qquad Equation 21$$

$${T}^{′} proc , CSI = ( {Z}^{′} ) ( 2048 + 144 ) \cdot κ 2 − μ \cdot Тс \qquad Equation 22$$

Z and Z′ values may have different values according to subcarrier spacing. Or Z and Z′ values may have different values according to whether a type used for CSI reporting is SINR or RSRP. Or Z and Z′ values may have different values according to whether a CSI resource used for CSI reporting is CRI or SSB. Or Z and Z′ values may have different values according to whether TB is present in PUSCH including CSI reporting. Or Z and Z′ values may have different values according to whether HARQ-ACK is multiplexed in PUSCH including CSI reporting. Or Z and Z′ values may have different values according to the number of CSI-RS ports. Or Z and Z′ values may have different values according to whether it is wideband CSI reporting or subband CSI reporting. Or Z and Z′ values may have different values according to codebook type. Or Z and Z′ values may have different values according to UE capability type. Table 31 may be an example illustrating that Z and Z′ values may be different from each other according to subcarrier spacing.

TABLE 31

Z [symbols]

| μ | Z | Z′ |
|---|---|---|
| 0 | 10 | 8 |
| 1 | 13 | 11 |
| 2 | 25 | 21 |
| 3 | 43 | 36 |

### [CP-OFDM]

Hereinafter, cyclic prefix orthogonal frequency division multiplexing (CP-OFDM) may be described. CP-OFDM effectively reduces inter-symbol interference due to multipath fading and may facilitate recovery and synchronization processes of received signals. This may increase reliability of data transmission and may enable high-speed data transmission support in various wireless communication systems. CP is generated by copying an end portion of an OFDM symbol and inserting it at a front portion of the corresponding symbol, and the inserted CP may absorb ISI caused by multipath delay so that a received OFDM symbol is less affected. Further, a length of CP should be set longer than multipath delay spread. Therefore, an OFDM symbol including CP minimizes interference that may occur in a multipath environment and may facilitate signal recovery and synchronization at a receiving side. A transmission process of CP-OFDM may be composed of the following procedures.

Data Input: Data to be transmitted may be input. This data is a digital signal and may be, e.g., in the form of a bit stream.

Serial-to-Parallel Conversion: An input serial data stream is converted to a parallel data stream to map to each subcarrier of OFDM. Parallelized data may be signal symbols to be allocated to each subcarrier.

Modulation: A parallelized data stream may be modulated through digital modulation schemes such as quadrature amplitude modulation (QAM) or phase shift keying (PSK). Modulated symbols represent data in a frequency domain, and each symbol may correspond to one subcarrier.

Inverse fast Fourier transform (IFFT): modulated subcarrier symbols may be converted from a frequency domain to a time domain through the inverse fast Fourier transform (IFFT). An output of IFFT may be an OFDM signal in which multiple subcarriers orthogonal to each other are synthesized.

Cyclic Prefix Insertion: To prevent inter-symbol interference (ISI) due to multipath fading, a portion of a last portion of an OFDM symbol may be copied and inserted at a front of the symbol. A length of inserted CP should be set longer than multipath delay spread, which may reduce interference that may occur when a transmission signal is received.

Parallel-to-Serial Conversion: An OFDM signal with CP inserted may be converted from parallel data to a serial data stream again. This may be a preparation process for transmission to a wireless channel through a transmitter.

D/A Conversion and RF Transmission: A serialized signal may be converted to an analog signal through digital-to-analog conversion (D/A Conversion). This analog signal may be transmitted to a wireless channel through a transmission antenna after frequency modulation.

A reception process of CP-OFDM may be composed of the following procedures.

RF Reception and A/D Conversion: A transmitted analog signal may be received by a reception antenna. This signal may be converted to a digital signal through analog-to-digital conversion (A/D Conversion).

Serial-to-Parallel Conversion: A received serial signal may be converted to a parallel data stream. This parallelized signal may be used for OFDM symbol recovery.

Cyclic Prefix Removal: CP may be removed from a received signal. A signal with CP removed is recovered to an original OFDM symbol, and CP has already performed a role of mitigating signal interference.

Fast Fourier transform (FFT): A signal with CP removed may be converted from a time domain to a frequency domain through FFT. FFT may extract modulated symbols by restoring frequency components of each subcarrier as a reverse process of IFFT.

Equalization: A channel equalization process is performed to correct distortion caused by a channel. In this process, amplitude and phase of a signal may be corrected based on channel state information to recover original modulated symbols.

Demodulation: Recovered symbols may be demodulated to original bit data. According to QAM or PSK modulation schemes, each symbol may be converted to corresponding bit data.

Parallel-to-Serial Conversion: A demodulated parallel data stream may be converted to a serial data stream. Through this process, an original transmitted data bit stream may be recovered.

Data Output: Recovered data is output, which may match original data input at a transmission side.

### [DFT-S-OFDM]

Hereinafter, discrete Fourier transform spread-ofdm (DFT-s-OFDM) may be described. Orthogonal frequency division multiplexing (OFDM) is a method of transmitting data in parallel using multiple subcarriers and may show strong performance against frequency selective fading and inter-symbol interference (ISI). However, an OFDM method has a disadvantage of high peak-to-average power ratio (PAPR). High PAPR may cause nonlinear distortion of a power amplifier and degrade transmission efficiency. To solve this, a DFT-s-OFDM method introducing discrete Fourier transform (DFT) spreading may be proposed. DFT-s-OFDM may be a technology that may enhance transmission efficiency by effectively reducing PAPR while maintaining advantages of OFDM. DFT spreading may apply discrete Fourier transform (DFT) to an input data sequence to convert data to a frequency domain. DFT may evenly spread each symbol of input data to all subcarriers so that each subcarrier has the same signal energy. Accordingly, PAPR is lowered, reducing nonlinear distortion of a power amplifier and enhancing quality of a transmission signal. Next, DFT spread data is mapped to multiple subcarriers through an OFDM modulator, and mapped subcarriers may be transmitted in parallel while maintaining orthogonality. In this process, cyclic prefix (CP) is inserted to strengthen resistance to multipath fading. Accordingly, DFT-s-OFDM may effectively lower PAPR while maintaining strong performance of OFDM against frequency selective fading and inter-symbol interference. When PAPR is lowered, efficiency of a power amplifier increases, and it may contribute to extending battery life and enhancing signal quality. A transmission process of DFT-s-OFDM may be composed of the following procedures.

Data Input: Digital data to be transmitted may be input. This data is generally in the form of a bit stream, and each bit may be ready to be converted to a symbol.

Serial-to-Parallel Conversion: An input serial data stream may be converted to a parallel data stream. Parallelized data may be each data block.

Modulation: A parallel data stream may be modulated through digital modulation schemes such as quadrature amplitude modulation (QAM) or phase shift keying (PSK). Modulated symbols represent data in a frequency domain and may be ready to be transmitted later through DFT.

DFT Spreading: Modulated symbols may be converted from a frequency domain to a time domain through discrete Fourier transform (DFT) operation. DFT may serve to distribute each modulated symbol to multiple subcarriers. In this process, each symbol is spread across multiple subcarriers, which may have an effect of lowering PAPR of a signal.

Serial-to-Parallel Conversion and Subcarrier Mapping: An output of DFT is converted to a parallel data stream, which may be mapped to each subcarrier of OFDM. Each DFT spreading symbol is mapped to a given subcarrier and may constitute an OFDM signal.

Inverse fast Fourier transform (IFFT): Mapped subcarriers may be converted to a time domain through IFFT. IFFT may generate one OFDM symbol by combining all subcarriers. In this case, an OFDM symbol may be composed of multiple subcarriers orthogonal to each other.

Cyclic Prefix (CP) Insertion: A cyclic prefix (CP) may be inserted into a generated OFDM symbol. CP is what is inserted at a front of a symbol by copying a last portion of an OFDM symbol and may prevent inter-symbol interference (ISI) due to multipath fading.

Parallel-to-Serial Conversion: An OFDM symbol with CP inserted may be converted from parallel data to a serial data stream again. This serial signal may be in a state ready to be transmitted to a wireless channel from a transmitter.

D/A Conversion and RF Transmission: A serialized signal may be converted to an analog signal through digital-to-analog conversion (D/A Conversion). An analog signal may be transmitted to a wireless channel through a transmission antenna after frequency modulation.

A reception process of DFT-s-OFDM may be composed of the following procedures.

RF Reception and A/D Conversion: A reception antenna receives a transmitted analog signal. This signal may be converted to a digital signal through analog-to-digital conversion (A/D Conversion).

Serial-to-Parallel Conversion: A received serial signal may be converted to a parallel data stream. This parallelized signal is a preparation process for OFDM symbol recovery.

Cyclic Prefix Removal: A cyclic prefix (CP) may be removed from a received signal. A signal with CP removed may be recovered to an original OFDM symbol. CP is for preventing interference due to multipath and may be removed in a reception process.

Fast Fourier transform (FFT): A signal with CP removed may be converted from a time domain to a frequency domain through FFT. FFT may extract modulated symbols by recovering frequency components separated by subcarrier.

Subcarrier Demapping and Parallel-to-Serial Conversion: Symbols recovered from each subcarrier may be recovered to an original parallel data stream again. Recovered data may be ready to be converted to original modulated symbols through DFT operation.

IDFT Despreading: Recovered frequency domain data may be converted to an original time domain through inverse discrete Fourier transform (IDFT). IDFT may serve to recover original modulated symbols by inverse-transforming data DFT spread at a transmission side.

Demodulation: Recovered symbols may be demodulated and converted to original bit data. Using QAM or PSK modulation schemes, each symbol may be converted to the corresponding bit stream.

Parallel-to-Serial Conversion: A demodulated parallel data stream may be converted to a serial data stream. This serial data may be recovered to an original transmitted +bit stream.

Data Output: Recovered data is output, which may match original data input at a transmission side.

### [CP-OFDM Vs DFT-s-OFDM]

As described above, CP-OFDM may be a method that adds a cyclic prefix (CP) to an OFDM method. OFDM may be a method that simultaneously transmits data using multiple orthogonal subcarriers. In this case, each subcarrier should maintain orthogonality to avoid interfering with each other. Accordingly, the following advantages and disadvantages are generally well known.

Advantage 1: May be strong against Multipath Interference. A cyclic prefix (CP) may play an important role in mitigating multipath interference that may occur during signal transmission. Accordingly, it may show robust performance against frequency selective fading of a channel.

Advantage 2: Efficient frequency resource use may be possible. Frequency resources may be efficiently utilized using orthogonal subcarriers.

Advantage 3: A receiver structure may be simple. Since CP-OFDM may independently demodulate signals of each subcarrier, a structure of a receiver may be relatively simple.

Disadvantage 1: Peak-to-average power ratio (PAPR) may be high. One of main disadvantages of CP-OFDM may be high peak-to-average power ratio (PAPR). This may cause inefficiency in amplifier design.

Disadvantage 2: Signal loss due to multipath delay may occur. If a length of CP is shorter than multipath delay, signal loss may occur.

DFT-s-OFDM is a type of OFDM and may be a method that first performs discrete Fourier transform (DFT) on data to be transmitted and then maps the result to subcarriers of OFDM. This may be a method proposed to solve a high PAPR problem of CP-OFDM. DFT-s-OFDM may also be called single carrier frequency division multiple access (SC-FDMA). The following advantages and disadvantages are generally known.

Advantage 1: PAPR may be low. It may provide lower PAPR compared to CP-OFDM by spreading data through DFT. This may increase power efficiency and create favorable conditions for amplifier design.

Advantage 2: Can have single carrier characteristics. Unlike CP-OFDM, DFT-s-OFDM maintains single carrier characteristics, so it may exhibit better performance against frequency selective fading.

Advantage 3: May be demodulated in the same way as OFDM while providing flexibility to apply various modulation schemes. Therefore, it may support modem design with a structure similar to OFDM.

Disadvantage 1: Transmitter and receiver design complexity may be increased. Due to DFT process and additional processing, receiver design may become complex. Further, due to this, DFT and inverse DFT (IDFT) operations are added, and computational load of transmitters and receivers may increase.

Disadvantage 2: In specific channel circumstances, DFT-s-OFDM may be inefficient in terms of frequency resource utilization compared to CP-OFDM.

CP-OFDM has a simple structure and is strong against multipath interference, but may have a high PAPR problem. DFT-s-OFDM has good power efficiency due to low PAPR and may maintain single carrier characteristics, but computational complexity increases and may be disadvantageous in efficiency in specific circumstances.

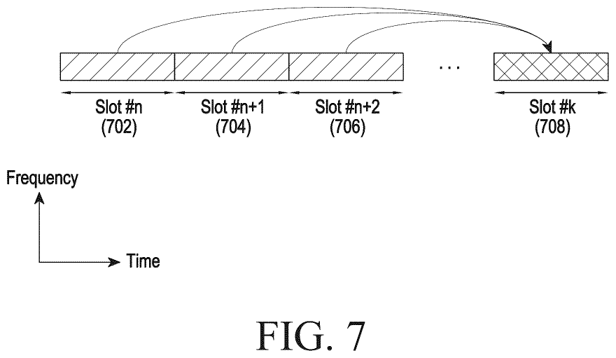

FIG. 9 is a transmission block diagram according to an embodiment of the disclosure.

Referring to FIG. 9, first, a Transform precoding operation 910 is applied only to DFT-S-OFDM, and subsequent Sub-carrier mapping 920, IFFT 930, and CP insertion 940 may be commonly applied to both DFT-S-OFDM and CP OFDM. Therefore, since all remaining processes except for the Transform precoding operation 910 are the same, it may be easy when implementing a modem. Further, in the case of DFT-S-OFDM, since a Transform precoding operation 910 is added, design complexity may be increased compared to CP OFDM.

### [OTFS]

Hereinafter, orthogonal time frequency space (OTFS) may be described. In existing wireless communication systems, frequency domain modulation schemes such as orthogonal frequency division multiplexing (OFDM) have been widely used. However, OFDM may have a disadvantage that performance deteriorates in environments with severe time-frequency variation such as multipath fading. Particularly, in high-speed mobile environments, interference in a frequency domain increases due to a Doppler effect, and communication quality may be greatly degraded. OTFS is a modulation scheme proposed to solve these problems and may modulate and transmit data in a time-Doppler space rather than a time-frequency domain. Accordingly, it illustrates strong performance against multipath fading and Doppler effect, and more stable data transmission may be possible. Modulation in a time-Doppler space means that input data may be converted to a time-Doppler space. To that end, a 2D transformation technique that converts a signal in a time-frequency domain to a time-Doppler domain may be applied. Subsequently, converted data may be modulated in a time-Doppler space. OTFS transmits by mapping each signal to a combination of Doppler frequency and delay time, which may enable more robust transmission against multipath and Doppler effect. Accordingly, resistance to multipath fading may be strong. Since OTFS is designed so that a transmitted signal is distributed in a time-Doppler space, interference due to multipath is distributed and may be effectively recovered at a receiver. Further, since OTFS naturally processes frequency shift due to Doppler effect in a time-Doppler space, it may guarantee stable communication even in high-speed mobile environments. Further, the receiver may, after demodulating a received signal in a time-Doppler space, inverse-transform it to a time-frequency domain. Through this process, original data may be accurately recovered. Accordingly, OTFS may perform channel equalization in a time-Doppler domain to effectively compensate for channel variability. As a result, an OTFS system may provide excellent performance even in environments with severe multipath and Doppler effect, and particularly, communication performance in high-speed mobile environments or urban areas is greatly enhanced, and it may be usefully applied in vehicle-to-everything (V2X), satellite communication, etc. A transmission process of OTFS may be composed of the following procedures.

Data Input: Digital data to be transmitted may be input. This data is generally in the form of a bit stream, and each bit may be ready to be converted to a symbol.

Serial-to-Parallel Conversion: An input serial data stream may be converted to a parallel data stream. This parallel data may be prepared for time-Doppler domain mapping of OTFS.

Modulation: A parallel data stream may be modulated through digital modulation schemes such as quadrature amplitude modulation (QAM) or phase shift keying (PSK). Modulated symbols represent data in a frequency domain. In OTFS, these modulated symbols may be ready to be mapped to a time-Doppler domain.

2D Transformation-Mapping to Time-Doppler Domain: Modulated symbols may be mapped to a time-Doppler domain through 2D transformation. This transformation includes a process of converting a signal from a time-frequency domain to a time-Doppler domain, and SFFT (Separated Fourier Transform) or other 2D transformation techniques may be used for this. In this mapping process, symbols are disposed in various delay time and Doppler frequency combinations, and through this, robustness against multipath and Doppler effect may be increased.

Sampling After Domain Transformation: A signal mapped in a time-Doppler domain may be converted to a time-frequency domain again. In this case, a signal may be converted to a time domain through inverse fast Fourier transform (IFFT). A converted signal is composed of OTFS symbols and may be ready to be transmitted in a time domain later.

Cyclic Prefix (CP) Insertion: A cyclic prefix (CP) may be inserted into OTFS symbols generated in a time domain. CP may be used to prevent multipath fading and inter-symbol interference (ISI) like OFDM.

Parallel-to-Serial Conversion: An OTFS signal with CP inserted may be converted from parallel data to a serial data stream. A serialized signal may be ready to be transmitted to a wireless channel through a transmitter.

D/A Conversion and RF Transmission: A serialized signal may be converted to an analog signal through digital-to-analog conversion (D/A Conversion). An analog signal may be transmitted to a wireless channel through a transmission antenna after frequency modulation.

A reception process of OTFS may be composed of the following procedures.

RF Reception and A/D Conversion: A reception antenna receives a transmitted analog signal. This signal may be converted to a digital signal through analog-to-digital conversion (A/D Conversion).

Serial-to-Parallel Conversion: A received serial signal may be converted to a parallel data stream. This parallelized signal is a preparation process for recovering OTFS symbols.

Cyclic Prefix Removal: A cyclic prefix (CP) may be removed from a received signal. A signal with CP removed may be recovered to original OTFS symbols. CP has already performed its role of reducing interference due to multipath in a reception process.

Time-Frequency Domain Transformation: A signal with CP removed may be converted to a time-frequency domain. This transformation may be performed using a tool such as Fast Fourier Transform (FFT). In this process, a received signal may be converted to data sampled in a frequency domain.

2D Transformation-Transformation to Time-Doppler Domain: A signal converted in a time-frequency domain may be converted to a time-Doppler domain again. Through this transformation, a received signal is mapped to original Doppler frequency and delay time, and through this, multipath and Doppler effect may be accurately compensated.

Demodulation: Data recovered in a time-Doppler domain may be converted to original bit data through a demodulation process. Using QAM or PSK modulation schemes, each symbol may be converted to the corresponding bit stream.

Parallel-to-Serial Conversion: A demodulated parallel data stream may be converted to a serial data stream. This serial data may be recovered to an original transmitted bit stream.

Data Output: Recovered data is output, which may match original data input at a transmission side.

The above-described CP-OFDM, DFT-S-OFDM, and OTFS may be considered as waveforms that may provide optimal performance in specific environments. For example, supporting CP-OFDM and DFT-S-OFDM for uplink transmission in LTE and 5G NR may be applicable. In next-generation communication systems, it may be possible to support one or more waveforms when transmitting not only uplink but also downlink. In such a circumstance, a method for determining downlink-related processing time may be described.

### Embodiment 1

Hereinafter, a method for determining PDSCH processing time according to a waveform may be described. When the UE supports a first waveform and a second waveform for downlink transmission/reception, it may be possible for different PDSCH processing times to be determined according to whether it is the first waveform or the second waveform. The first waveform may be one of DFT-S-OFDM or CP-OFDM or OTFS. The second waveform may be one of DFT-S-OFDM or CP-OFDM or OTFS. When the first waveform is applied, x symbols may be added in Equation 1. When the second waveform is applied, y symbols different from x symbols may be added. x and y may each have a form of values having integer values. For example, in a circumstance where a waveform of PDCCH is fixed to CP-OFDM, additional processing time may or may not be needed according to whether a waveform of PDSCH is CP-OFDM or DFT-S-OFDM or OTFS. If waveforms of both PDCCH and PDSCH are CP-OFDM, the UE does not have waveform change from a reception standpoint, but when a waveform of PDCCH is CP-OFDM and a waveform of PDSCH is DFT-S-OFDM or OTFS, since the UE has waveform change from a reception standpoint, additional processing time according to the corresponding change may be needed. Therefore, the x or y symbols may be added for the reasons, and may have different values according to UE capability reporting. Or when the first waveform is applied, Equation 1 may be applied and, when the second waveform is applied, Equation 23 may be applied. Equation 23 may have the following form.

$$Tproc , 1 = ( N 1 + d 1 , 1 ) ( 2048 + 144 ) κ 2 − μ Tc \qquad Equation 23$$

Or when the first waveform is applied, it may be possible for processing time to be increased according to the number of layers or the number of ranks of a scheduled PDSCH. For example, if the number of layers is 4, processing time may be added by 2 symbols in Equation 1. As another example, if the number of ranks is 2, processing time may be added by 1 symbol in Equation 1. Determination of whether the first waveform or the second waveform is applied may be configured or indicated from the base station to the UE by a higher layer signal or an L1 signal or a combination thereof. For example, it may be possible to indicate whether a waveform for a scheduled PDSCH is the first waveform or the second waveform through a specific field in a DCI format.

Or the first waveform may be configured or indicated only under specific conditions. The specific conditions may correspond to at least one of necessary processing minimum required time, subcarrier spacing, the number of DMRS symbols, PDSCH mapping type, PDSCH time resource length, overlap PDCCH resource, PDSCH frequency size, and the number of layers. For example, when multiple processing minimum required time conditions of the UE exist, the first waveform may be applied only to slow required time conditions. As another example, the first waveform may be applied only to a specific subcarrier spacing (e.g., 15 kHz). As another example, the first waveform may be applied only when a DMRS symbol is one symbol within a scheduled PDSCH resource. As another example, the first waveform may be applied only when a DMRS mapping type of a scheduled PDSCH is fixed to a specific symbol position in a slot rather than a first symbol of the scheduled PDSCH. As another example, the first waveform may be applied only when a transmission length of a scheduled PDSCH is greater than X symbols. As another example, the first waveform may be applied only when a scheduled PDSCH transmission resource does not overlap a PDCCH resource at least in terms of time resource. The reason is that when a waveform applied to PDCCH and a waveform applied to PDSCH are different, the UE may need switching time to receive and process different waveforms respectively. As another example, the first waveform may be applied only when a frequency resource size (number of RBs) of a scheduled PDSCH is smaller than Y. As another example, the first waveform may be applied only to a PDSCH scheduled with a single layer. A meaning that the first waveform is applied only to the specific conditions may mean that when the corresponding conditions are not satisfied, the first waveform is not applied. The conditions may be determined by the UE through a higher layer signal or an L1 signal or combinations thereof. For example, the number of DMRS symbols may be indicated through a specific field in DCI that schedules PDSCH. As another example, time resource length and PDSCH frequency length of PDSCH may be indicated through different specific fields in DCI respectively. As another example, a DMRS mapping type of PDSCH may be configured through a separate higher layer signal.

### Embodiment 2

Hereinafter, an embodiment may describe a method for performing CSI calculation (computation time) in a circumstance where multiple waveforms may be applied to CSI-RS. The UE may have minimum required time for CSI-RS measurement and reporting, and in this case, the minimum required time may be the same or different according to a waveform applied to CSI-RS measured by the UE. When the UE measures CSI-RS, an applied waveform may be the first waveform or the second waveform, which may be configured by a higher layer signal in advance or indicated by an L1 signal. When configured by a higher layer signal in advance, when the UE receives CSI-RS related higher layer signal configuration information, it may be possible for the UE to receive waveform information applied to the corresponding CSI-RS within the corresponding information. When receiving by an L1 signal, when the UE performs aperiodic or semi-persistent CSI-RS measurement and/or additionally reports measurement values thereof, when information is included in a specific DCI format, it may be determined whether a waveform is the first waveform or the second waveform through a specific field in the corresponding DCI format. Or whether it is the first waveform or the second waveform may be implicitly determined through CSI-RS resource information value or CSI-RS measurement reporting resource value in the DCI format. The implicit determination may mean a case where linkage information between CSI-RS resource information value (or CSI-RS measurement reporting resource value) and a specific waveform is configured by a higher layer signal in advance.

The UE may report valid CSI when the following conditions are satisfied in a circumstance where multiple waveforms may be applied to CSI-RS. In other words, when a CSI request field on DCI received from the base station triggers CSI report(s) to be included in PUSCH, the UE may report valid CSI for an nth triggered report when the following conditions are satisfied.

Condition 1: When it does not start earlier than a first uplink symbol Zref including the corresponding CSI report reflecting an effect of timing advance

Condition 2: When it does not start earlier than a first uplink symbol Z′ref(n) including an nth CSI report reflecting an effect of timing advance

Zref may mean a next first symbol that starts after Tproc,CSI of Equation 21 from a last symbol of PDCCH that triggers the CSI report. Zref may mean a next first symbol that starts after T′proc,CSI of Equation 22 from a last symbol of a CSI-RS resource (or CSI-IM or NZP CSI-RS). The UE may apply the same values as Table 31 for both the first waveform and the second waveform for Z and Z′ values in Equation 21 or Equation 22, or different values may be applied for at least some items other than Table 31. Or when the UE reports CSI-RS measurement results, when reporting measurement results for the first waveform or the second waveform, Equation 21 or Equation 22 may be applied. Or when the UE reports CSI-RS measurement results, when reporting both measurement results for the first waveform and the second waveform, the UE may be able to add an N1 value to Equation 21 or Equation 22 respectively. The N1 may be in symbol units, ms units, or slot units. Or instead of adding +N1 value to Equation 21 or Equation 22 respectively, when reporting multiple waveforms in the form of Table 31, it may be possible to add an N2 value. In this case, a unit of N2 may be symbol units or ms units. Further, an N2 value may be applied differently for each subcarrier spacing and for each Z or Z′ value. Or when the UE reports CSI-RS measurement results, when reporting only one waveform or reporting both measurement results for the first waveform and the second waveform, it may be possible to apply different tables using Z or Z′. Although Table 31 was taken as an example, it may be possible to apply other tables similar to Table 31 respectively.

Further, when reporting CSI-RS measurement applying the first waveform, it may be possible only under specific circumstances. For example, CSI-RS measurement report applying the first waveform may be possible only for a specific subcarrier spacing (e.g., 15 kHz). As another example, when CSI measurement information is reported by PUSCH, CSI-RS measurement report applying the first waveform may be possible only when there is no TB in the corresponding PUSCH. In other words, when CSI measurement report is indicated through DCI that schedules UL grant, it may be determined that there is no TB in the corresponding PUSCH through a field indicating presence of TB in the corresponding DCI format. As another example, when CSI measurement information is reported by PUSCH, the corresponding CSI measurement information may be reported to the corresponding PUSCH only when a waveform of the corresponding PUSCH and a waveform of measured CSI-RS are the same. A waveform of the PUSCH and a waveform of CSI-RS may be determined by different higher layer signals or different L1 signals or different combinations thereof respectively. As another example, CSI-RS measurement report applying the first waveform may be possible only when the number of CSI-RS resources included in CSI-RS measurement report is below a predetermined threshold. When the threshold is X, if the UE performs measurement report for more CSI-RS resources than X, it may not be able to apply the first waveform. In other words, the first waveform may be applied only when the UE performs measurement report for X or fewer CSI-RS resources than X. As another example, when reporting CSI-RS measurement, the first waveform may be applied only to a specific CSI feedback type. The first waveform may be applied when the UE reports CSI feedback composed of at least some combinations of specific RI, CRI, CQI, LI, and PMI, and the first waveform may not be applied otherwise. An example of the combinations may mean composed of RI, CRI, and CQI. Or it may mean composed of RI and CQI. Or when L1 (or CQI or CRI or PMI or RI) is included in CSI feedback, the UE does not apply the first waveform. In other words, the UE may apply the first waveform only when there is no L1 (or CQI or CRI or PMI or RI). As another example, when reporting CSI-RS measurement, the UE may be able to apply the first waveform only when reporting CSI-RS feedback for a specific reportQuantity. Or the UE may be able to apply the first waveform when reporting CSI-RS feedback including a specific reportQuantity. The specific reportQuantity may correspond to ‘ssb-Index-RSRP’ or ‘cri-SINR’ or ‘ssb-Index-SINR’ or ‘cri-RSRP-Index’ or ‘ssb-Index-RSRP-Index’ or ‘cri-SINR-Index’ or ‘ssb-Index-SINR-Index’ or ‘tdcp’. As another example, it may be possible to apply the first waveform only to at least aperiodic CSI report or semi-persistent CSI report or periodic CSI report or some combinations thereof. As another example, when reporting CSI-RS including an RI value of 2 or more, it may be possible not to apply the first waveform. In other words, CSI-RS measurement report applying the first waveform may be possible only when an RI value is 1.

A meaning of applying the first waveform may mean that when reporting CSI feedback, a waveform applied to the corresponding CSI-RS resource is the first waveform. A meaning of not applying the first waveform may mean that when reporting CSI feedback, a waveform applied to the corresponding CSI-RS resource is another waveform except for the first waveform.

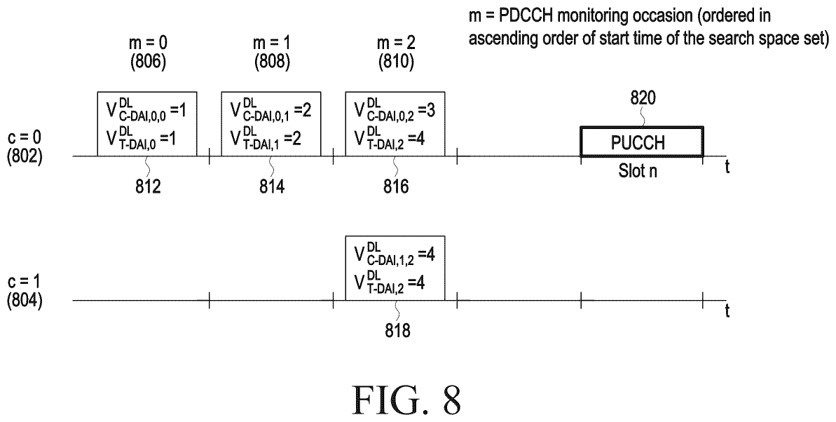

FIG. 10 is a flowchart illustrating a process of calculating processing time of the UE and reporting HARQ-ACK feedback accordingly in a circumstance where multiple waveforms may be applied to a PDSCH according to an embodiment of the disclosure.

Referring to FIG. 10, the UE may receive higher layer signal information or an L1 signal or a combination thereof from the base station at operation 1010. Accordingly, when receiving PDSCH, an applied waveform may be determined as described in embodiment 1 at operation 1020. Subsequently, the UE may transmit a PUCCH or PUSCH including HARQ-ACK information based on a first processing time or a second processing time respectively according to whether the corresponding waveform is the first waveform or the second waveform at operations 1030 and 1040. In this case, a first processing time and a second processing time may be composed of different equations, or a second processing time may be composed of a form in which some constants or variables are added or modified from a first processing time.

FIG. 11 is a flowchart illustrating a procedure in which uplink information and control information are multiplexed according to an embodiment of the disclosure.

Referring to FIG. 11, FIG. 11 is a flowchart illustrating a process of determining CSI calculation time of the UE and reporting CSI feedback accordingly in a circumstance where multiple waveforms may be applied to CSI-RS according to an embodiment.

Referring to FIG. 11, the UE may receive higher layer signal information or an L1 signal or a combination thereof from the base station at operation 1110. Accordingly, the UE may receive CSI-RS and determine a waveform applied to the corresponding CSI-RS as described in embodiment 2 at operation 1120. Subsequently, the UE may transmit a PUCCH or PUSCH including CSI feedback information based on a first processing time or a second processing time respectively according to whether the corresponding waveform is the first waveform or the second waveform at operation 1130 and 1140. In this case, a first processing time and a second processing time may be composed of different equations, or a second processing time may be composed of a form in which some constants or variables are added or modified from a first processing time.

The disclosure relates to a communication technique for merging, with an IoT technology, a 5G communication system for supporting a data transmission rate higher than that of a 4G system and a system therefor. The disclosure can be applied for intelligent services based on 5G communication technology and IoT related technology (for example, smart homes, smart buildings, smart cities, smart cars or connected cars, healthcare, digital education, retail businesses, security and safety related services, and the like). The disclosure may propose a method and device for uplink control information and/or uplink data transmission according to multiple priorities of the UE and uplink control information and/or uplink data reception according to multiple priorities of the base station.

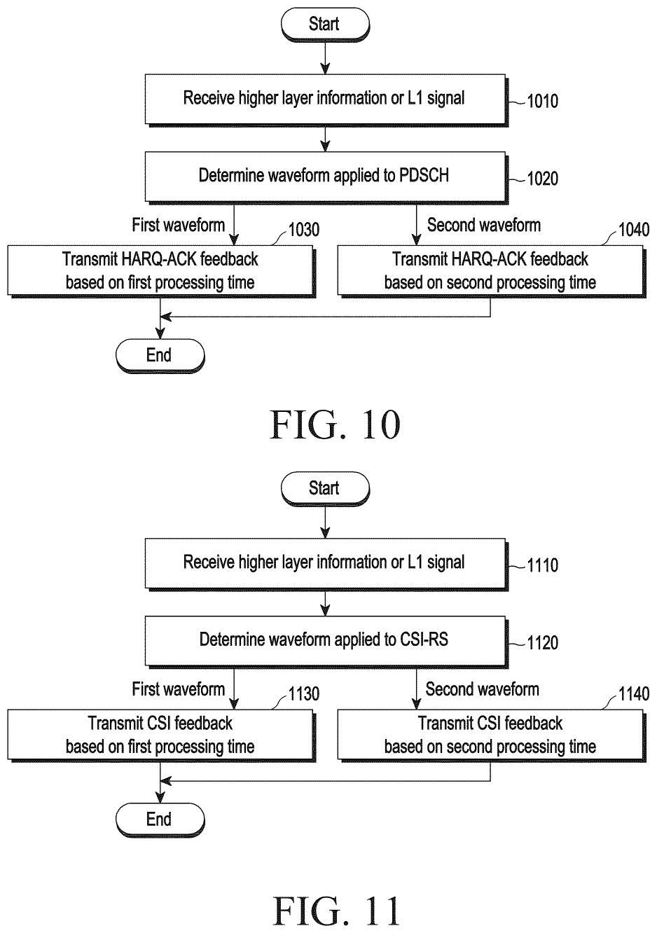

FIG. 12 is a view illustrating a structure of a UE in a wireless communication system according to an embodiment of the disclosure.

Referring to FIG. 12, the UE may include a transceiver collectively referring to a UE receiver 1200 and a UE transmitter 1210, memory (not illustrated), and a UE processor 1205 (or UE controller or processor). According to the above-described communication method of the UE, a UE receiver 1200, a UE transmitter 1210, the memory, and the UE processor 1205 of the UE may operate. However, the components of the UE are not limited thereto. For example, the UE may include more or fewer components than the above-described components. Further, the transceiver, memory, and processor may be implemented in the form of one chip.

The transceiver may transmit or receive signals to/from the base station. The signal may include control information and data. To that end, the transceiver may include a radio frequency (RF) transmitter for frequency-up converting and amplifying signals transmitted and an RF receiver for low-noise amplifying signals received and frequency-down converting the frequency of the received signals. However, this is merely an example of the transceiver, and the components of the transceiver are not limited to the RF transmitter and the RF receiver.

Further, the transceiver may receive a signal through a radio channel, output it to the processor, and transmit a signal output from the processor through the radio channel.

The memory may store programs and data necessary for the operation of the UE. The memory may store control information or data that is included in the signal transmitted/received by the UE. The memory may include a storage medium, such as read only memory (ROM), random access memory (RAM), hard disk, compact disc read only memory (CD-ROM), and digital versatile disc (DVD), or a combination of storage media. There may be provided a plurality of memories.

Further, the processor may control a series of processes for the UE to be able to operate according to the above-described embodiments. For example, the processor may control the components of the UE to receive a DCI constituted of two layers and simultaneously receive multiple PDSCHs. There may be a plurality of processors. The processor may perform control operations on the component(s) of the UE by executing a program stored in the memory.

The UE may include a terminal. In a method of a user equipment (UE) transmitting and receiving data in a wireless communication system, the UE may receive at least one of higher layer information or an L1 signal from a base station. The UE may determine a waveform applied to a received PDSCH using at least one of the higher layer information or the L1 signal. The UE may determine a processing time by determining the waveform. The UE may transmit HARQ-ACK feedback to the base station using the determined processing time.

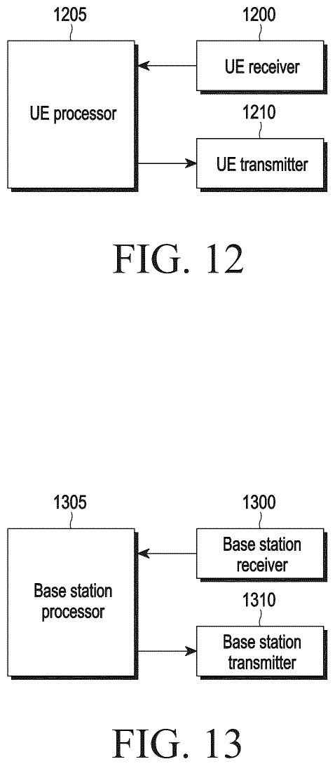

FIG. 13 is a view illustrating a structure of a base station in a wireless communication system according to an embodiment of the disclosure.

Referring to FIG. 13, the base station may include a transceiver including a base station receiver 1300 and a base station transmitter 1310, memory (not shown), and a base station processor 1305 (or a base station controller or processor). According to the above-described communication method of a base station, a base station receiver 1300, a base station transmitter 1310, memory, and the base station processor 1305 of the base station may operate. However, the components of the base station are not limited thereto. For example, the base station may include more or fewer components than the above-described components. Further, the transceiver, memory, and processor may be implemented in the form of one chip.

The transceiver may transmit or receive signals to/from the UE. The signal may include control information and data. To that end, the transceiver may include a radio frequency (RF) transmitter for frequency-up converting and amplifying signals transmitted and an RF receiver for low-noise amplifying signals received and frequency-down converting the frequency of the received signals. However, this is merely an example of the transceiver, and the components of the transceiver are not limited to the RF transmitter and the RF receiver.

Further, the transceiver may receive a signal through a radio channel, output it to the processor, and transmit a signal output from the processor through the radio channel.

The memory may store programs and data necessary for the operation of the base station. The memory may store control information or data that is included in the signal transmitted/received by the base station. The memory may include a storage medium, such as ROM, RAM, hard disk, CD-ROM, and DVD, or a combination of storage media. There may be provided a plurality of memories.

The processor may control a series of processes for the base station to operate according to the above-described embodiments. For example, the processor may control each component of the base station to configure DCIs of two layers including allocation information about multiple PDSCHs and transmitting the DCIs. There may be a plurality of processors. The processor may perform control operations on the component(s) of the base station by executing a program stored in the memory.

The methods according to the embodiments descried in the specification or claims of the disclosure may be implemented in hardware, software, or a combination of hardware and software.

When implemented in software, there may be provided a computer readable storage medium storing one or more programs (software modules). One or more programs stored in the computer readable storage medium are configured to be executed by one or more processors in an electronic device. One or more programs include instructions that enable the electronic device to execute methods according to the embodiments described in the specification or claims of the disclosure.

The programs (software modules or software) may be stored in random access memories, non-volatile memories including flash memories, read-only memories (ROMs), electrically erasable programmable read-only memories (EEPROMs), magnetic disc storage devices, compact-disc ROMs, digital versatile discs (DVDs), or other types of optical storage devices, or magnetic cassettes. Or, the programs may be stored in memory constituted of a combination of all or some thereof. As each constituting memory, multiple ones may be included.

The programs may be stored in attachable storage devices that may be accessed via a communication network, such as the Internet, Intranet, local area network (LAN), wide area network (WLAN), or storage area network (SAN) or a communication network configured of a combination thereof. The storage device may connect to the device that performs embodiments of the disclosure via an external port. A separate storage device over the communication network may be connected to the device that performs embodiments of the disclosure.

In the above-described specific embodiments, the components included in the disclosure are represented in singular or plural forms depending on specific embodiments proposed. However, the singular or plural forms are selected to be adequate for contexts suggested for ease of description, and the disclosure is not limited to singular or plural components.

The embodiments herein are provided merely for better understanding of the disclosure, and the disclosure should not be limited thereto or thereby. In other words, it is apparent to one of ordinary skill in the art that various changes may be made thereto without departing from the scope of the disclosure. Further, the embodiments may be practiced in combination. For example, the base station and the UE may be operated in a combination of parts of an embodiment and another embodiment. For example, some of the first and second embodiments of the disclosure may partially be combined and be operated by the base station and the UE. Further, although the above-described embodiments are suggested based on the FDD LTE system, other modifications based on the technical spirit of the above-described embodiments may be implemented in other systems, such as TDD LTE systems or 5G or NR systems.

In the drawings illustrating methods according to embodiments, the order of description is not necessarily identical to the order of execution, and some operations may be performed in a different order or simultaneously.

Some of the components shown in the drawings illustrating methods of the disclosure may be omitted in such an extent as not to impair the gist or essence of the disclosure.

The methods in the disclosure may be performed in a combination of all or some of the embodiments described herein in such an extent as not to impair the gist or essence of the disclosure.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a user equipment (UE) transmitting and receiving data in a wireless communication system, the method comprising:
receiving, at least one of higher layer information or a layer 1 (L1) signal from a base station;
identifying, a waveform applied to a physical downlink shared channel (PDSCH) received using at least one of the higher layer information or the L1 signal;
determining, a processing time based on the waveform applied to the PDSCH; and
transmitting, a hybrid automatic repeat request-acknowledgement (HARQ-ACK) feedback to the base station based on the determined processing time.

2. The method of claim 1, further comprising:
comparing the waveform applied to the PDSCH with a waveform applied to a physical downlink control channel (PDCCH);
determining whether to change the waveform applied to the PDSCH based on a comparison between the waveform applied to the PDSCH and the waveform applied to the PDCCH; and
determining the processing time based on the change.

3. The method of claim 2,
wherein the waveform applied to the PDSCH includes one of a first waveform or a second waveform,
wherein the first waveform is at least one of a Discrete Fourier Transform Spread Orthogonal Frequency Division Multiplexing (DFT-S-OFDM), a cyclic prefix orthogonal frequency division multiplexing (CP-OFDM), or an Orthogonal Time Frequency Space (OTFS), and
wherein the second waveform is at least one of a DFT-S-OFDM, a CP-OFDM, or an OTFS.

4. The method of claim 3, further comprising:
increasing the processing time based on a number of layers or ranks of the PDSCH in response to the waveform applied to the PDSCH being the first waveform.

5. The method of claim 1, further comprising:
applying a first waveform in response to at least one of a necessary processing minimum required time, a number of demodulation reference signal (DMRS) symbols, a PDSCH mapping type, a PDSCH time resource length, an overlap with PDCCH resources, and a PDSCH frequency size being satisfied.

6. A method performed by a user equipment (UE) transmitting and receiving data in a wireless communication system, the method comprising:
receiving, at least one of higher layer information or a layer 1 (L1) signal from a base station;
identifying, a waveform applied to a channel state information-reference signal (CSI-RS) received using at least one of the higher layer information or the L1 signal;
determining, a processing time based on the waveform applied to the CSI-RS; and
transmitting, CSI feedback to the base station using the determined processing time.

7. The method of claim 6,
wherein the waveform applied to the CSI-RS includes one of a first waveform or a second waveform,
wherein the first waveform is at least one of a Discrete Fourier Transform Spread Orthogonal Frequency Division Multiplexing (DFT-S-OFDM), a cyclic prefix orthogonal frequency division multiplexing (CP-OFDM), or an Orthogonal Time Frequency Space (OTFS), and
wherein the second waveform is at least one of a DFT-S-OFDM, a CP-OFDM, or an OTFS.

8. The method of claim 7, further comprising:
determining the waveform applied to the CSI-RS as the first waveform based on field information included in a downlink control information (DCI) format.

9. The method of claim 7, further comprising:
determining the waveform applied to the CSI-RS based on a CSI-RS resource information value in a downlink control information (DCI) format or a resource value used for reporting the CSI-RS.

10. The method of claim 7, further comprising:
transmitting to the base station a CSI-RS measurement result for at least one of the first waveform or the second waveform.

11. A user equipment (UE) for transmitting and receiving data in a wireless communication system, the UE comprising:
a transceiver;
memory, comprising one or more storage media, storing instructions; and
one or more processors communicatively coupled to the transceiver and the memory,
wherein the instructions, when executed by the one or more processors individually or collectively, cause the UE to:
receive at least one of higher layer information or a layer 1 (L1) signal from a base station,
identify a waveform applied to a physical downlink shared channel (PDSCH) received using at least one of the higher layer information or the L1 signal,
determine a processing time based on the waveform applied to the PDSCH, and
transmit a hybrid automatic repeat request-acknowledgement (HARQ-ACK) feedback to the base station using the determined processing time.

12. The UE of claim 11, wherein the instructions, when executed by the one or more processors individually or collectively, further cause the UE to:
compare the waveform applied to the PDSCH with a waveform applied to a physical downlink control channel (PDCCH),
determine whether to change the waveform applied to the PDSCH based on the comparison between the waveform applied to the PDSCH and the waveform applied to the PDCCH, and
determine the processing time based on the change.

13. The UE of claim 12,
wherein the waveform applied to the PDSCH includes one of a first waveform or a second waveform,
wherein the first waveform is at least one of a Discrete Fourier Transform Spread Orthogonal Frequency Division Multiplexing (DFT-S-OFDM), a cyclic prefix orthogonal frequency division multiplexing (CP-OFDM), or an Orthogonal Time Frequency Space (OTFS), and
wherein the second waveform is at least one of a DFT-S-OFDM, a CP-OFDM, or an OTFS.

14. The UE of claim 13, wherein the instructions, when executed by the one or more processors individually or collectively, further cause the UE to:
increase the processing time based on a number of layers or ranks of the PDSCH in response to the waveform applied to the PDSCH being the first waveform.

15. The UE of claim 11, wherein the instructions, when executed by the one or more processors individually or collectively, further cause the UE to:
apply a first waveform in response to at least one of a necessary processing minimum required time, a number of demodulation reference signal (DMRS) symbols, a PDSCH mapping type, a PDSCH time resource length, an overlap with PDCCH resources, and a PDSCH frequency size being satisfied.

16. One or more non-transitory computer-readable storage media storing one or more computer programs including computer-executable instructions that, when executed by one or more processors of a user equipment (UE) individually or collectively, cause the UE to perform operations, the operations comprising:
receiving, by the UE, at least one of higher layer information or a layer 1 (L1) signal from a base station;
identifying, by the UE, a waveform applied to a physical downlink shared channel (PDSCH) received using at least one of the higher layer information or the L1 signal;
determining, by the UE, a processing time based on the waveform applied to the PDSCH; and
transmitting, by the UE, a hybrid automatic repeat request-acknowledgement (HARQ-ACK) feedback to the base station based on the determined processing time.

17. The one or more non-transitory computer-readable storage media of claim 16, the operations further comprising:
comparing the waveform applied to the PDSCH with a waveform applied to a physical downlink control channel (PDCCH);
determining whether to change the waveform applied to the PDSCH based on a comparison between the waveform applied to the PDSCH and the waveform applied to the PDCCH; and
determining the processing time based on the change.
